(19) United States
(12) Patent Application Publication
(10) Pub. No.: US 2026/0160981 A1
(43) Pub. Date: Jun. 11, 2026

(54) IMAGING LENS AND IMAGING APPARATUS

(71) Applicant: FUJIFILM Corporation, Tokyo (JP)

(72) Inventor: Masato KONDO, Saitama-shi (JP)

(73) Assignee: FUJIFILM Corporation, Tokyo (JP)

(21) Appl. No.: 19/181,280

(22) Filed: Apr. 16, 2025

Related U.S. Application Data
(63) Continuation of application No. PCT/JP2023/035275, filed on Sep. 27, 2023.

(30) Foreign Application Priority Data
Oct. 24, 2022 (JP) 2022-170035

(51) Int. Cl. G02B 13/00; G02B 9/12; G02B 9/34; G02B 9/60

(52) U.S. Cl. CPC G02B 13/0045; G02B 9/12; G02B 9/34; G02B 9/60

(57) ABSTRACT

An imaging lens includes a first lens group that is disposed closest to an object side and that is fixed with respect to an image plane during focusing, and two or fewer focus lens groups that move along an optical axis during focusing. One of the two or fewer focus lens groups is disposed adjacent to the first lens group on an image side. The imaging lens satisfies a predetermined conditional expression.

### CROSS-REFERENCE TO RELATED APPLICATIONS

This application is a continuation application of International Application No. PCT/JP2023/035275, filed on Sep. 27, 2023, which claims priority from Japanese Patent Application No. 2022-170035, filed on Oct. 24, 2022. The entire disclosure of each of the above applications is incorporated herein by reference.

### BACKGROUND

### Technical Field

The disclosed technology relates to an imaging lens and an imaging apparatus.

### Related Art

In the related art, imaging lenses according to WO2012/026070A and JP2012-128045A have been known as an imaging lens usable in an imaging apparatus such as a digital camera.

### SUMMARY

There is a demand for an imaging lens that is reduced in size and that maintains favorable optical performance. A level of such a demand is increasing every year.

An object of the present disclosure is to provide an imaging lens that is reduced in size and that maintains favorable optical performance, and an imaging apparatus comprising the imaging lens.

According to a first aspect of the present disclosure, there is provided an imaging lens comprising a first lens group that is disposed closest to an object side and that is fixed with respect to an image plane during focusing, and two or fewer focus lens groups that move along an optical axis during focusing, in which one of the two or fewer focus lens groups is disposed adjacent to the first lens group on an image side, and in a case where a maximum half angle of view in a state where an infinite distance object is in focus is denoted by ωm, ωm is in degree units, a back focus of an entire system as an air conversion distance in the state where the infinite distance object is in focus is denoted by Bf, and a focal length of the entire system in the state where the infinite distance object is in focus is denoted by f, Conditional Expressions (1) and (2) are satisfied, which are represented by

$$35 < ω m < 76 and \qquad ( 1 )$$

$$0.3 < Bf / ( f \times tan ω m ) < 1.2 . \qquad ( 2 )$$

According to a second aspect of the present disclosure, in the imaging lens of the first aspect, in a case where a sum of a distance on the optical axis from a lens surface of the imaging lens closest to the object side to a lens surface of the imaging lens closest to the image side and the back focus of the entire system as the air conversion distance in the state where the infinite distance object is in focus is denoted by TL, Conditional Expression (3) is satisfied, which is represented by

$$1.4 < TL / ( f \times tan ω m ) < 3.5 . \qquad ( 3 )$$

According to a third aspect of the present disclosure, in the imaging lens of the second aspect, Conditional Expression (3-1) is satisfied, which is represented by

$$1.7 < TL / ( f \times tan ω m ) < 3.2 . \qquad ( 3 - 1 )$$

According to a fourth aspect of the present disclosure, in the imaging lens of the first aspect, in a case where an open F-number in the state where the infinite distance object is in focus is denoted by FNo, Conditional Expression (4) is satisfied, which is represented by

$$1 < FNo / tan ω m < 4.5 . \qquad ( 4 )$$

According to a fifth aspect of the present disclosure, in the imaging lens of the fourth aspect, Conditional Expression (4-1) is satisfied, which is represented by

$$1. 4 < FNo / tan ω m < 2.75 . \qquad ( 4 - 1 )$$

According to a sixth aspect of the present disclosure, in the imaging lens of the first aspect, in a case where an open F-number in the state where the infinite distance object is in focus is denoted by FNo, Conditional Expression (5) is satisfied, which is represented by

$$2.2 < FNo < 4.2 . \qquad ( 5 )$$

According to a seventh aspect of the present disclosure, in the imaging lens of the first aspect, an aperture stop is disposed, and in which, in a case where a distance on the optical axis from a lens surface of the first lens group closest to the object side to the aperture stop in the state where the infinite distance object is in focus is denoted by STI, and a sum of a distance on the optical axis from a lens surface of the imaging lens closest to the object side to a lens surface of the imaging lens closest to the image side and the back focus of the entire system as the air conversion distance in the state where the infinite distance object is in focus is denoted by TL, Conditional Expression (6) is satisfied, which is represented by

$$0.06 < STI / TL < 0.45 . \qquad ( 6 )$$

According to an eighth aspect of the present disclosure, in the imaging lens of the first aspect, in a case where a maximum imaging magnification is denoted by β, Conditional Expression (7) is satisfied, which is represented by

$$0.05 < \vert β \vert < 0.3 . \qquad ( 7 )$$

According to a ninth aspect of the present disclosure, in the imaging lens of the first aspect, in a case where a focal length of the first lens group is denoted by f1, Conditional Expression (8) is satisfied, which is represented by

$$- 1.5 < f / f 1 < 1.5 . \qquad ( 8 )$$

According to a tenth aspect of the present disclosure, in the imaging lens of the first aspect, in a case where a sum of a distance on the optical axis from a lens surface of the imaging lens closest to the object side to a lens surface of the imaging lens closest to the image side and the back focus of the entire system as the air conversion distance in the state where the infinite distance object is in focus is denoted by TL, Conditional Expression (3-1) is satisfied, which is represented by

$$1.7 < TL / ( f \times tan ω m ) < 3.2 . \qquad ( 3 - 1 )$$

According to an eleventh aspect of the present disclosure, in the imaging lens of the tenth aspect, in a case where an open F-number in the state where the infinite distance object is in focus is denoted by FNo, Conditional Expression (4-1) is satisfied, which is represented by

$$1.4 < FNo / tan ω m < 2.75 . \qquad ( 4 - 1 )$$

According to a twelfth aspect of the present disclosure, in the imaging lens of the eleventh aspect, Conditional Expression (1-1) is satisfied, which is represented by

$$39 < ω m < 72. \qquad ( 1 - 1 )$$

According to a thirteenth aspect of the present disclosure, in the imaging lens of the twelfth aspect, in a case where the open F-number in the state where the infinite distance object is in focus is denoted by FNo, Conditional Expression (5) is satisfied, which is represented by

$$2.2 < FNo < 4.2 . \qquad ( 5 )$$

According to a fourteenth aspect of the present disclosure, in the imaging lens of the eleventh aspect, the first lens group includes, in consecutive order from a position closest to the object side to the image side, a negative lens having a concave surface facing the image side and a negative meniscus lens having a concave surface facing the image side.

According to a fifteenth aspect of the present disclosure, in the imaging lens of the eleventh aspect, in a case where a focal length of the first lens group is denoted by f1, Conditional Expression (8-1) is satisfied, which is represented by

$$- 0.8 < f / f 1 < 0.25 . \qquad ( 8 - 1 )$$

According to a sixteenth aspect of the present disclosure, in the imaging lens of the fifteenth aspect, a lens closest to the object side in the first lens group is a negative lens having a concave surface facing the image side.

According to a seventeenth aspect of the present disclosure, in the imaging lens of the first aspect, in a case where a distance on the optical axis from a lens surface of the imaging lens closest to the object side to a paraxial entrance pupil position in the state where the infinite distance object is in focus is denoted by Denp, Conditional Expression (9) is satisfied, which is represented by

$$0.05 < Denp / f < 1. \qquad ( 9 )$$

According to an eighteenth aspect of the present disclosure, in the imaging lens of the first aspect, a lens closest to the object side in the first lens group is a negative lens.

According to a nineteenth aspect of the present disclosure, in the imaging lens of the eighteenth aspect, in a case where a paraxial curvature radius of a surface, on the object side, of the negative lens closest to the object side in the first lens group is denoted by R1f, and a paraxial curvature radius of a surface, on the image side, of the negative lens closest to the object side in the first lens group is denoted by R1r, Conditional Expression (10) is satisfied, which is represented by

$$0.1 < ( R 1 f + R 1 r ) / ( R 1 f - R 1 r ) < 5. \qquad ( 10 )$$

According to a twentieth aspect of the present disclosure, in the imaging lens of the eighteenth aspect, in a case where a paraxial curvature radius of a surface, on the object side, of the negative lens closest to the object side in the first lens group is denoted by R1f, Conditional Expression (11) is satisfied, which is represented by

$$- 3 < f / R 1 f < 4. \qquad ( 11 )$$

According to a twenty-first aspect of the present disclosure, in the imaging lens of the eighteenth aspect, in a case where a focal length of the negative lens closest to the object side in the first lens group is denoted by fL1, Conditional Expression (12) is satisfied, which is represented by

$$0.1 < f / ( - fL 1 ) < 3.5 . \qquad ( 12 )$$

According to a twenty-second aspect of the present disclosure, in the imaging lens of the eighteenth aspect, in a case where a paraxial curvature radius of a surface, on the object side, of a lens which is second from the object side in the first lens group is denoted by R2f, and a paraxial curvature radius of a surface, on the image side, of the lens which is second from the object side in the first lens group is denoted by R2r, Conditional Expression (13) is satisfied, which is represented by

$$- 3 < ( R 2 f + R 2 r ) / ( R 2 f - R 2 r ) < 8. \qquad ( 13 )$$

According to a twenty-third aspect of the present disclosure, in the imaging lens of the first aspect, a lens closest to the image side in the first lens group is a positive lens.

According to a twenty-fourth aspect of the present disclosure, in the imaging lens of the twenty-third aspect, in a case where a paraxial curvature radius of a surface, on the object side, of the positive lens closest to the image side in the first lens group is denoted by R1rf, and a paraxial curvature radius of a surface, on the image side, of the positive lens closest to the image side in the first lens group is denoted by R1rr, Conditional Expression (14) is satisfied, which is represented by

$$- 4 < ( R 1 rf + R 1 rr ) / ( R 1 rf - R 1 rr ) < 0. \qquad ( 14 )$$

According to a twenty-fifth aspect of the present disclosure, in the imaging lens of the twenty-third aspect, in a case where an Abbe number based on a d line for the positive lens closest to the image side in the first lens group is denoted by v1r, Conditional Expression (15) is satisfied, which is represented by

$$22 < v 1 r < 85. \qquad ( 15 )$$

According to a twenty-sixth aspect of the present disclosure, in the imaging lens of the first aspect, in a case where an average value of relative densities of all lenses included in the first lens group is denoted by ρ1ave, Conditional Expression (16) is satisfied, which is represented by

$$2.3 < ρ lave < 4.7 . \qquad ( 16 )$$

According to a twenty-seventh-aspect of the present disclosure, in the imaging lens of the first aspect, the first lens group includes at least one negative lens and at least one positive lens, and the number of lenses included in the first lens group is four or less.

According to a twenty-eighth aspect of the present disclosure, in the imaging lens of the twenty-seventh aspect, the first lens group includes, in order from the object side to the image side, only three lenses consisting of a negative lens having a concave surface facing the image side, a negative lens having a concave surface facing the image side, and a positive lens as lenses.

According to a twenty-ninth aspect of the present disclosure, in the imaging lens of the first aspect, the first lens group includes an aspherical lens having a concave surface facing the image side, and in a case where a paraxial curvature radius of a surface of the aspherical lens on the object side is denoted by Rc1f, a paraxial curvature radius of a surface of the aspherical lens on the image side is denoted by Rc1r, a curvature radius of the surface of the aspherical lens on the object side at a position of a maximum effective diameter is denoted by Ry1f, and a curvature radius of the surface of the aspherical lens on the image side at a position of a maximum effective diameter is denoted by Ry1r, Conditional Expression (17) is satisfied, which is represented by

$$0.4 < ( 1 / Rc 1 f - 1 / Rc 1 r ) / ( 1 / Ry 1 f - 1 / Ry 1 r ) < 2.4 . \qquad ( 17 )$$

According to a thirtieth aspect of the present disclosure, in the imaging lens of the first aspect, the imaging lens includes two focus lens groups, and in a case where a focus lens group on the object side out of the two focus lens groups is referred to as a first focus lens group, and a focus lens group on the image side out of the two focus lens groups is referred to as a second focus lens group, during focusing, the first focus lens group and the second focus lens group move by different moving amounts, and a lens group different from the first focus lens group and the second focus lens group is fixed with respect to the image plane.

According to a thirty-first aspect of the present disclosure, in the imaging lens of the thirtieth aspect, in a case where a sum of a distance on the optical axis from a lens surface of the imaging lens closest to the object side to a lens surface of the imaging lens closest to the image side and the back focus of the entire system as the air conversion distance in the state where the infinite distance object is in focus is denoted by TL, Conditional Expression (3-1) is satisfied, which is represented by

$$1.7 < TL / ( f \times tan ω m ) < 3.2 . \qquad ( 3 - 1 )$$

According to a thirty-second aspect of the present disclosure, in the imaging lens of the thirtieth aspect, in a case where a focal length of the first focus lens group is denoted by ff1, and a focal length of the second focus lens group is denoted by ff2, Conditional Expression (18) is satisfied, which is represented by

$$0.04 < ff 1 / ff 2 < 2. \qquad ( 18 )$$

According to a thirty-third aspect of the present disclosure, in the imaging lens of the thirty-first aspect, Conditional Expression (1-2) is satisfied, which is represented by

$$41 < ω m < 70. \qquad ( 1 - 2 )$$

According to a thirty-fourth aspect of the present disclosure, in the imaging lens of the thirty-first aspect, in a case where a focal length of the first focus lens group is denoted by ff1, and a focal length of the second focus lens group is denoted by ff2, Conditional Expression (18-1) is satisfied, which is represented by

$$0.1 < ff 1 / ff 2 < 0.9 . \qquad ( 18 - 1 )$$

According to a thirty-fifth aspect of the present disclosure, in the imaging lens of the thirty-fourth aspect, the first lens group includes, in consecutive order from a position closest to the object side to the image side, a negative lens having a concave surface facing the image side and a negative lens having a concave surface facing the image side.

According to a thirty-sixth aspect of the present disclosure, in the imaging lens of the thirtieth aspect, in a case where a lateral magnification of the first focus lens group in the state where the infinite distance object is in focus is denoted by βf1, and a lateral magnification of the second focus lens group in the state where the infinite distance object is in focus is denoted by βf2, Conditional Expression (19) is satisfied, which is represented by

$$- 1 < β f 1 / β f 2 < 1.2 . \qquad ( 19 )$$

According to a thirty-seventh aspect of the present disclosure, in the imaging lens of the thirtieth aspect, in a case where a lateral magnification of the first focus lens group in the state where the infinite distance object is in focus is denoted by βf1, Conditional Expression (20) is satisfied, which is represented by

$$0 < {\{ β f 1 + ( 1 / β f 1 ) \}}^{- 2} < 0.25 . \qquad ( 20 )$$

According to a thirty-eighth aspect of the present disclosure, in the imaging lens of the thirtieth aspect, in a case where a lateral magnification of the second focus lens group in the state where the infinite distance object is in focus is denoted by βf2, Conditional Expression (21) is satisfied, which is represented by

$$0.05 < {\{ β f 2 + ( 1 / β f 2 ) \}}^{- 2} < 0.25 . \qquad ( 21 )$$

According to a thirty-ninth aspect of the present disclosure, in the imaging lens of the thirtieth aspect, in a case where a focal length of the first focus lens group is denoted by ff1, Conditional Expression (22) is satisfied, which is represented by

$$0.1 < f / ff 1 < 1.5 . \qquad ( 22 )$$

According to a fortieth aspect of the present disclosure, in the imaging lens of the thirtieth aspect, the first focus lens group includes a cemented lens in which a positive lens and a negative lens are cemented in order from the object side.

According to a forty-first aspect of the present disclosure, in the imaging lens of the fortieth aspect, in a case where an Abbe number based on a d line for the positive lens of the cemented lens is denoted by vf1p, and an Abbe number based on a d line for the negative lens of the cemented lens is denoted by vf1n, Conditional Expression (23) is satisfied, which is represented by

$$- 15 < vf 1 p - vf 1 n < 25. \qquad ( 23 )$$

According to a forty-second aspect of the present disclosure, in the imaging lens of the fortieth aspect, in a case where a refractive index with respect to a d line for the positive lens of the cemented lens is denoted by Nf1p, and a refractive index with respect to a d line for the negative lens of the cemented lens is denoted by Nf1n, Conditional Expression (24) is satisfied, which is represented by

$$0 < Nf 1 p - Nf 1 n < 0.45 . \qquad ( 24 )$$

According to a forty-third aspect of the present disclosure, in the imaging lens of the thirtieth aspect, in a case where an average value of an effective radius of a surface of the first focus lens group closest to the image side and an effective radius of a surface of the second focus lens group closest to the image side is denoted by Effave, Conditional Expression (25) is satisfied, which is represented by

$$0.3 < Effave / ( f \times tan ω m ) < 0.7 . \qquad ( 25 )$$

According to a forty-fourth aspect of the present disclosure, in the imaging lens of the thirtieth aspect, an image-side lens group that has a refractive power and that is fixed with respect to the image plane during focusing is disposed adjacent to the second focus lens group on the image side.

According to a forty-fifth aspect of the present disclosure, in the imaging lens of the forty-fourth aspect, in a case where a focal length of the image-side lens group is denoted by fi, Conditional Expression (26) is satisfied, which is represented by

$$0.05 < f / ( - fi ) < 0.7 . \qquad ( 26 )$$

According to a forty-sixth aspect of the present disclosure, in the imaging lens of the forty-fifth aspect, a lens closest to the image side in the image-side lens group is a negative lens having a concave surface facing the object side.

According to a forty-seventh aspect of the present disclosure, in the imaging lens of the forty-sixth aspect, in a case where a refractive index with respect to a d line for the negative lens closest to the image side in the image-side lens group is denoted by Nir, Conditional Expression (27) is satisfied, which is represented by

$$1.45 < Nir < 2.2 . \qquad ( 27 )$$

According to a forty-eighth aspect of the present disclosure, in the imaging lens of the thirtieth aspect, the first focus lens group includes an aspherical lens having a concave surface facing the object side, and in a case where a paraxial curvature radius of a surface, on the object side, of the aspherical lens is denoted by Rcff1f, a paraxial curvature radius of a surface, on the image side, of the aspherical lens is denoted by Rcff1r, a curvature radius of the surface, on the object side, of the aspherical lens at a position of a maximum effective diameter is denoted by Ryff1f, and a curvature radius of the surface, on the image side, of the aspherical lens at a position of a maximum effective diameter is denoted by Ryff1r, Conditional Expression (28) is satisfied, which is represented by

$$0.1 < ( 1 / Rcff 1 f - 1 / Rcff 1 r ) / ( 1 / Ryff 1 f - 1 / Ryff 1 r ) < 1.6 . \qquad ( 28 )$$

According to a forty-ninth aspect of the present disclosure, in the imaging lens of the thirtieth aspect, the second focus lens group includes an aspherical lens having a concave surface facing the object side, and in a case where a paraxial curvature radius of a surface, on the object side, of the aspherical lens is denoted by Rcff2f, a paraxial curvature radius of a surface, on the image side, of the aspherical lens is denoted by Rcff2r, a curvature radius of the surface, on the object side, of the aspherical lens at a position of a maximum effective diameter is denoted by Ryff2f, and a curvature radius of the surface, on the image side, of the aspherical lens at a position of a maximum effective diameter is denoted by Ryff2r, Conditional Expression (29) is satisfied, which is represented by

$$0 < ( 1 / Rcff 2 f - 1 / Rcff 2 r ) / ( 1 / Ryff 2 f - 1 / Ryff 2 r ) < 0.6 . \qquad ( 29 )$$

According to a fiftieth aspect of the present disclosure, in the imaging lens of the forty-fourth aspect, the imaging lens consists of, in order from the object side to the image side, the first lens group, the first focus lens group, the second focus lens group, and the image-side lens group.

According to a fifty-first aspect of the present disclosure, in the imaging lens of the thirtieth aspect, a middle lens group that has a positive refractive power and that is fixed with respect to the image plane during focusing is provided between the first focus lens group and the second focus lens group, and in a case where a focal length of the middle lens group is denoted by fm, and a focal length of the first focus lens group is denoted by ff1, Conditional Expression (30) is satisfied, which is represented by

$$0.2 < fm / ff 1 < 1. \qquad ( 30 )$$

According to a fifty-second aspect of the present disclosure, in the imaging lens of the first aspect, the imaging lens includes only one focus lens group.

According to a fifty-third aspect of the present disclosure, in the imaging lens of the fifty-second aspect, in a case where a focal length of the focus lens group is denoted by ff, Conditional Expression (31) is satisfied, which is represented by

$$0.1 < f / ff < 2. \qquad ( 31 )$$

According to a fifty-fourth aspect of the present disclosure, in the imaging lens of the fifty-second aspect, in a case where a sum of a distance on the optical axis from a lens surface of the imaging lens closest to the object side to a lens surface of the imaging lens closest to the image side and the back focus of the entire system as the air conversion distance in the state where the infinite distance object is in focus is TL, and a focal length of the focus lens group is denoted by ff, Conditional Expression (32) is satisfied, which is represented by

$$0.5 < TL / ff < 3.5 . \qquad ( 32 )$$

According to a fifty-fifth aspect of the present disclosure, in the imaging lens of the fifty-second aspect, the focus lens group includes a cemented lens in which a positive lens and a negative lens are cemented in order from the object side.

According to a fifty-sixth aspect of the present disclosure, in the imaging lens of the fifty-fifth aspect, in a case where an Abbe number based on a d line for the positive lens of the cemented lens is denoted by vfp, and an Abbe number based on a d line for the negative lens of the cemented lens is denoted by vfn, Conditional Expression (33) is satisfied, which is represented by

$$- 15 < vfp - vfn < 25. \qquad ( 33 )$$

According to a fifty-seventh aspect of the present disclosure, in the imaging lens of the fifty-fifth aspect, in a case where a refractive index with respect to a d line for the positive lens of the cemented lens is denoted by Nfp, and a refractive index with respect to a d line for the negative lens of the cemented lens is denoted by Nfn, Conditional Expression (34) is satisfied, which is represented by

$$0 < Nfp - Nfn < 0.45 . \qquad ( 34 )$$

According to a fifty-eighth aspect of the present disclosure, in the imaging lens of the fifty-second aspect, in a case where an effective radius of a surface of the focus lens group closest to the image side is denoted by Eff, Conditional Expression (35) is satisfied, which is represented by

$$0.3 < Eff / ( f \times tan ω m ) < 0.7 . \qquad ( 35 )$$

According to a fifty-ninth aspect of the present disclosure, in the imaging lens of the fifty-second aspect, an image-side lens group that has a refractive power and that is fixed with respect to the image plane during focusing is disposed adjacent to the focus lens group on the image side.

According to a sixtieth aspect of the present disclosure, in the imaging lens of the fifty-ninth aspect, in a case where a focal length of the image-side lens group is denoted by fi, Conditional Expression (26) is satisfied, which is represented by

$$0.05 < f / ( - fi ) < 0.7 . \qquad ( 26 )$$

According to a sixty-first aspect of the present disclosure, in the imaging lens of the sixtieth aspect, a lens closest to the image side in the image-side lens group is a negative lens having a concave surface facing the object side.

According to a sixty-second aspect of the present disclosure, in the imaging lens of the sixty-first aspect, in a case where a refractive index with respect to a d line for the negative lens closest to the image side in the image-side lens group is denoted by Nir, Conditional Expression (27) is satisfied, which is represented by

$$1.45 < Nir < 2.2 . \qquad ( 27 )$$

According to a sixty-third aspect of the present disclosure, in the imaging lens of the fifty-second aspect, the focus lens group includes at least one aspherical lens, an aspherical lens closest to the object side among aspherical lenses included in the focus lens group has a concave surface facing the object side, and in a case where a paraxial curvature radius of a surface, on the object side, of the aspherical lens closest to the object side is denoted by Rcffof, a paraxial curvature radius of a surface, on the image side, of the aspherical lens closest to the object side is denoted by Rcffor, a curvature radius of the surface, on the object side, of the aspherical lens closest to the object side at a position of a maximum effective diameter is denoted by Ryffof, and a curvature radius of the surface, on the image side, of the aspherical lens closest to the object side at a position of a maximum effective diameter is denoted by Ryffor, Conditional Expression (36) is satisfied, which is represented by

$$0.1 < ( 1 / Rcffof - 1 / Rcffor ) / ( 1 / Ryffof - 1 / Ryffor ) < 1.6 . \qquad ( 36 )$$

According to a sixty-fourth aspect of the present disclosure, in the imaging lens of the fifty-second aspect, the focus lens group includes at least one aspherical lens, an aspherical lens closest to the image side among aspherical lenses included in the focus lens group has a concave surface facing the object side, and in a case where a paraxial curvature radius of a surface, on the object side, of the aspherical lens closest to the image side is denoted by Rcffif, a paraxial curvature radius of a surface, on the image side, of the aspherical lens closest to the image side is denoted by Rcffir, a curvature radius of the surface, on the object side, of the aspherical lens closest to the image side at a position of a maximum effective diameter is denoted by Ryffif, and a curvature radius of the surface, on the image side, of the aspherical lens closest to the image side at a position of a maximum effective diameter is denoted by Ryffir, Conditional Expression (37) is satisfied, which is represented by

$$- 0.7 < ( 1 / Rcffif - 1 / Rcffir ) / ( 1 / Ryffif - 1 / Ryffir ) < 1.2 . \qquad ( 37 )$$

According to a sixty-fifth aspect of the present disclosure, in the imaging lens of the first aspect, the imaging lens includes an Lp lens that is a positive lens, and in a case where a refractive index with respect to a d line for the Lp lens is denoted by Np, an Abbe number based on the d line for the Lp lens is denoted by vp, and a partial dispersion ratio of the Lp lens between a g line and an F line is denoted by θgFp, Conditional Expressions (38), (39), (40), and (41) are satisfied, which are represented by

$$0.005 < Np - ( 2.015 - 0.0068 \times vp ) < 0.15 , \qquad ( 38 )$$

$$50 < vp < 65 , \qquad ( 39 )$$

$$0.545 < θ gFp < 0.58 , and \qquad ( 40 )$$

$$- 0.011 < θ gFp - ( 0.6418 - 0.00168 \times vp ) < 0.035 . \qquad ( 41 )$$

According to a sixty-sixth aspect of the present disclosure, the imaging lens of the sixty-fifth aspect further comprises an aperture stop, in which the Lp lens is disposed on the image side with respect to the aperture stop, and in a case where an open F-number in the state where the infinite distance object is in focus is denoted by FNo, a distance on the optical axis from a lens surface of the first lens group closest to the object side to the aperture stop in the state where the infinite distance object is in focus is denoted by STI, and a sum of a distance on the optical axis from a lens surface of the imaging lens closest to the object side to a lens surface of the imaging lens closest to the image side and the back focus of the entire system as the air conversion distance in the state where the infinite distance object is in focus is denoted by TL, Conditional Expressions (4-2) and (6-1) are satisfied, which are represented by

$$1.5 < FNo / tan ω m < 2.5 and \qquad ( 4 - 2 )$$

$$0.09 < STI / TL < 0.35 . \qquad ( 6 - 1 )$$

According to a sixty-seventh aspect of the present disclosure, in the imaging lens of the sixty-sixth aspect, Conditional Expression (3-1) is satisfied, which is represented by

$$1. 7 < T L / ( f \times tan ω m ) < 3.2 . \qquad ( 3 - 1 )$$

According to a sixty-eighth aspect of the present disclosure, in the imaging lens of the sixty-seventh aspect, a lens closest to the object side in the first lens group is a negative lens having a concave surface facing the image side.

According to a sixty-ninth aspect of the present disclosure, there is provided an imaging apparatus comprising the imaging lens according to any one of the first to sixth-eighth aspects.

In the present specification, the expressions “consists of” and “consisting of” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the illustrated constituents.

The term “group having a positive refractive power” in the present specification means that the entire group has a positive refractive power. The term “group having a negative refractive power” means that the entire group has a negative refractive power. The terms “first lens group”, “focus lens group”, “first focus lens group”, “second focus lens group”, “middle lens group”, and “image-side lens group” in the present specification are not limited to a configuration consisting of a plurality of lenses and may be a configuration consisting of only one lens.

A compound aspherical lens (a lens functioning as one aspherical lens as a whole, in which a spherical lens and a film of an aspherical shape formed on the spherical lens are configured to be integrated with each other) is not regarded as a cemented lens and is handled as one lens. Unless otherwise specified, a curvature radius, a sign of a refractive power, and a surface shape related to a lens including an aspherical surface in a paraxial region are used. For a sign of the curvature radius, a sign of the curvature radius of a surface of a shape having a convex surface facing the object side is positive, and a sign of the curvature radius of a surface of a shape having a convex surface facing the image side is negative.

The term “entire system” in the present specification means the imaging lens. The term “focal length” used in the conditional expressions means a paraxial focal length. Unless otherwise specified, the term “distance on the optical axis” used in the conditional expressions means a geometrical distance. Unless otherwise specified, values used in the conditional expressions are values based on the d line in the state where the infinite distance object is in focus.

The terms “d line”, “C line”, “F line”, and “g line” described in the present specification mean bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

In a case where refractive indices with respect to a g line, an F line, and a C line for a lens are denoted by Ng, NF, and NC, respectively, and a partial dispersion ratio of the lens between the g line and the F line is denoted by θgF, θgF is defined by the following expression.

$$θ g F = ( Ng - NF ) / ( NF - NC )$$

According to the present disclosure, an imaging lens that is reduced in size and that maintains favorable optical performance, and an imaging apparatus comprising the imaging lens can be provided.

### BRIEF DESCRIPTION OF THE DRAWINGS

FIG. 1 is a cross-sectional view that illustrates a configuration of an imaging lens according to one embodiment and that corresponds to an imaging lens of Example 1.

FIG. 2 is a cross-sectional view illustrating a configuration and luminous fluxes of the imaging lens in FIG. 1.

FIG. 3 is a diagram for describing positions of an effective radius and a maximum effective diameter.

FIG. 4 is each aberration diagram of the imaging lens of Example 1.

FIG. 5 is a cross-sectional view illustrating a configuration of an imaging lens of Example 2.

FIG. 6 is each aberration diagram of the imaging lens of Example 2.

FIG. 7 is a cross-sectional view illustrating a configuration of an imaging lens of Example 3.

FIG. 8 is each aberration diagram of the imaging lens of Example 3.

FIG. 9 is a cross-sectional view illustrating a configuration of an imaging lens of Example 4.

FIG. 10 is each aberration diagram of the imaging lens of Example 4.

FIG. 11 is a cross-sectional view illustrating a configuration of an imaging lens of Example 5.

FIG. 12 is each aberration diagram of the imaging lens of Example 5.

FIG. 13 is a cross-sectional view illustrating a configuration of an imaging lens of Example 6.

FIG. 14 is each aberration diagram of the imaging lens of Example 6.

FIG. 15 is a cross-sectional view illustrating a configuration of an imaging lens of Example 7.

FIG. 16 is each aberration diagram of the imaging lens of Example 7.

FIG. 17 is a cross-sectional view illustrating a configuration of an imaging lens of Example 8.

FIG. 18 is each aberration diagram of the imaging lens of Example 8.

FIG. 19 is a cross-sectional view illustrating a configuration of an imaging lens of Example 9.

FIG. 20 is each aberration diagram of the imaging lens of Example 9.

FIG. 21 is a cross-sectional view illustrating a configuration of an imaging lens of Example 10.

FIG. 22 is each aberration diagram of the imaging lens of Example 10.

FIG. 23 is a cross-sectional view illustrating a configuration of an imaging lens of Example 11.

FIG. 24 is each aberration diagram of the imaging lens of Example 11.

FIG. 25 is a cross-sectional view illustrating a configuration of an imaging lens of Example 12.

FIG. 26 is each aberration diagram of the imaging lens of Example 12.

FIG. 27 is a cross-sectional view illustrating a configuration of an imaging lens of Example 13.

FIG. 28 is each aberration diagram of the imaging lens of Example 13.

FIG. 29 is a cross-sectional view illustrating a configuration of an imaging lens of Example 14.

FIG. 30 is each aberration diagram of the imaging lens of Example 14.

FIG. 31 is a cross-sectional view illustrating a configuration of an imaging lens of Example 15.

FIG. 32 is each aberration diagram of the imaging lens of Example 15.

FIG. 33 is a perspective view of a front surface side of an imaging apparatus according to one embodiment.

FIG. 34 is a perspective view of a rear surface side of the imaging apparatus according to one embodiment.

### DETAILED DESCRIPTION

Hereinafter, an embodiment of the present disclosure will be described with reference to the drawings.

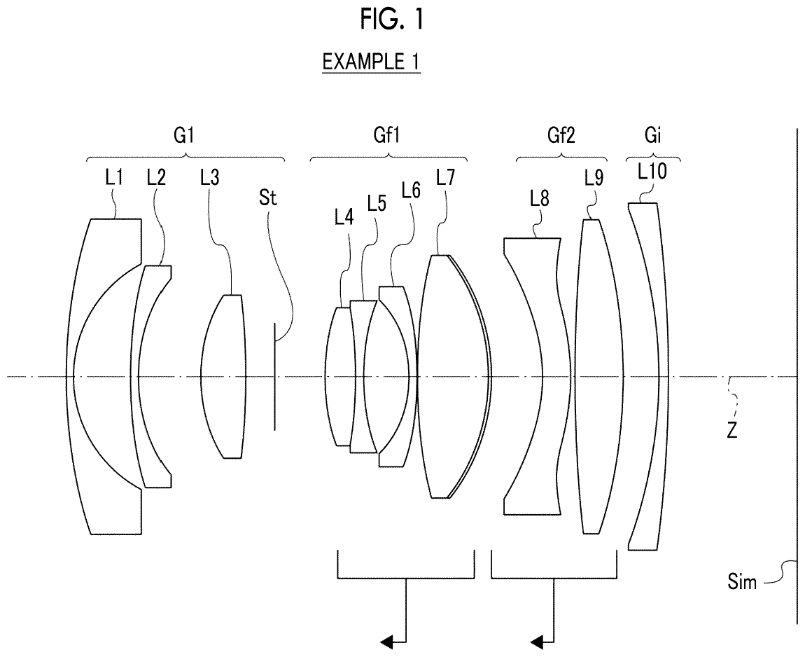

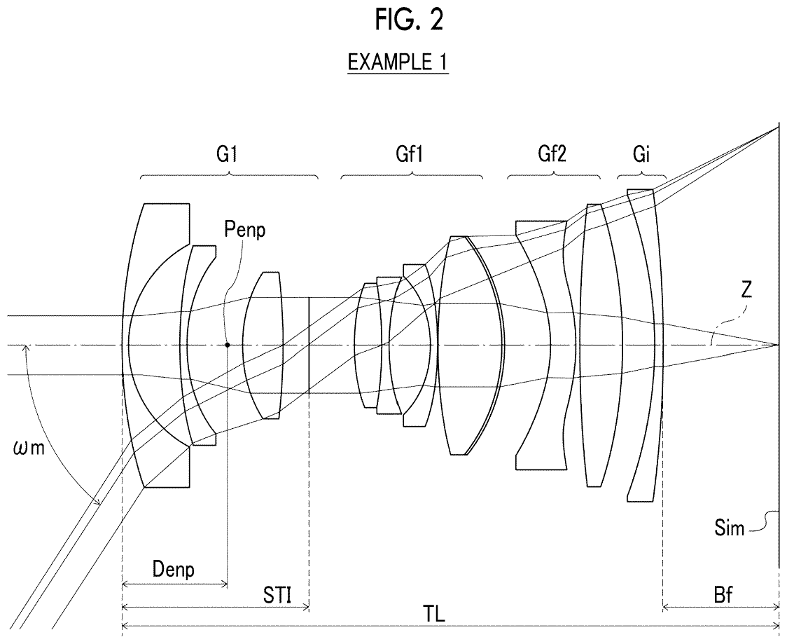

FIG. 1 illustrates a cross-sectional view of a configuration of an imaging lens according to one embodiment of the present disclosure. FIG. 2 is a cross-sectional view of a configuration and luminous fluxes of the imaging lens in FIG. 1. FIG. 2 illustrates an on-axis luminous flux and a luminous flux of a maximum half angle of view ωm as the luminous fluxes. FIGS. 1 and 2 illustrate a state where an infinite distance object is in focus, in which a left side is an object side and a right side is an image side. In the present specification, an object at an infinite distance will be referred to as the infinite distance object. The examples illustrated in FIGS. 1 and 2 correspond to an imaging lens of Example 1 described later. Hereinafter, description will be mainly provided with reference to FIG. 1.

The imaging lens of the present disclosure comprises a first lens group G1 and two or fewer focus lens groups disposed along an optical axis Z. The first lens group G1 is disposed closest to the object side and is fixed with respect to an image plane Sim during focusing. According to this configuration, a total length of an optical system does not change during focusing. Thus, the imaging lens can provide good usability. The two or fewer focus lens groups are lens groups that move along the optical axis Z during focusing. Focusing is performed by moving the two or fewer focus lens groups. One of the two or fewer focus lens groups is disposed adjacent to the first lens group G1 on the image side.

For example, the imaging lens in FIG. 1 comprises two focus lens groups. Hereinafter, in the configuration in which the imaging lens comprises two focus lens groups, a focus lens group on the object side out of the two focus lens groups will be referred to as a first focus lens group Gf1, and a focus lens group on the image side out of the two focus lens groups will be referred to as a second focus lens group Gf2. Leftward arrows below the first focus lens group Gf1 and the second focus lens group Gf2 in FIG. 1 indicate that those groups move to the object side during focusing from the infinite distance object to a nearest object.

For example, the imaging lens in FIG. 1 consists of, in order from the object side to the image side, the first lens group G1, the first focus lens group Gf1, the second focus lens group Gf2, and an image-side lens group Gi. During focusing, the first focus lens group Gf1 and the second focus lens group Gf2 move by different moving amounts. Moving the two focus lens groups by different moving amounts can favorably suppress fluctuation in aberrations caused by a change in an imaging distance.

During focusing, a lens group different from the first focus lens group Gf1 and the second focus lens group Gf2 is fixed with respect to the image plane Sim. That is, during focusing, the first lens group G1 and the image-side lens group Gi are fixed with respect to the image plane Sim. Disposing the image-side lens group Gi that has a refractive power and that is fixed with respect to the image plane Sim during focusing, adjacent to the second focus lens group Gf2 on the image side achieves an advantage in favorably correcting various aberrations. Moving all lenses between the first lens group G1 and the image-side lens group Gi during focusing facilitates suppression of fluctuation in the aberrations caused by focusing.

For example, each lens group of the imaging lens in FIG. 1 is configured as follows. The first lens group G1 consists of, in order from the object side to the image side, three lenses including lenses L1 to L3 and an aperture stop St. The first focus lens group Gf1 consists of, in order from the object side to the image side, four lenses including lenses L4 to L7. The second focus lens group Gf2 consists of, in order from the object side to the image side, two lenses including lenses L8 and L9. The image-side lens group Gi consists of one lens that is a lens L10. The aperture stop St in FIG. 1 does not indicate a size and a shape, and indicates a position in an optical axis direction. This illustration method of the aperture stop St also applies to other cross-sectional views.

A lens closest to the object side in the first lens group G1 is preferably a negative lens. Doing so achieves an advantage in implementing a wide angle. More specifically, the lens closest to the object side in the first lens group G1 is preferably a negative lens having a concave surface facing the image side. Doing so achieves a further advantage in implementing a wide angle.

The first lens group G1 preferably includes, in consecutive order from a position closest to the object side to the image side, a negative lens having a concave surface facing the image side and a negative lens having a concave surface facing the image side. Doing so achieves a still further advantage in implementing a wide angle. In the configuration in which the first lens group G1 includes, in consecutive order from the position closest to the object side to the image side, the negative lens having the concave surface facing the image side and the negative lens having the concave surface facing the image side, the second negative lens from the object side in the first lens group G1 may be configured to be a negative meniscus lens. Doing so achieves an advantage in achieving a wide angle.

A lens closest to the image side in the first lens group G1 is preferably a positive lens. Doing so achieves an advantage in correcting a spherical aberration.

It is preferable that the first lens group G1 includes at least one negative lens and at least one positive lens, and the number of lenses included in the first lens group G1 is four or less. Doing so achieves an advantage in favorably correcting various aberrations, and setting the number of lenses of the first lens group G1 to be four or less can suppress an increase in a size of the optical system.

For example, the first lens group G1 may be configured to include, in order from the object side to the image side, only three lenses consisting of a negative lens having a concave surface facing the image side, a negative lens having a concave surface facing the image side, and a positive lens as lenses. Providing the first lens group G1 with a three-lens configuration achieves an advantage in favorably correcting various aberrations while suppressing an increase in the size of the optical system.

The first focus lens group Gf1 preferably includes a cemented lens in which a positive lens and a negative lens are cemented in order from the object side. Doing so achieves an advantage in favorably correcting a chromatic aberration.

A lens closest to the image side in the image-side lens group Gi may be configured to be a negative lens having a concave surface facing the object side. Doing so achieves an advantage in favorably correcting a distortion.

Hereinafter, preferable configurations of the imaging lens of the present disclosure related to conditional expressions will be described. In the following description of the conditional expressions, in order to avoid redundancy, the same symbol will be used for the same definition to omit duplicate descriptions of the symbol.

Hereinafter, the “imaging lens of the present disclosure” will be simply referred to as the “imaging lens” in order to avoid redundancy.

In a case where the maximum half angle of view in the state where the infinite distance object is in focus is denoted by ωm, the imaging lens preferably satisfies Conditional Expression (1). Here, ωm is in degree units. Ensuring that a corresponding value of Conditional Expression (1) is not less than or equal to its lower limit can secure a wide angle of view and thus, can provide the imaging lens of high added value. Ensuring that the corresponding value of Conditional Expression (1) is not greater than or equal to its upper limit facilitates balancing between optical performance and size reduction.

$$35 < ω m < 76 \qquad ( 1 )$$

In order to obtain more favorable characteristics, the lower limit of Conditional Expression (1) is preferably set to any of 37, 39, 41, 42, 43, or 45 instead of 35. The upper limit of Conditional Expression (1) is preferably set to any of 74, 72, 70, 66, 63, or 60 instead of 76. For example, the imaging lens more preferably satisfies Conditional Expression (1-1) and further preferably satisfies Conditional Expression (1-2).

$$39 < ω m < 72 \qquad ( 1 - 1 )$$

$$41 < ω m < 70 \qquad ( 1 - 2 )$$

The imaging lens preferably satisfies Conditional Expression (2). Aback focus Bf of the entire system as an air conversion distance in the state where the infinite distance object is in focus is denoted by Bf A focal length of the entire system in the state where the infinite distance object is in focus is denoted by f. The back focus Bf as the air conversion distance is an air conversion distance on the optical axis from a lens surface of the imaging lens closest to the image side to the image plane Sim. For example, FIG. 2 illustrates the back focus Bf Here, tan denotes a tangent. Ensuring that a corresponding value of Conditional Expression (2) is not less than or equal to its lower limit can suppress an increase in a diameter of a lens closest to the image side in the imaging lens. Ensuring that the corresponding value of Conditional Expression (2) is not greater than or equal to its upper limit achieves an advantage in reducing the total length of the optical system.

$$0.3 < Bf / ( f \times tan ω m ) < 1.2 \qquad ( 2 )$$

In order to obtain more favorable characteristics, the lower limit of Conditional Expression (2) is preferably set to any of 0.35, 0.37, or 0.4 instead of 0.3. The upper limit of Conditional Expression (2) is preferably set to any of 1.1, 1, or 0.92 instead of 1.2.

The imaging lens preferably satisfies Conditional Expression (3). A sum of a distance on the optical axis from a lens surface of the imaging lens closest to the object side to the lens surface of the imaging lens closest to the image side and the back focus Bf of the entire system as the air conversion distance in the state where the infinite distance object is in focus is denoted by TL. TL denotes the total length of the lens system. For example, FIG. 2 illustrates the total length TL of the lens system. Ensuring that a corresponding value of Conditional Expression (3) is not less than or equal to its lower limit achieves an advantage in maintaining high optical performance. Ensuring that the corresponding value of Conditional Expression (3) is not greater than or equal to its upper limit achieves an advantage in size reduction of the optical system.

$$1. 4 < TL / ( f \times tan ω m ) < 3.5 \qquad ( 3 )$$

In order to obtain more favorable characteristics, the lower limit of Conditional Expression (3) is preferably set to any of 1.5, 1.6, 1.7, 1.8, or 1.9 instead of 1.4. The upper limit of Conditional Expression (3) is preferably set to any of 3.4, 3.3, 3.2, 3.1, or 3 instead of 3.5. For example, the imaging lens more preferably satisfies Conditional Expression (3-1).

$$1. 7 < TL / ( f \times tan ω m ) < 3.2 \qquad ( 3 - 1 )$$

In a case where an open F-number in the state where the infinite distance object is in focus is denoted by FNo, the imaging lens preferably satisfies Conditional Expression (4). Ensuring that a corresponding value of Conditional Expression (4) is not less than or equal to its lower limit achieves an advantage in suppressing an increase in the number of lenses and suppressing an increase in the size of the lens system while obtaining favorable optical performance. Ensuring that the corresponding value of Conditional Expression (4) is not greater than or equal to its upper limit can increase the angle of view or reduce the open F-number and thus, can support a wide range of applications and provide the imaging lens of high value.

$$1 < FNo / tan ω m < 4.5 \qquad ( 4 )$$

In order to obtain more favorable characteristics, the lower limit of Conditional Expression (4) is preferably set to any of 1.1, 1.2, 1.3, 1.4, or 1.5 instead of 1. The upper limit of Conditional Expression (4) is preferably set to any of 4, 3.5, 3, 2.75, or 2.5 instead of 4.5. For example, the imaging lens more preferably satisfies Conditional Expression (4-1) and further preferably satisfies Conditional Expression (4-2).

$$1.4 < FNo / tan ω m < 2.75 \qquad ( 4 - 1 )$$

$$1.5 < FN o / tan ω m < 2.5 \qquad ( 4 - 2 )$$

The imaging lens preferably satisfies Conditional Expression (5). Ensuring that a corresponding value of Conditional Expression (5) is not less than or equal to its lower limit facilitates securing of high optical performance or achieves an advantage in size reduction of the optical system. Ensuring that the corresponding value of Conditional Expression (5) is not greater than or equal to its upper limit can implement an optical system having a small F-number.

$$2.2 < FNo < 4.2 \qquad ( 5 )$$

In order to obtain more favorable characteristics, the lower limit of Conditional Expression (5) is preferably set to any of 2.4, 2.5, 2.6, 2.7, or 2.8 instead of 2.2. The upper limit of Conditional Expression (5) is preferably set to any of 4.1, 4, 3.9, 3.8, or 3.7 instead of 4.2.

In the configuration in which the imaging lens comprises the aperture stop St, the imaging lens preferably satisfies Conditional Expression (6). A distance on the optical axis from a lens surface of the first lens group G1 closest to the object side to the aperture stop St in the state where the infinite distance object is in focus is denoted by STI. For example, FIG. 2 illustrates the distance STI. Ensuring that a corresponding value of Conditional Expression (6) is not less than or equal to its lower limit can secure a sufficient space on the object side with respect to the aperture stop St. Thus, by disposing an appropriate number of lenses, the imaging lens can be configured without unnecessarily reducing an absolute value of a curvature radius of the lens. This facilitates suitable correction of various aberrations. Ensuring that the corresponding value of Conditional Expression (6) is not greater than or equal to its upper limit can prevent a position of the aperture stop St from being excessively close to the image plane Sim and thus, can prevent an excessively large incidence angle of an off-axis principal ray incident on an imaging element disposed on the image plane Sim in an imaging apparatus.

$$0.06 < STI / TL < 0 \text{.45} \qquad ( 6 )$$

In order to obtain more favorable characteristics, the lower limit of Conditional Expression (6) is preferably set to 0.07 or 0.09 instead of 0.06. The upper limit of Conditional Expression (6) is preferably set to 0.4 or 0.35 instead of 0.45. For example, the imaging lens more preferably satisfies Conditional Expression (6-1).

$$0.09 < STI / TL < 0 \text{.35} \qquad ( 6 - 1 )$$

In a case where a maximum imaging magnification is denoted by β, the imaging lens preferably satisfies Conditional Expression (7). In the present specification, an imaging magnification in a state where the nearest object is in focus will be referred to as the maximum imaging magnification. Ensuring that a corresponding value of Conditional Expression (7) is not less than or equal to its lower limit can suppress reduction of an imageable region of the optical system and thus, can secure added value suitable for the imaging lens. Ensuring that the corresponding value of Conditional Expression (7) is not greater than or equal to its upper limit can reduce a moving amount of a lens group during focusing and thus, can contribute to size reduction of the optical system.

$$0.05 < \vert β \vert < 0.3 \qquad ( 7 )$$

In order to obtain more favorable characteristics, the lower limit of Conditional Expression (7) is preferably set to any of 0.06, 0.07, 0.08, or 0.09 instead of 0.05. The upper limit of Conditional Expression (7) is preferably set to any of 0.28, 0.26, 0.24, or 0.22 instead of 0.3.

In a case where a focal length of the first lens group G1 is denoted by f1, the imaging lens preferably satisfies Conditional Expression (8). Ensuring that a corresponding value of Conditional Expression (8) is not less than or equal to its lower limit prevents an excessively strong negative refractive power of the first lens group G1 and thus, achieves an advantage in reducing the total length of the optical system and facilitates securing of an edge part light quantity. Ensuring that the corresponding value of Conditional Expression (8) is not greater than or equal to its upper limit prevents an excessively strong positive refractive power of the first lens group G1 and thus, facilitates correction of the spherical aberration and a field curvature.

$$- 1.5 < f / f 1 < 1.5 \qquad ( 8 )$$

In order to obtain more favorable characteristics, the lower limit of Conditional Expression (8) is preferably set to −1.1 or −0.8 instead of −1.5. The upper limit of Conditional Expression (8) is preferably set to 1.15 or 0.25 instead of 1.5. For example, the imaging lens more preferably satisfies Conditional Expression (8-1).

$$- 0.8 < f / f 1 < 0.25 \qquad ( 8 - 1 )$$

The imaging lens preferably satisfies Conditional Expression (9). A distance on the optical axis from the lens surface of the imaging lens closest to the object side to a paraxial entrance pupil position Penp in the state where the infinite distance object is in focus is denoted by Denp. For example, FIG. 2 illustrates the distance Denp and the paraxial entrance pupil position Penp. Ensuring that a corresponding value of Conditional Expression (9) is not less than or equal to its lower limit achieves an advantage in suppressing the distortion. Ensuring that the corresponding value of Conditional Expression (9) is not greater than or equal to its upper limit achieves an advantage in size reduction of the optical system.

$$0.05 < Denp / f < 1 \qquad ( 9 )$$

In order to obtain more favorable characteristics, the lower limit of Conditional Expression (9) is preferably set to 0.1 or 0.12 instead of 0.05. The upper limit of Conditional Expression (9) is preferably set to 0.8 or 0.7 instead of 1.

In the configuration in which the lens closest to the object side in the first lens group G1 is the negative lens, the imaging lens preferably satisfies Conditional Expression (10). A paraxial curvature radius of a surface, on the object side, of the negative lens closest to the object side in the first lens group G1 is denoted by R1f A paraxial curvature radius of a surface, on the image side, of the negative lens closest to the object side in the first lens group G1 is denoted by R1r. Conditional Expression (10) defines a shape factor of the lens. Ensuring that a corresponding value of Conditional Expression (10) is not less than or equal to its lower limit facilitates favorable correction of an astigmatism. Ensuring that the corresponding value of Conditional Expression (10) is not greater than or equal to its upper limit facilitates favorable correction of the spherical aberration. Ensuring that the corresponding value of Conditional Expression (10) is not greater than or equal to its upper limit prevents an excessively weak refractive power of the lens and thus, facilitates achieving of a wide angle.

$$0.1 < ( R 1 f + R 1 r ) / ( R 1 f - R 1 r ) < 5 \qquad ( 10 )$$

In order to obtain more favorable characteristics, the lower limit of Conditional Expression (10) is preferably set to 0.25 or 0.4 instead of 0.1. The upper limit of Conditional Expression (10) is preferably set to 4.5 or 4 instead of 5.

In the configuration in which the lens closest to the object side in the first lens group G1 is the negative lens, the imaging lens preferably satisfies Conditional Expression (11).

Ensuring that a corresponding value of Conditional Expression (11) is not less than or equal to its lower limit facilitates correction of the distortion. Ensuring that the corresponding value of Conditional Expression (11) is not greater than or equal to its upper limit facilitates correction of the astigmatism.

$$- 3 < f / R 1 f < 4 \qquad ( 11 )$$

In order to obtain more favorable characteristics, the lower limit of Conditional Expression (11) is preferably set to −2 or −1 instead of −3. The upper limit of Conditional Expression (11) is preferably set to 2.5 or 1.35 instead of 4.

In the configuration in which the lens closest to the object side in the first lens group G1 is the negative lens, the imaging lens preferably satisfies Conditional Expression (12). Afocal length of the negative lens closest to the object side in the first lens group G1 is denoted by fL1. Ensuring that a corresponding value of Conditional Expression (12) is not less than or equal to its lower limit facilitates correction of the field curvature. Ensuring that the corresponding value of Conditional Expression (12) is not greater than or equal to its upper limit facilitates correction of the distortion.

$$0.1 < f / ( - fL 1 ) < 3.5 \qquad ( 12 )$$

In order to obtain more favorable characteristics, the lower limit of Conditional Expression (12) is preferably set to 0.25 or 0.4 instead of 0.1. The upper limit of Conditional Expression (12) is preferably set to 2.5 or 1.5 instead of 3.5.

The imaging lens preferably satisfies Conditional Expression (13). A paraxial curvature radius of a surface, on the object side, of a lens which is second from the object side in the first lens group G1 is denoted by R2f. A paraxial curvature radius of a surface, on the image side, of the lens which is second from the object side in the first lens group G1 is denoted by R2r. Ensuring that a corresponding value of Conditional Expression (13) is not less than or equal to its lower limit facilitates favorable correction of the astigmatism. Ensuring that the corresponding value of Conditional Expression (13) is not greater than or equal to its upper limit facilitates favorable correction of the spherical aberration. Ensuring that the corresponding value of Conditional Expression (13) is not greater than or equal to its upper limit prevents an excessively weak refractive power of the lens and thus, facilitates achieving of a wide angle.

$$- 3 < ( R 2 f + R 2 r ) / ( R 2 f - R 2 r ) < 8 \qquad ( 13 )$$

In order to obtain more favorable characteristics, the lower limit of Conditional Expression (13) is preferably set to −2 or −1 instead of −3. The upper limit of Conditional Expression (13) is preferably set to 7 or 6.5 instead of 8.

In the configuration in which the lens closest to the image side in the first lens group G1 is the positive lens, the imaging lens preferably satisfies Conditional Expression (14). A paraxial curvature radius of a surface, on the object side, of the positive lens closest to the image side in the first lens group G1 is denoted by R1rf. A paraxial curvature radius of a surface, on the image side, of the positive lens closest to the image side in the first lens group G1 is denoted by R1rr. Ensuring that a corresponding value of Conditional Expression (14) is not less than or equal to its lower limit facilitates favorable correction of the spherical aberration. Ensuring that the corresponding value of Conditional Expression (14) is not greater than or equal to its upper limit facilitates favorable correction of the astigmatism.

$$- 4 < ( R 1 rf + R 1 rr ) / ( R 1 rf - R 1 rr ) < 0 \qquad ( 14 )$$

In order to obtain more favorable characteristics, the lower limit of Conditional Expression (14) is preferably set to −3.5 or −3 instead of −4. The upper limit of Conditional Expression (14) is preferably set to −0.1 or −0.2 instead of 0.

In the configuration in which the lens closest to the image side in the first lens group Gi is the positive lens, the imaging lens preferably satisfies Conditional Expression (15). An Abbe number based on a d line for the positive lens closest to the image side in the first lens group G1 is denoted by v1r. Ensuring that a corresponding value of Conditional Expression (15) is not less than or equal to its lower limit facilitates correction of the chromatic aberration.

Ensuring that the corresponding value of Conditional Expression (15) is not greater than or equal to its upper limit enables use of an easily obtainable material and thus, facilitates implementation of favorable correction of various aberrations other than the chromatic aberration.

$$22 < v 1 r < 85 \qquad ( 15 )$$

In order to obtain more favorable characteristics, the lower limit of Conditional Expression (15) is preferably set to 30 or 35 instead of 22. The upper limit of Conditional Expression (15) is preferably set to 84 or 72 instead of 85.

In a case where an average value of relative densities of all lenses included in the first lens group Gi is denoted by ρ1ave, the imaging lens preferably satisfies Conditional Expression (16). Ensuring that a corresponding value of Conditional Expression (16) is not less than or equal to its lower limit enables use of an easily obtainable material and thus, facilitates implementation of favorable correction of various aberrations. Ensuring that the corresponding value of Conditional Expression (16) is not greater than or equal to its upper limit achieves an advantage in weight reduction of the first lens group G1.

$$2.3 < ρ 1 ave < 4.7 \qquad ( 16 )$$

In order to obtain more favorable characteristics, the lower limit of Conditional Expression (16) is preferably set to 2.5 or 2.7 instead of 2.3. The upper limit of Conditional Expression (16) is preferably set to 4.2 or 3.7 instead of 4.7.

The first lens group Gi may be configured to include an aspherical lens having a concave surface facing the image side. In the configuration in which the first lens group G1 includes the aspherical lens having the concave surface facing the image side, the imaging lens preferably satisfies Conditional Expression (17). The following symbols of the conditional expressions are defined for the aspherical lens having the concave surface facing the image side in the first lens group G1. A paraxial curvature radius of a surface of the aspherical lens on the object side is denoted by Rc1f. A paraxial curvature radius of a surface of the aspherical lens on the image side is denoted by Rc1r. A curvature radius of the surface of the aspherical lens on the object side at a position of a maximum effective diameter is denoted by Ry1f. A curvature radius of the surface of the aspherical lens on the image side at the position of the maximum effective diameter is denoted by Ry1r. Ensuring that a corresponding value of Conditional Expression (17) is not less than or equal to its lower limit prevents an excessively strong refractive power on an edge part side of the lens and thus, achieves an advantage in correcting the distortion. Ensuring that the corresponding value of Conditional Expression (17) is not greater than or equal to its upper limit prevents an excessively weak refractive power on the edge part side of the lens and thus, achieves an advantage in suppressing the astigmatism caused by an off-axis ray on the edge part side of the lens.

$$0. 4 < ( 1 / Rc 1 f - 1 / Rc 1 r ) / ( 1 / Ry 1 f - 1 / Ry 1 r ) < 2.4 \qquad ( 17 )$$

In order to obtain more favorable characteristics, the lower limit of Conditional Expression (17) is preferably set to 0.7 or 1 instead of 0.4. The upper limit of Conditional Expression (17) is preferably set to 2 or 1.8 instead of 2.4.

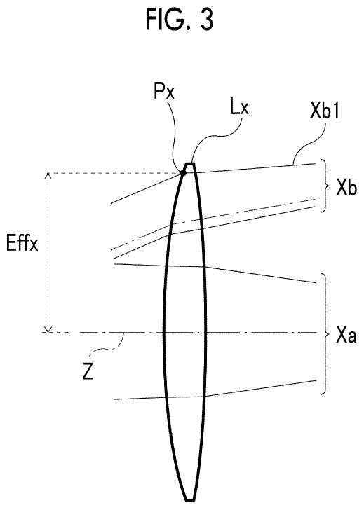

FIG. 3 illustrates an example of a position Px of the maximum effective diameter as a diagram for description. In FIG. 3, a left side is the object side, and a right side is the image side. FIG. 3 illustrates an on-axis luminous flux Xa and an off-axis luminous flux Xb that pass through a lens Lx. In the example in FIG. 3, a ray Xb1 that is an upper ray of the off-axis luminous flux Xb is a ray passing through the most outer side. In the present specification, a distance from an intersection between the ray passing through the most outer side and a lens surface to the optical axis Z among rays that are incident on the lens surface from the object side and that exit to the image side will be referred to as an “effective radius” of the lens surface. The term “outer side” means an outer side in a diameter direction centered on the optical axis Z, that is, a side away from the optical axis Z. In the example in FIG. 3, a distance from an intersection between a surface of the lens Lx on the object side and the ray Xb1 to the optical axis Z is an effective radius Effx of the surface of the lens Lx on the object side. A position of the intersection between the ray passing through the most outer side and the lens surface is the position Px of the maximum effective diameter. While the upper ray of the off-axis luminous flux Xb is the ray passing through the most outer side in the example in FIG. 3, which ray is the ray passing through the most outer side varies depending on the optical system.

In the configuration in which the imaging lens comprises two focus lens groups, the imaging lens preferably satisfies Conditional Expression (18). A focal length of the first focus lens group Gf1 is denoted by ff1. A focal length of the second focus lens group Gf2 is denoted by ff2. Ensuring that a corresponding value of Conditional Expression (18) is not less than or equal to its lower limit prevents an excessively strong refractive power of the first focus lens group Gf1 and thus, facilitates correction of the astigmatism. Ensuring that the corresponding value of Conditional Expression (18) is not greater than or equal to its upper limit prevents an excessively weak refractive power of the first focus lens group Gf1 and thus, facilitates correction of the field curvature.

$$0.04 < ff 1 / ff 2 < 2 \qquad ( 18 )$$

In order to obtain more favorable characteristics, the lower limit of Conditional Expression (18) is preferably set to any of 0.06, 0.08, or 0.1 instead of 0.04. The upper limit of Conditional Expression (18) is preferably set to any of 1.7, 1.3, or 0.9 instead of 2. For example, the imaging lens more preferably satisfies Conditional Expression (18-1).

$$0 \text{.1} < ff 1 / ff 2 < 0.9 \qquad ( 18 - 1 )$$

In the configuration in which the imaging lens comprises two focus lens groups, the imaging lens preferably satisfies Conditional Expression (19). A lateral magnification of the first focus lens group Gf1 in the state where the infinite distance object is in focus is denoted by βf1. A lateral magnification of the second focus lens group Gf2 in the state where the infinite distance object is in focus is denoted by βf2. Ensuring that a corresponding value of Conditional Expression (19) is not less than or equal to its lower limit facilitates correction of the astigmatism during focusing on a short range object. Ensuring that the corresponding value of Conditional Expression (19) is not greater than or equal to its upper limit facilitates correction of the field curvature during focusing on the short range object.

$$- 1 < β f 1 / β f 2 < 1.2 \qquad ( 19 )$$

In order to obtain more favorable characteristics, the lower limit of Conditional Expression (19) is preferably set to −0.8 or −0.4 instead of −1. The upper limit of Conditional Expression (19) is preferably set to 0.7 or 0.25 instead of 1.2.

In the configuration in which the imaging lens comprises two focus lens groups, the imaging lens preferably satisfies Conditional Expression (20). Ensuring that a corresponding value of Conditional Expression (20) is not less than or equal to its lower limit facilitates correction of the spherical aberration and an axial chromatic aberration. Ensuring that the corresponding value of Conditional Expression (20) is not greater than or equal to its upper limit facilitates correction of the astigmatism and can reduce the moving amount of the first focus lens group Gf1 from the state where the infinite distance object is in focus to the state where the nearest object is in focus, and thus, achieves an advantage in size reduction.

$$0 < {\{ β f 1 + ( 1 / β f 1 ) \}}^{- 2} < 0 \text{.25} \qquad ( 20 )$$

In order to obtain more favorable characteristics, the lower limit of Conditional Expression (20) is preferably set to 0.01 or 0.03 instead of 0. The upper limit of Conditional Expression (20) is preferably set to 0.22 or 0.2 instead of 0.25.

In the configuration in which the imaging lens comprises two focus lens groups, the imaging lens preferably satisfies Conditional Expression (21). Ensuring that a corresponding value of Conditional Expression (21) is not less than or equal to its lower limit facilitates correction of the field curvature and the astigmatism. Ensuring that the corresponding value of Conditional Expression (21) is not greater than or equal to its upper limit facilitates correction of the astigmatism and can reduce the moving amount of the second focus lens group Gf2 from the state where the infinite distance object is in focus to the state where the nearest object is in focus, and thus, achieves an advantage in size reduction.

$$0.05 < {\{ β f 2 + ( 1 / β f 2 ) \}}^{- 2} < 0 \text{.25} \qquad ( 21 )$$

In order to obtain more favorable characteristics, the lower limit of Conditional Expression (21) is preferably set to 0.1 or 0.15 instead of 0.05.

The upper limit of Conditional Expression (21) is preferably set to 0.24 or 0.22 instead of 0.25.

In the configuration in which the imaging lens comprises two focus lens groups, the imaging lens preferably satisfies Conditional Expression (22). The focal length of the first focus lens group Gf1 is denoted by ff1. Ensuring that a corresponding value of Conditional Expression (22) is not less than or equal to its lower limit prevents an excessively weak refractive power of the first focus lens group Gf1 and thus, facilitates correction of the spherical aberration. Ensuring that the corresponding value of Conditional Expression (22) is not greater than or equal to its upper limit prevents an excessively strong refractive power of the first focus lens group Gf1 and thus, facilitates correction of the astigmatism.

$$0.1 < f / ff 1 < 1.5 \qquad ( 22 )$$

In order to obtain more favorable characteristics, the lower limit of Conditional Expression (22) is preferably set to 0.17 or 0.25 instead of 0.1. The upper limit of Conditional Expression (22) is preferably set to 1.3 or 1.1 instead of 1.5.

In the configuration in which the imaging lens comprises two focus lens groups, and the first focus lens group Gf1 includes the cemented lens in which the positive lens and the negative lens are cemented in order from the object side, the imaging lens preferably satisfies Conditional Expression (23). An Abbe number based on a d line for the positive lens of the cemented lens is denoted by vf1p. An Abbe number based on a d line for the negative lens of the cemented lens is denoted by vf1n. Satisfying Conditional Expression (23) facilitates favorable correction of the chromatic aberration.

$$- 15 < ν f 1 p - ν f 1 n < 25 \qquad ( 23 )$$

In order to obtain more favorable characteristics, the lower limit of Conditional Expression (23) is preferably set to −12 or −9 instead of −15. The upper limit of Conditional Expression (23) is preferably set to 20 or 17 instead of 25.

In the configuration in which the imaging lens comprises two focus lens groups, and the first focus lens group Gf1 includes the cemented lens in which the positive lens and the negative lens are cemented in order from the object side, the imaging lens preferably satisfies Conditional Expression (24). A refractive index with respect to the d line for the positive lens of the cemented lens is denoted by Nf1p. A refractive index with respect to the d line for the negative lens of the cemented lens is denoted by Nf1n. Satisfying Conditional Expression (24) facilitates favorable correction of the chromatic aberration.

$$0 < Nf 1 p - Nf 1 n < 0.45 \qquad ( 24 )$$

In order to obtain more favorable characteristics, the lower limit of Conditional Expression (24) is preferably set to 0.05 or 0.1 instead of 0. The upper limit of Conditional Expression (24) is preferably set to 0.35 or 0.27 instead of 0.45.

In the configuration in which the imaging lens comprises two focus lens groups, the imaging lens preferably satisfies Conditional Expression (25). An average value of an effective radius of a surface of the first focus lens group Gf1 closest to the image side and an effective radius of a surface of the second focus lens group Gf2 closest to the image side is denoted by Effave. Ensuring that a corresponding value of Conditional Expression (25) is not less than or equal to its lower limit achieves an advantage in securing a sufficient edge part light quantity. Ensuring that the corresponding value of Conditional Expression (25) is not greater than or equal to its upper limit can suppress an increase in diameters of the lenses of the first focus lens group Gf1 and the second focus lens group Gf2 and thus, can achieve size reduction and weight reduction. This can contribute to improvement of a degree of freedom in disposing a mechanism for holding the lens.

$$0.3 < Effave / ( f \times tan ω m ) < 0.7 \qquad ( 25 )$$

In order to obtain more favorable characteristics, the lower limit of Conditional Expression (25) is preferably set to 0.35 or 0.38 instead of 0.3.

The upper limit of Conditional Expression (25) is preferably set to 0.65 or 0.62 instead of 0.7.

In a case where a focal length of the image-side lens group Gi is denoted by fi, the imaging lens preferably satisfies Conditional Expression (26). Ensuring that a corresponding value of Conditional Expression (26) is not less than or equal to its lower limit prevents an excessively weak refractive power of the image-side lens group Gi and thus, facilitates correction of the field curvature. Ensuring that the corresponding value of Conditional Expression (26) is not greater than or equal to its upper limit prevents an excessively strong refractive power of the image-side lens group Gi and thus, facilitates correction of a lateral chromatic aberration and the distortion and facilitates separation of an exit pupil position from the image plane Sim.

$$0.05 < f / ( - fi ) < 0.7 \qquad ( 26 )$$

In order to obtain more favorable characteristics, the lower limit of Conditional Expression (26) is preferably set to 0.1 or 0.15 instead of 0.05. The upper limit of Conditional Expression (26) is preferably set to 0.6 or 0.5 instead of 0.7.

In the configuration in which the lens closest to the image side in the image-side lens group Gi is the negative lens having the concave surface facing the object side, the imaging lens preferably satisfies Conditional Expression (27). A refractive index with respect to a d line for the negative lens closest to the image side in the image-side lens group Gi is denoted by Nir. Ensuring that a corresponding value of Conditional Expression (27) is not less than or equal to its lower limit achieves an advantage in correcting the distortion. Ensuring that the corresponding value of Conditional Expression (27) is not greater than or equal to its upper limit achieves an advantage in securing the edge part light quantity.

$$1.45 < Nir < 2.2 \qquad ( 27 )$$

In order to obtain more favorable characteristics, the lower limit of Conditional Expression (27) is preferably set to 1.6 or 1.7 instead of 1.45. The upper limit of Conditional Expression (27) is preferably set to 2.1 or 2.05 instead of 2.2.

In a case where the imaging lens comprises two focus lens groups, the first focus lens group Gf1 may be configured to include an aspherical lens having a concave surface facing the object side. In the configuration in which the imaging lens comprises two focus lens groups, and the first focus lens group Gf1 includes the aspherical lens having the concave surface facing the object side, the imaging lens preferably satisfies Conditional Expression (28). The following symbols of the conditional expression are defined for the aspherical lens having the concave surface facing the object side in the first focus lens group Gf1. A paraxial curvature radius of a surface of the aspherical lens on the object side is denoted by Rcff1f. A paraxial curvature radius of a surface of the aspherical lens on the image side is denoted by Rcff1r. A curvature radius of the surface of the aspherical lens on the object side at the position of the maximum effective diameter is denoted by Ryff1f. A curvature radius of the surface of the aspherical lens on the image side at the position of the maximum effective diameter is denoted by Ryff1r. Ensuring that a corresponding value of Conditional Expression (28) is not less than or equal to its lower limit prevents an excessively strong refractive power on the edge part side of the lens and thus, achieves an advantage in correcting fluctuation in the astigmatism during focusing. Ensuring that the corresponding value of Conditional Expression (28) is not greater than or equal to its upper limit prevents an excessively weak refractive power on the edge part side of the lens and thus, achieves an advantage in suppressing the astigmatism caused by the off-axis ray on the edge part side of the lens.

$$0.1 < ( 1 / Rcff 1 f - 1 / Rcff 1 r ) / ( 1 / Ryff 1 f - 1 / Ryff 1 r ) < 1.6 \qquad ( 28 )$$

In order to obtain more favorable characteristics, the lower limit of Conditional Expression (28) is preferably set to 0.3 or 0.4 instead of 0.1. The upper limit of Conditional Expression (28) is preferably set to 1.4 or 1.2 instead of 1.6.

In a case where the imaging lens comprises two focus lens groups, the second focus lens group Gf2 may be configured to include an aspherical lens having a concave surface facing the object side. In the configuration in which the imaging lens comprises two focus lens groups, and the second focus lens group Gf2 includes the aspherical lens having the concave surface facing the object side, the imaging lens preferably satisfies Conditional Expression (29).

The following symbols of the conditional expression are defined for the aspherical lens having the concave surface facing the object side in the second focus lens group Gf2. A paraxial curvature radius of a surface of the aspherical lens on the object side is denoted by Rcff2f. A paraxial curvature radius of a surface of the aspherical lens on the image side is denoted by Rcff2r. A curvature radius of the surface of the aspherical lens on the object side at the position of the maximum effective diameter is denoted by Ryff2f. A curvature radius of the surface of the aspherical lens on the image side at the position of the maximum effective diameter is denoted by Ryff2r. Ensuring that a corresponding value of Conditional Expression (29) is not less than or equal to its lower limit prevents an excessively large difference between the refractive power on the edge part side and a refractive power at a center of the lens and thus, can suppress overcorrection of the field curvature. Ensuring that the corresponding value of Conditional Expression (29) is not greater than or equal to its upper limit prevents an excessively small difference between the refractive power on the edge part side and the refractive power at the center of the lens and thus, achieves an advantage in correcting the field curvature.

$$0 < ( 1 / Rcff 2 f - 1 / Rcff 2 r ) / ( 1 / Ryff 2 f - 1 / Ryff 2 r ) < 0.6 \qquad ( 29 )$$

In order to obtain more favorable characteristics, the lower limit of Conditional Expression (29) is preferably set to 0.05 or 0.1 instead of 0. The upper limit of Conditional Expression (29) is preferably set to 0.5 or 0.4 instead of 0.6.

The imaging lens preferably includes at least one Lp lens that is a positive lens satisfying Conditional Expressions (38), (39), (40), and (41). A refractive index with respect to a d line for the Lp lens is denoted by Np. An Abbe number based on the d line for the Lp lens is denoted by vp. A partial dispersion ratio of the Lp lens between a g line and an F line is denoted by θgFp. In the example in FIG. 1, the lens L7 and the lens L9 correspond to the Lp lens.

$$0.005 < Np - ( 2.015 - 0.0068 \times ν p ) < 0.15 \qquad ( 38 )$$

$$50 < ν p < 65 \qquad ( 39 )$$

$$0.545 < θ gFp < 0.58 \qquad ( 40 )$$

$$- 0.011 < θ gFp - ( 0.6418 - 0.00168 \times ν p ) < 0.035 \qquad ( 41 )$$

Ensuring that a corresponding value of Conditional Expression (38) is not less than or equal to its lower limit facilitates correction of the chromatic aberration. Ensuring that the corresponding value of Conditional Expression (38) is not greater than or equal to its upper limit facilitates performing correction of the spherical aberration and correction of the chromatic aberration at the same time.

In order to obtain more favorable characteristics, the lower limit of Conditional Expression (38) is preferably set to any of 0.02, 0.03, 0.04, or 0.05 instead of 0.005. The upper limit of Conditional Expression (38) is preferably set to any of 0.14, 0.13, 0.12, or 0.11 instead of 0.15.

Ensuring that a corresponding value of Conditional Expression (39) is not less than or equal to its lower limit facilitates correction of the chromatic aberration. Ensuring that the corresponding value of Conditional Expression (39) is not greater than or equal to its upper limit enables use of an easily obtainable material and thus, facilitates implementation of favorable correction of various aberrations other than the chromatic aberration.

In order to obtain more favorable characteristics, the lower limit of Conditional Expression (39) is preferably set to 50.1 or 50.2 instead of 50. The upper limit of Conditional Expression (39) is preferably set to 63 or 59 instead of 65.

Ensuring that a corresponding value of Conditional Expression (40) is not less than or equal to its lower limit facilitates correction of the chromatic aberration. Ensuring that the corresponding value of Conditional Expression (40) is not greater than or equal to its upper limit enables use of an easily obtainable material and thus, facilitates implementation of favorable correction of various aberrations other than the chromatic aberration.

In order to obtain more favorable characteristics, the lower limit of Conditional Expression (40) is preferably set to 0.546 or 0.547 instead of 0.545. The upper limit of Conditional Expression (40) is preferably set to 0.57 or 0.56 instead of 0.58.

Ensuring that a corresponding value of Conditional Expression (41) is not less than or equal to its lower limit facilitates correction of the chromatic aberration. Ensuring that the corresponding value of Conditional Expression (41) is not greater than or equal to its upper limit enables use of an easily obtainable material and thus, facilitates implementation of favorable correction of various aberrations other than the chromatic aberration.

In order to obtain more favorable characteristics, the lower limit of Conditional Expression (41) is preferably set to any of −0.01, −0.009, or −0.008 instead of −0.011. The upper limit of Conditional Expression (41) is preferably set to any one of 0.025, 0.015, or 0.005 instead of 0.035.

In a case where the imaging lens comprises the aperture stop St, the Lp lens may be configured to be disposed on the image side with respect to the aperture stop St. Doing so facilitates effective correction of the lateral chromatic aberration. In the configuration in which the imaging lens comprises the aperture stop St, and the Lp lens is disposed on the image side with respect to the aperture stop St, the imaging lens preferably satisfies Conditional Expressions (4-2) and (6-1) and more preferably satisfies Conditional Expressions (4-2), (6-1), and (3-1).

The example illustrated in FIG. 1 is merely an example and can be subjected to various modifications without departing from the gist of the disclosed technology. For example, the number of lens groups included in the imaging lens and the number of lenses included in each lens group may be different from those in the example in FIG. 1.

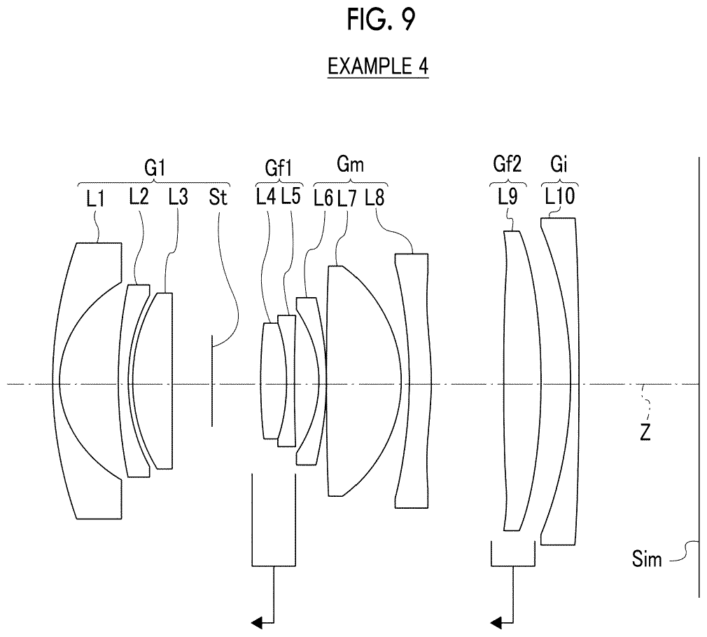

While the first focus lens group Gf1 and the second focus lens group Gf2 are consecutively disposed in the example in FIG. 1, the imaging lens of the present disclosure is not limited to this configuration. In the imaging lens of the present disclosure, another lens group may be disposed between the first focus lens group Gf1 and the second focus lens group Gf2. For example, as illustrated in FIG. 9, the imaging lens may be configured to include, between the first focus lens group Gf1 and the second focus lens group Gf2, a middle lens group Gm that has a positive refractive power and that is fixed with respect to the image plane Sim during focusing. In the configuration in which the imaging lens includes the middle lens group Gm between the first focus lens group Gf1 and the second focus lens group Gf2, the imaging lens preferably satisfies Conditional Expression (30). A focal length of the middle lens group Gm is denoted by fm. Ensuring that a corresponding value of Conditional Expression (30) is not less than or equal to its lower limit prevents an excessively strong refractive power of the middle lens group Gm and thus, facilitates suppression of fluctuation in the aberrations during focusing. Ensuring that the corresponding value of Conditional Expression (30) is not greater than or equal to its upper limit prevents an excessively strong refractive power of the first focus lens group Gf1 and thus, facilitates suppression of fluctuation in the angle of view during focusing.

$$0.2 < fm / ff 1 < 1 \qquad ( 30 )$$

In order to obtain more favorable characteristics, the lower limit of Conditional Expression (30) is preferably set to 0.3 or 0.4 instead of 0.2. The upper limit of Conditional Expression (30) is preferably set to 0.9 or 0.8 instead of 1.

While the imaging lens of the example in FIG. 1 comprises two focus lens groups, the imaging lens of the present disclosure may be configured to comprise only one focus lens group. In a case where the number of lens groups that move during focusing is only one, the mechanism can be simplified.

In the configuration in which the imaging lens comprises only one focus lens group, the imaging lens preferably satisfies Conditional Expression (31). A focal length of the focus lens group is denoted by ff. Ensuring that a corresponding value of Conditional Expression (31) is not less than or equal to its lower limit prevents an excessively weak refractive power of the focus lens group and thus, can reduce a moving amount of the focus lens group during focusing. Ensuring that the corresponding value of Conditional Expression (31) is not greater than or equal to its upper limit facilitates suppression of fluctuation in the aberrations during focusing.

$$0.1 < f / ff < 2 \qquad ( 31 )$$

In order to obtain more favorable characteristics, the lower limit of Conditional Expression (31) is preferably set to 0.15 or 0.2 instead of 0.1. The upper limit of Conditional Expression (31) is preferably set to 1.7 or 1.4 instead of 2.

In the configuration in which the imaging lens comprises only one focus lens group, the imaging lens preferably satisfies Conditional Expression (32). Ensuring that a corresponding value of Conditional Expression (32) is not less than or equal to its lower limit prevents an excessively weak refractive power of the focus lens group and thus, can reduce the moving amount of the focus lens group during focusing. Ensuring that the corresponding value of Conditional Expression (32) is not greater than or equal to its upper limit facilitates suppression of fluctuation in the aberrations during focusing.

$$0.5 < TL / ff < 3.5 \qquad ( 32 )$$

In order to obtain more favorable characteristics, the lower limit of Conditional Expression (32) is preferably set to 0.6 or 0.65 instead of 0.5. The upper limit of Conditional Expression (32) is preferably set to 2.2 or 1.6 instead of 3.5.

In a case where the imaging lens comprises only one focus lens group, the focus lens group preferably includes a cemented lens in which a positive lens and a negative lens are cemented in order from the object side. Doing so facilitates favorable correction of the chromatic aberration.

In the configuration in which the imaging lens comprises only one focus lens group, and the focus lens group includes the cemented lens in which the positive lens and the negative lens are cemented in order from the object side, the imaging lens preferably satisfies Conditional Expression (33). The following symbols of the conditional expression are defined for the cemented lens of the focus lens group. An Abbe number based on a d line for the positive lens of the cemented lens is denoted by vfp. An Abbe number based on a d line for the negative lens of the cemented lens is denoted by vfn. Satisfying Conditional Expression (33) facilitates favorable correction of the chromatic aberration.

$$- 15 < ν fp - ν fn < 25 \qquad ( 33 )$$

In order to obtain more favorable characteristics, the lower limit of Conditional Expression (33) is preferably set to −12 or −9 instead of −15. The upper limit of Conditional Expression (33) is preferably set to 20 or 17 instead of 25.

In the configuration in which the imaging lens comprises only one focus lens group, and the focus lens group includes the cemented lens in which the positive lens and the negative lens are cemented in order from the object side, the imaging lens preferably satisfies Conditional Expression (34). The following symbols of the conditional expression are defined for the cemented lens of the focus lens group. A refractive index with respect to a d line for the positive lens of the cemented lens is denoted by Nfp. A refractive index with respect to a d line for the negative lens of the cemented lens is denoted by Nfn. Satisfying Conditional Expression (34) facilitates favorable correction of the chromatic aberration.

$$0 < Nfp - Nfn < 0.45 \qquad ( 34 )$$

In order to obtain more favorable characteristics, the lower limit of Conditional Expression (34) is preferably set to 0.05 or 0.1 instead of 0. The upper limit of Conditional Expression (34) is preferably set to 0.35 or 0.27 instead of 0.45.

In the configuration in which the imaging lens comprises only one focus lens group, the imaging lens preferably satisfies Conditional Expression (35). An effective radius of a surface of the focus lens group closest to the image side is denoted by Eff. Ensuring that a corresponding value of Conditional Expression (35) is not less than or equal to its lower limit achieves an advantage in securing a sufficient edge part light quantity. Ensuring that the corresponding value of Conditional Expression (35) is not greater than or equal to its upper limit can suppress an increase in diameters of the lenses of the focus lens group and thus, can achieve size reduction and weight reduction. This can contribute to improvement of the degree of freedom in disposing the mechanism for holding the lens.

$$0.3 < Eff / ( f \times tan ω m ) < 0.7 \qquad ( 35 )$$

In order to obtain more favorable characteristics, the lower limit of Conditional Expression (35) is preferably set to 0.35 or 0.38 instead of 0.3. The upper limit of Conditional Expression (35) is preferably set to 0.65 or 0.62 instead of 0.7.

In a case where the imaging lens comprises only one focus lens group, the image-side lens group Gi that has a refractive power and that is fixed with respect to the image plane Sim during focusing may be disposed adjacent to the focus lens group on the image side. Doing so facilitates favorable correction of various aberrations. In this case, the imaging lens preferably satisfies Conditional Expression (26). An effect of Conditional Expression (26) and the preferable lower limit value and the preferable upper limit value of the conditional expression for obtaining more favorable characteristics are described above.

In a case where the imaging lens comprises only one focus lens group, and the image-side lens group Gi is disposed adjacent to the focus lens group on the image side, the lens closest to the image side in the image-side lens group Gi may be configured to be a negative lens having a concave surface facing the object side. Doing so facilitates favorable correction of the distortion. In this case, the imaging lens preferably satisfies Conditional Expression (27). An effect of Conditional Expression (27) and the preferable lower limit value and the preferable upper limit value of the conditional expression for obtaining more favorable characteristics are described above.

In a case where the imaging lens comprises only one focus lens group, the focus lens group may include at least one aspherical lens, and an aspherical lens closest to the object side among aspherical lenses included in the focus lens group may be configured to have a concave surface facing the object side. In the configuration in which the imaging lens comprises only one focus lens group, the focus lens group includes at least one aspherical lens, and the aspherical lens closest to the object side among the aspherical lenses included in the focus lens group has the concave surface facing the object side, the imaging lens preferably satisfies Conditional Expression (36). The following symbols of the conditional expression are defined for the aspherical lens closest to the object side among the aspherical lenses included in the focus lens group. A paraxial curvature radius of a surface of the aspherical lens on the object side is denoted by Rcffof. A paraxial curvature radius of a surface of the aspherical lens on the image side is denoted by Rcffor. A curvature radius of the surface of the aspherical lens on the object side at the position of the maximum effective diameter is denoted by Ryffof. A curvature radius of the surface of the aspherical lens on the image side at the position of the maximum effective diameter is denoted by Ryffor. Ensuring that a corresponding value of Conditional Expression (36) is not less than or equal to its lower limit prevents an excessively strong refractive power on the edge part side of the lens and thus, achieves an advantage in correcting fluctuation in the astigmatism during focusing. Ensuring that the corresponding value of Conditional Expression (36) is not greater than or equal to its upper limit prevents an excessively weak refractive power on the edge part side of the lens and thus, achieves an advantage in suppressing the astigmatism caused by the off-axis ray on the edge part side of the lens.

$$0.1 < ( 1 / Rcffof - 1 / Rcffor ) / ( 1 / Ryffof - 1 / Ryffor ) < 1.6 \qquad ( 36 )$$

In order to obtain more favorable characteristics, the lower limit of Conditional Expression (36) is preferably set to 0.3 or 0.4 instead of 0.1. The upper limit of Conditional Expression (36) is preferably set to 1.4 or 1.2 instead of 1.6.

In a case where the imaging lens comprises only one focus lens group, the focus lens group may include at least one aspherical lens, and an aspherical lens closest to the image side among aspherical lenses included in the focus lens group may be configured to have a concave surface facing the object side. In the configuration in which the imaging lens comprises only one focus lens group, the focus lens group includes at least one aspherical lens, and the aspherical lens closest to the image side among the aspherical lenses included in the focus lens group has the concave surface facing the object side, the imaging lens preferably satisfies Conditional Expression (37). The following symbols of the conditional expression are defined for the aspherical lens closest to the image side among the aspherical lenses included in the focus lens group. A paraxial curvature radius of a surface of the aspherical lens on the object side is denoted by Rcffif. A paraxial curvature radius of a surface of the aspherical lens on the image side is denoted by Rcffir. A curvature radius of the surface of the aspherical lens on the object side at the position of the maximum effective diameter is denoted by Ryffif. A curvature radius of the surface of the aspherical lens on the image side at the position of the maximum effective diameter is denoted by Ryffir. Ensuring that a corresponding value of Conditional Expression (37) is not less than or equal to its lower limit prevents an excessively large difference between the refractive power on the edge part side and the refractive power at the center of the lens and thus, can suppress overcorrection of the field curvature. Ensuring that the corresponding value of Conditional Expression (37) is not greater than or equal to its upper limit prevents an excessively small difference between the refractive power on the edge part side and the refractive power at the center of the lens and thus, achieves an advantage in correcting the field curvature.

$$- 0.7 < ( 1 / Rcffif - 1 / Rcffir ) / ( 1 / Ryffif - 1 / Ryffir ) < 1.2 \qquad ( 37 )$$

In order to obtain more favorable characteristics, the lower limit of Conditional Expression (37) is preferably set to −0.6 or −0.5 instead of −0.7. The upper limit of Conditional Expression (37) is preferably set to 1 or 0.8 instead of 1.2.

The imaging lens of the present disclosure may be configured to include at least one aspherical lens. In this case, at least one material of aspherical lenses included in the imaging lens of the present disclosure may be formed of plastic. Doing so achieves an advantage in weight reduction of the optical system.

The imaging lens of the present disclosure may be configured to include at least one aspherical lens. In this case, at least one of aspherical lenses included in the imaging lens of the present disclosure may be a compound aspherical lens obtained by forming a resin of which a surface in contact with air has an aspherical shape, on a spherical surface of a glass lens. Doing so enables the aspherical surface to be attached to the lens surface while reducing a manufacturing cost and thus, can achieve both of a low cost and favorable correction of various aberrations.

The above preferable configurations and available configurations can be combined with each other in any manner and are preferably selectively adopted, as appropriate, in accordance with required specifications.

For example, according to a preferable aspect of the present disclosure, the imaging lens comprises the first lens group G1 that is disposed closest to the object side and that is fixed with respect to the image plane Sim during focusing, and two or fewer focus lens groups that move along the optical axis Z during focusing, in which one of the two or fewer focus lens groups is disposed adjacent to the first lens group G1 on the image side, and Conditional Expressions (1) and (2) are satisfied.

Next, examples of the imaging lens of the present disclosure will be described with reference to the drawings. Reference numerals provided to the lenses in the cross-sectional view of each example are independently used for each example in order to avoid complication of description and the drawings caused by an increasing number of digits of the reference numerals. Accordingly, a common reference numeral provided in the drawings of different examples does not necessarily indicate a common configuration.

### Example 1

A cross-sectional view of a configuration of the imaging lens of Example 1 is illustrated in FIG. 1, and its illustration method and configuration are the same as described above. Thus, duplicate descriptions will be partially omitted. The imaging lens of Example 1 consists of, in order from the object side to the image side, the first lens group G1 having a negative refractive power, the first focus lens group Gf1 having a positive refractive power, the second focus lens group Gf2 having a positive refractive power, and the image-side lens group Gi having a negative refractive power. During focusing from the infinite distance object to the nearest object, the first lens group G1 and the image-side lens group Gi are fixed with respect to the image plane Sim, and the first focus lens group Gf1 and the second focus lens group Gf2 move to the object side by different moving amounts.

The first lens group G1 consists of, in order from the object side to the image side, three lenses including the lenses L1 to L3 and the aperture stop St. The first focus lens group Gf1 consists of, in order from the object side to the image side, four lenses including the lenses L4 to L7. The second focus lens group Gf2 consists of, in order from the object side to the image side, two lenses including the lenses L8 and L9. The image-side lens group Gi consists of one lens that is the lens L10. The lens L7 is a compound aspherical lens. Materials of the lens L6 and the lens L8 are plastic.

For the imaging lens of Example 1, Table 1 shows basic lens data, Table 2 shows specifications, Table 3 shows a variable surface spacing, and Table 4 shows aspherical coefficients.

The table of the basic lens data is described as follows. A column of Sn shows surface numbers in a case where the number is increased by one at a time toward the image side from a first surface that is a surface closest to the object side. A column of R shows a curvature radius of each surface. A column of D shows a surface spacing on the optical axis between each surface and a surface adjacent thereto on the image side. A column of Nd shows a refractive index with respect to a d line for each constituent. A column of vd shows an Abbe number based on the d line for each constituent. A column of θgF shows a partial dispersion ratio between a g line and an F line for each constituent. A column of ER shows an effective radius of each lens surface. A column of ρ shows a relative density of each constituent. In the columns of ER and ρ, fields not related to the conditional expressions are partially omitted. A leftmost column shows a reference numeral of a corresponding lens group, and a sign of a refractive power of the lens group is shown in parentheses. For example, “G1(−)” in the column on the left of the first surface to the seventh surface in Table 1 indicates that the first surface to the seventh surface correspond to the first lens group Gi, and a sign of the refractive power of the first lens group Gi is negative. In addition, “G1(+)” in the column on the left of the eighth surface to the fifteenth surface in Table 1 indicates that the eighth surface to the fifteenth surface correspond to the first focus lens group Gf1, and a sign of the refractive power of the first focus lens group G1f is positive.

In the table of the basic lens data, a sign of the curvature radius of the surface having a convex shape facing the object side is positive, and a sign of the curvature radius of the surface having a convex shape facing the image side is negative. A field of the surface number of the surface corresponding to the aperture stop St shows the surface number and a text (St). A value in a lowermost field of the column of D in the table indicates a spacing between a surface closest to the image side in the table and the image plane Sim.

Table 2 shows the focal length f, the back focus Bf, the open F-number FNo, and a maximum full angle of view 2ωm based on a d line. In a field of the maximum full angle of view, [° ] indicates a degree unit. Tables 1 and 2 show values in the state where the infinite distance object is in focus.

Table 3 shows the variable surface spacing during focusing. A column of Sn in Table 3 shows the surface number of the variable surface spacing on the object side during focusing. A column of “Infinite Distance” shows the surface spacing in the state where the infinite distance object is in focus. Afield on the right of a field of “Infinite Distance” shows an absolute value of the imaging magnification in the state where the nearest object is in focus, that is, an absolute value of the maximum imaging magnification, and a column of the field shows the variable surface spacing in the state where the nearest object is in focus.

In the basic lens data, a surface number of an aspherical surface is marked with *, and a field of a curvature radius of the aspherical surface shows a numerical value of a paraxial curvature radius. In Table 4, a row of Sn shows the surface number of the aspherical surface, and rows of KA and Am show numerical values of the aspherical coefficients for each aspherical surface.

Here, m of Am is an integer greater than or equal to 3 and varies depending on the surface. For example, m=4, 6, 8, 10, 12, 14, 16, and 18 is established for the eleventh surface of Example 1. In the numerical values of the aspherical coefficients in Table 4, “E±n” (n: integer) means “×10^{±n}”. KA and Am are aspherical coefficients in an aspheric equation represented by the following expression.

$$Zd = C \times {h}^{2} / \{ 1 + {( 1 - KA \times {C}^{2} \times {h}^{2} )}^{1 / 2} \} + \sum Am \times {h}^{m}$$

where
Zd: a depth of the aspherical surface (a length of a perpendicular line drawn from a point on the aspherical surface at a height h to a plane that is in contact with an aspherical surface apex and that is perpendicular to the optical axis Z)
h: a height (a distance from the optical axis Z to the lens surface)
C: a reciprocal of the paraxial curvature radius
KA and Am: aspherical coefficients
Σ in the aspheric equation means a sum total related to m.

In the data of each table, a degree unit is used for angles, and a millimeter (mm) unit is used for lengths. However, since the optical system can also be proportionally enlarged or proportionally reduced to be used, other appropriate units can also be used. Each table below shows numerical values rounded to predetermined digits.

TABLE 1
Example 1

| | Sn | R | D | Nd | νd | θgF | ER | ρ |
|---|---|---|---|---|---|---|---|---|
| G1 | 1 | 47.4567 | 0.7001 | 1.48749 | 70.32 | 0.52917 | | 2.45 |
| (−) | 2 | 11.4537 | 4.9181 | | | | | |
| | 3 | 41.6850 | 0.7248 | 1.80400 | 46.60 | 0.55755 | | 4.57 |
| | 4 | 15.7012 | 5.2464 | | | | | |
| | 5 | 13.2939 | 3.9529 | 1.48749 | 70.32 | 0.52917 | | 2.45 |
| | 6 | −104.6202 | 2.5871 | | | | | |
| | 7 (St) | ∞ | 4.4237 | | | | | |
| Gf1 | 8 | 21.8640 | 2.6694 | 1.88300 | 39.22 | 0.57288 | | |
| (+) | 9 | −36.5510 | 0.6352 | 1.54814 | 45.51 | 0.56846 | | |
| | 10 | 19.3649 | 3.9628 | | | | | |
| | *11 | −12.2028 | 0.6748 | 1.66121 | 20.35 | 0.66162 | 6.74 | |
| | *12 | −29.3272 | 0.0500 | | | | 8.07 | |
| | 13 | 47.1353 | 6.3244 | 1.75500 | 52.34 | 0.54761 | | |
| | 14 | −17.5936 | 0.1400 | 1.56093 | 36.64 | 0.58853 | | |
| | *15 | −20.5737 | 4.4794 | | | | 10.78 | |
| Gf2 | *16 | −13.6258 | 2.4793 | 1.66121 | 20.35 | 0.66162 | 10.88 | |
| (+) | *17 | −17.6170 | 0.3113 | | | | 12.27 | |
| | 18 | 120.5799 | 4.2418 | 1.77535 | 50.30 | 0.55004 | | |
| | 19 | −46.7910 | 3.0701 | | | | 14.02 | |
| Gi | 20 | −43.5109 | 0.8751 | 2.00069 | 25.46 | 0.61402 | | |
| (−) | 21 | −119.1238 | 11.0966 | | | | | |

TABLE 2
Example 1

| | |
|---|---|
| f | 16.56 |
| Bf | 11.10 |
| FNo | 2.88 |
| 2ωm [°] | 116.2 |

TABLE 3
Example 1

Variable Surface Spacing

| Sn | Infinite Distance | 0.2x |
|---|---|---|
| 7 | 4.4237 | 2.4690 |
| 15 | 4.4794 | 2.8455 |
| 19 | 3.0701 | 6.6587 |

TABLE 4
Example 1

| Sn | 11 | 12 |
|---|---|---|
| KA | 1.0000000E+00 | 1.0000000E+00 |
| A4 | −1.1179627E−04 | 2.8291740E−05 |
| A6 | −3.3473180E−07 | −2.5854734E−08 |
| A8 | −5.4335084E−08 | −4.8806140E−09 |
| A10 | 5.4307099E−10 | −1.3306995E−10 |
| A12 | −8.2487201E−13 | −2.1711908E−13 |
| A14 | −1.0502992E−13 | 1.8357287E−14 |
| A16 | −7.7864929E−15 | 1.4279215E−16 |
| A18 | 1.3236065E−16 | −2.3647502E−18 |

| Sn | 15 | 16 | 17 |
|---|---|---|---|
| KA | 1.0000000E+00 | 1.0000000E+00 | 1.0000000E+00 |
| A4 | −7.3764673E−05 | 1.2632314E−04 | 1.5928581E−04 |
| A6 | −1.7912014E−07 | 1.0324293E−06 | 9.8375400E−07 |
| A8 | 7.8463318E−09 | −3.2162245E−09 | −3.0752303E−09 |
| A10 | −2.5554791E−11 | −7.4258198E−11 | −5.5339640E−11 |
| A12 | −3.3494381E−13 | 1.9067587E−13 | 2.3705414E−13 |
| A14 | 3.4297554E−15 | 1.7828814E−15 | 7.0950462E−16 |
| A16 | −9.0166570E−18 | −4.2941730E−18 | −3.6915008E−18 |

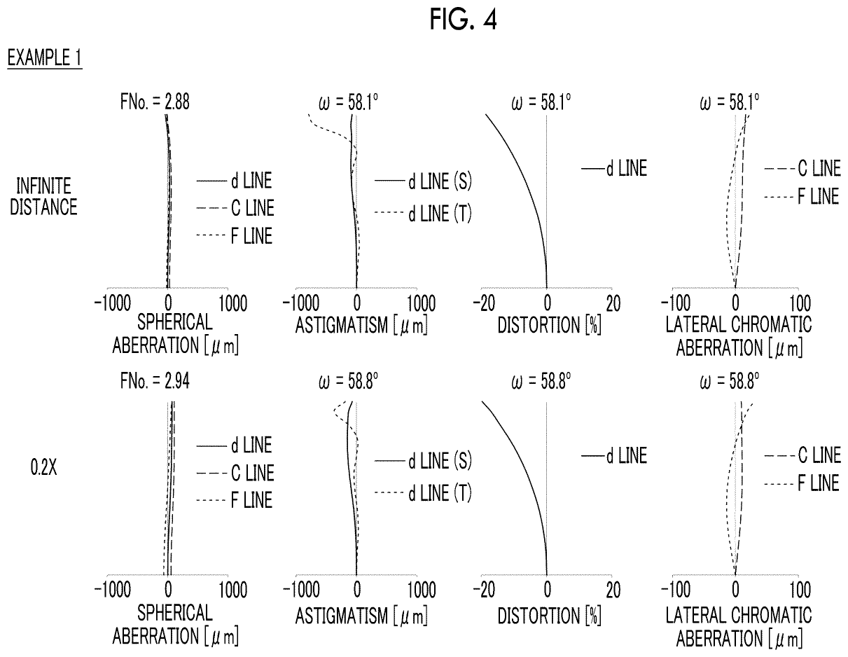

FIG. 4 illustrates each aberration diagram of the imaging lens of Example 1. FIG. 4 illustrates, in order from the left, a spherical aberration, an astigmatism, a distortion, and a lateral chromatic aberration. In FIG. 4, each aberration diagram in the state where the infinite distance object is in focus is illustrated in an upper part labeled “INFINITE DISTANCE”, and each aberration diagram in the state where the nearest object is in focus is illustrated in a lower part labeled “0.2×”. In the spherical aberration diagram, the aberration on a d line, a C line, and an F line is illustrated by a solid line, a long broken line, and a short broken line, respectively. In the astigmatism diagram, the aberration on a d line in a sagittal direction is illustrated by a solid line, and the aberration on a d line in a tangential direction is illustrated by a short broken line. In the distortion diagram, the aberration on a d line is illustrated by a solid line.

In the lateral chromatic aberration diagram, the aberration on a C line and an F line are illustrated by a long broken line and a short broken line, respectively. In the spherical aberration diagram, a value of the open F-number is shown after “FNo.=”. In other aberration diagrams, a value of the maximum half angle of view is shown after “ω=”. FNo. and ω of the aberration diagrams in the upper part correspond to FNo and ωm, respectively, in the conditional expressions.

Symbols, meanings, description methods, and illustration methods of each data related to Example 1 are basically the same for the following examples unless otherwise specified. Thus, duplicate descriptions will be omitted below.

### Example 2

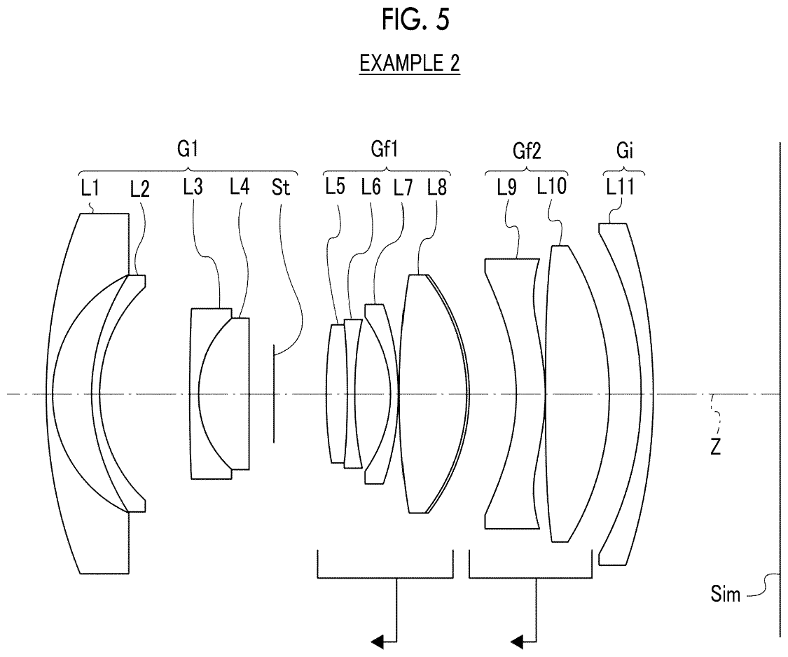

A cross-sectional view of a configuration of an imaging lens of Example 2 is illustrated in FIG. 5. The imaging lens of Example 2 consists of, in order from the object side to the image side, the first lens group G1 having a negative refractive power, the first focus lens group Gf1 having a positive refractive power, the second focus lens group Gf2 having a positive refractive power, and the image-side lens group Gi having a negative refractive power. During focusing from the infinite distance object to the nearest object, the first lens group G1 and the image-side lens group Gi are fixed with respect to the image plane Sim, and the first focus lens group Gf1 and the second focus lens group Gf2 move to the object side by different moving amounts.

The first lens group G1 consists of, in order from the object side to the image side, four lenses including the lenses L1 to L4 and the aperture stop St. The first focus lens group Gf1 consists of, in order from the object side to the image side, four lenses including the lenses L5 to L8. The second focus lens group Gf2 consists of, in order from the object side to the image side, two lenses including the lenses L9 and L10. The image-side lens group Gi consists of one lens that is a lens L11. The lens L8 is a compound aspherical lens. Materials of the lens L7 and the lens L9 are plastic.

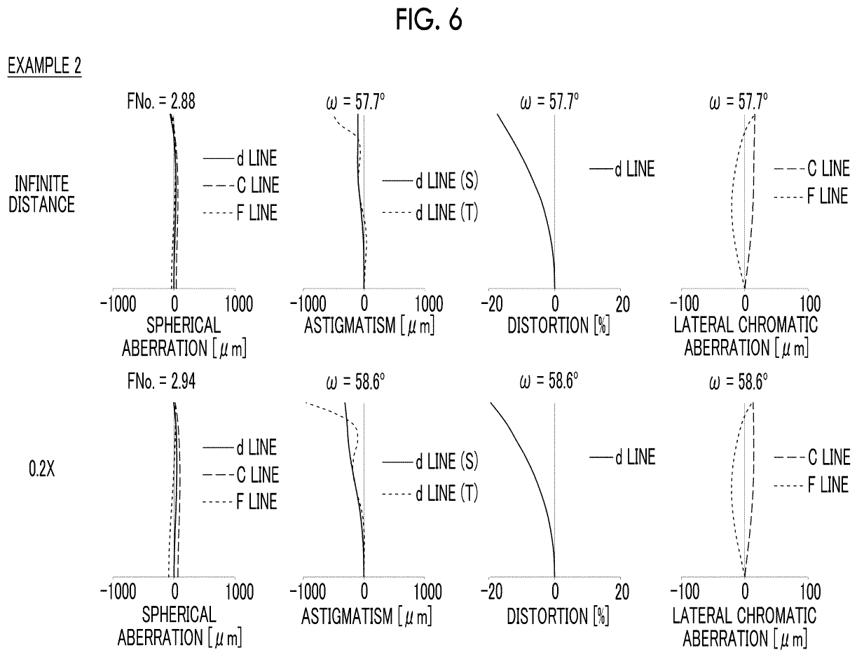

For the imaging lens of Example 2, Table 5 shows basic lens data, Table 6 shows specifications, Table 7 shows a variable surface spacing, Table 8 shows aspherical coefficients, and FIG. 6 illustrates each aberration diagram.

TABLE 5
Example 2

| | Sn | R | D | Nd | νd | θgF | ER | ρ |
|---|---|---|---|---|---|---|---|---|
| G1 | 1 | 43.3937 | 0.7000 | 1.48749 | 70.32 | 0.52917 | | 2.45 |
| (−) | 2 | 11.8208 | 3.2897 | | | | | |
| | 3 | 18.7485 | 0.7248 | 1.80400 | 46.60 | 0.55755 | | 4.57 |
| | 4 | 13.5338 | 7.8414 | | | | | |
| | 5 | 109.8836 | 0.7100 | 1.67270 | 32.10 | 0.59891 | | 2.91 |
| | 6 | 9.3268 | 4.4943 | 1.88300 | 39.22 | 0.57288 | | 5.17 |
| | 7 | −473.3855 | 2.0427 | | | | | |
| | 8 (St) | ∞ | 4.4056 | | | | | |
| Gf1 | 9 | 31.4653 | 1.9247 | 1.88300 | 39.22 | 0.57288 | | |
| (+) | 10 | −89.7156 | 0.6352 | 1.58267 | 46.48 | 0.56631 | | |
| | 11 | 33.1507 | 3.0434 | | | | | |
| | *12 | −15.0995 | 0.6752 | 1.66121 | 20.35 | 0.66162 | 6.79 | |
| | *13 | −29.2027 | 0.0500 | | | | 7.95 | |
| | 14 | 57.8111 | 5.9780 | 1.77535 | 50.30 | 0.55004 | | |
| | 15 | −17.6474 | 0.1400 | 1.56093 | 36.64 | 0.58853 | | |
| | *16 | −21.6098 | 4.0878 | | | | 10.70 | |
| Gf2 | *17 | −15.6590 | 2.4573 | 1.66121 | 20.35 | 0.66162 | 10.95 | |
| (+) | *18 | −19.3980 | 0.0500 | | | | 11.97 | |
| | 19 | 190.9276 | 5.5002 | 1.48749 | 70.32 | 0.52917 | | |
| | 20 | −25.6807 | 2.8662 | | | | 13.15 | |
| Gi | 21 | −29.4115 | 0.8748 | 2.00069 | 25.46 | 0.61402 | | |
| (−) | 22 | −53.2837 | 11.1025 | | | | | |

TABLE 6
Example 2

| | |
|---|---|
| f | 16.56 |
| Bf | 11.10 |
| FNo | 2.88 |
| 2ωm [°] | 115.4 |

TABLE 7
Example 2

Variable Surface Spacing

| Sn | Infinite Distance | 0.2x |
|---|---|---|
| 8 | 4.4056 | 2.4690 |
| 16 | 4.0878 | 2.6419 |
| 20 | 2.8662 | 6.2486 |

TABLE 8
Example 2

| Sn | 12 | 13 |
|---|---|---|
| KA | 1.0000000E+00 | 1.0000000E+00 |
| A4 | −1.2494410E−04 | 8.1231338E−06 |
| A6 | −2.2997095E−07 | −4.5374803E−08 |
| A8 | −5.8398796E−08 | −5.0592038E−09 |
| A10 | 7.0678675E−10 | −1.2260140E−10 |
| A12 | 2.8467772E−12 | −4.8281881E−13 |
| A14 | −1.5726454E−13 | 1.9805037E−14 |
| A16 | −8.2719538E−15 | −2.7611087E−16 |
| A18 | 1.2176917E−16 | 2.0526036E−18 |

| Sn | 16 | 17 | 18 |
|---|---|---|---|
| KA | 1.0000000E+00 | 1.0000000E+00 | 1.0000000E+00 |
| A4 | −8.8708313E−05 | 9.6643540E−05 | 1.4776546E−04 |
| A6 | −1.9938126E−07 | 1.0318990E−06 | 9.9214132E−07 |
| A8 | 7.6640273E−09 | −3.2304115E−09 | −2.8557213E−09 |
| A10 | −2.1739390E−11 | −6.9776312E−11 | −5.6785647E−11 |
| A12 | −3.1419870E−13 | 1.7870892E−13 | 2.4236832E−13 |
| A14 | 3.4068814E−15 | 1.8110717E−15 | 6.5737584E−16 |
| A16 | −9.8752468E−18 | −5.2476611E−18 | −3.4906314E−18 |

### Example 3

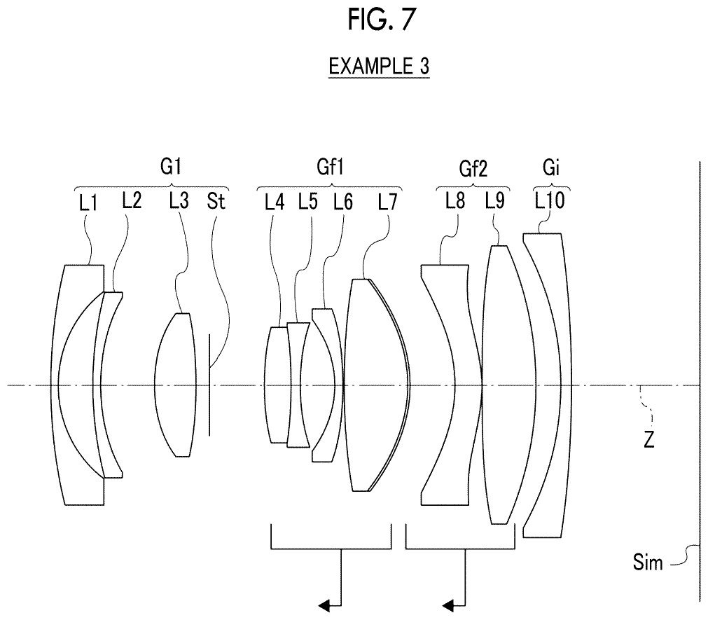

A cross-sectional view of a configuration of an imaging lens of Example 3 is illustrated in FIG. 7. The imaging lens of Example 3 consists of, in order from the object side to the image side, the first lens group G1 having a positive refractive power, the first focus lens group Gf1 having a positive refractive power, the second focus lens group Gf2 having a positive refractive power, and the image-side lens group Gi having a negative refractive power. During focusing from the infinite distance object to the nearest object, the first lens group G1 and the image-side lens group Gi are fixed with respect to the image plane Sim, and the first focus lens group Gf1 and the second focus lens group Gf2 move to the object side by different moving amounts.

The first lens group G1 consists of, in order from the object side to the image side, three lenses including the lenses L1 to L3 and the aperture stop St. The first focus lens group Gf1 consists of, in order from the object side to the image side, four lenses including the lenses L4 to L7. The second focus lens group Gf2 consists of, in order from the object side to the image side, two lenses including the lenses L8 and L9. The image-side lens group Gi consists of one lens that is the lens L10. The lens L7 is a compound aspherical lens. The materials of the lens L6 and the lens L8 are plastic.

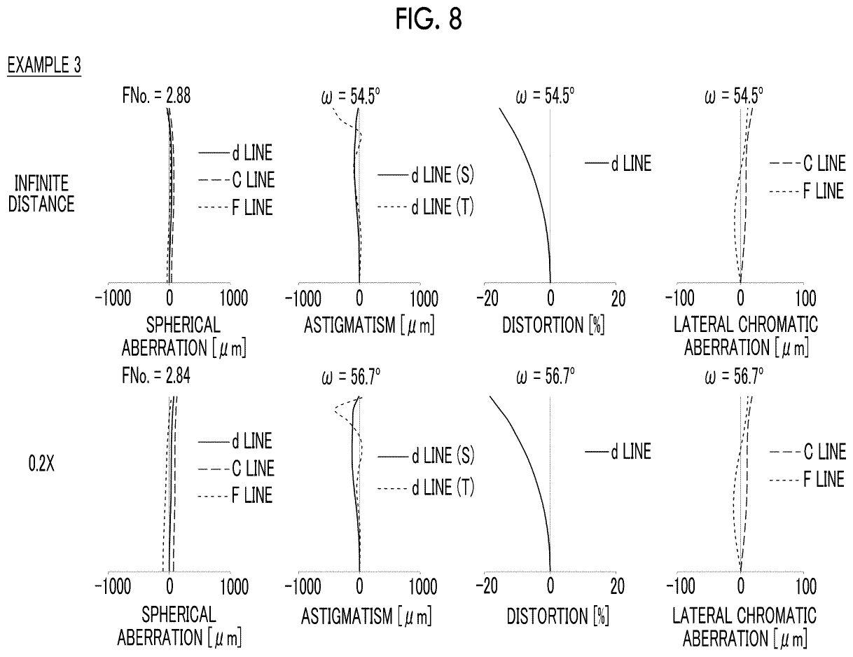

For the imaging lens of Example 3, Table 9 shows basic lens data, Table 10 shows specifications, Table 11 shows a variable surface spacing, Table 12 shows aspherical coefficients, and FIG. 8 illustrates each aberration diagram.

TABLE 9
Example 3

| | Sn | R | D | Nd | νd | θgF | ER | ρ |
|---|---|---|---|---|---|---|---|---|
| G1 | 1 | 52.2413 | 0.7002 | 1.77535 | 50.30 | 0.55004 | | 4.35 |
| (+) | 2 | 11.9101 | 3.3052 | | | | | |
| | 3 | 35.6232 | 0.7249 | 1.48749 | 70.32 | 0.52917 | | 2.45 |
| | 4 | 18.2624 | 5.0872 | | | | | |
| | 5 | 13.2836 | 3.8468 | 1.48749 | 70.32 | 0.52917 | | 2.45 |
| | 6 | −51.1745 | 1.4415 | | | | | |
| | 7 (St) | ∞ | 5.1275 | | | | | |
| Gf1 | 8 | 19.9255 | 2.7184 | 1.95375 | 32.33 | 0.59055 | | |
| (+) | 9 | −26.7595 | 0.6348 | 1.80100 | 34.97 | 0.58642 | | |
| | 10 | 18.7738 | 3.4601 | | | | | |
| | *11 | −10.7040 | 0.6748 | 1.66121 | 20.35 | 0.66162 | 6.19 | |
| | *12 | −22.6059 | 0.0500 | | | | 7.53 | |
| | 13 | 62.5977 | 6.1375 | 1.77535 | 50.30 | 0.55004 | | |
| | 14 | −15.8172 | 0.1400 | 1.56093 | 36.64 | 0.58853 | | |
| | *15 | −18.8302 | 4.2850 | | | | 10.37 | |
| Gf2 | *16 | −12.9020 | 2.4999 | 1.66121 | 20.35 | 0.66162 | 10.73 | |
| (+) | *17 | −16.1584 | 0.0500 | | | | 11.97 | |
| | 18 | 98.5402 | 4.8053 | 1.77535 | 50.30 | 0.55004 | | |
| | 19 | −38.1159 | 2.7000 | | | | 13.62 | |
| Gi | 20 | −29.4121 | 0.8748 | 2.00069 | 25.46 | 0.61402 | | |
| (−) | 21 | −118.0284 | 12.2985 | | | | | |

TABLE 10
Example 3

| | |
|---|---|
| f | 18.26 |
| Bf | 12.30 |
| FNo | 2.88 |
| 2ωm [°] | 109.0 |

TABLE 11
Example 3

Variable Surface Spacing

| Sn | Infinite Distance | 0.2x |
|---|---|---|
| 7 | 5.1275 | 3.8188 |
| 15 | 4.2850 | 2.5221 |
| 19 | 2.7000 | 5.7715 |

TABLE 12
Example 3

| Sn | 11 | 12 |
|---|---|---|
| KA | 1.0000000E+00 | 1.0000000E+00 |
| A4 | −2.5851698E−07 | 1.5633805E−04 |
| A6 | −7.9263348E−07 | −4.5398261E−07 |
| A8 | −1.0661166E−07 | −7.2584797E−09 |
| A10 | 1.5959953E−09 | −1.5514889E−10 |
| A12 | 1.4666236E−11 | −1.2159797E−12 |
| A14 | −1.3311988E−12 | 2.3688121E−14 |
| A16 | −5.8394291E−15 | 6.6732304E−16 |
| A18 | 3.7833791E−16 | −7.0750438E−18 |

| Sn | 15 | 16 | 17 |
|---|---|---|---|
| KA | 1.0000000E+00 | 1.0000000E+00 | 1.0000000E+00 |
| A4 | −7.4390296E−05 | 1.4732253E−04 | 1.5731537E−04 |
| A6 | −4.4161882E−07 | 1.1276125E−06 | 1.0445811E−06 |
| A8 | 7.2252043E−09 | −3.5813341E−09 | −2.9691495E−09 |
| A10 | −2.6134099E−12 | −6.9972315E−11 | −5.7985232E−11 |
| A12 | −3.7649029E−13 | 1.9398270E−13 | 2.4710516E−13 |
| A14 | 3.5666586E−15 | 1.9539520E−15 | 7.6919760E−16 |
| A16 | −1.0903009E−17 | −4.6542847E−18 | −3.9835723E−18 |

### Example 4

A cross-sectional view of a configuration of an imaging lens of Example 4 is illustrated in FIG. 9. The imaging lens of Example 4 consists of, in order from the object side to the image side, the first lens group G1 having a negative refractive power, the first focus lens group Gf1 having a positive refractive power, the middle lens group Gm having a positive refractive power, the second focus lens group Gf2 having a positive refractive power, and the image-side lens group Gi having a negative refractive power. During focusing from the infinite distance object to the nearest object, the first lens group Gi, the middle lens group Gm, and the image-side lens group Gi are fixed with respect to the image plane Sim, and the first focus lens group Gf1 and the second focus lens group Gf2 move to the object side by different moving amounts.

The first lens group G1 consists of, in order from the object side to the image side, three lenses including the lenses L1 to L3 and the aperture stop St. The first focus lens group Gf1 consists of, in order from the object side to the image side, two lenses including the lenses L4 and L5. The middle lens group Gm consists of, in order from the object side to the image side, three lenses including the lenses L6 to L8. The second focus lens group Gf2 consists of one lens that is the lens L9. The image-side lens group G1 consists of one lens that is the lens L10. Materials of the lens L2, the lens L6, the lens L8, and the lens L9 are plastic.

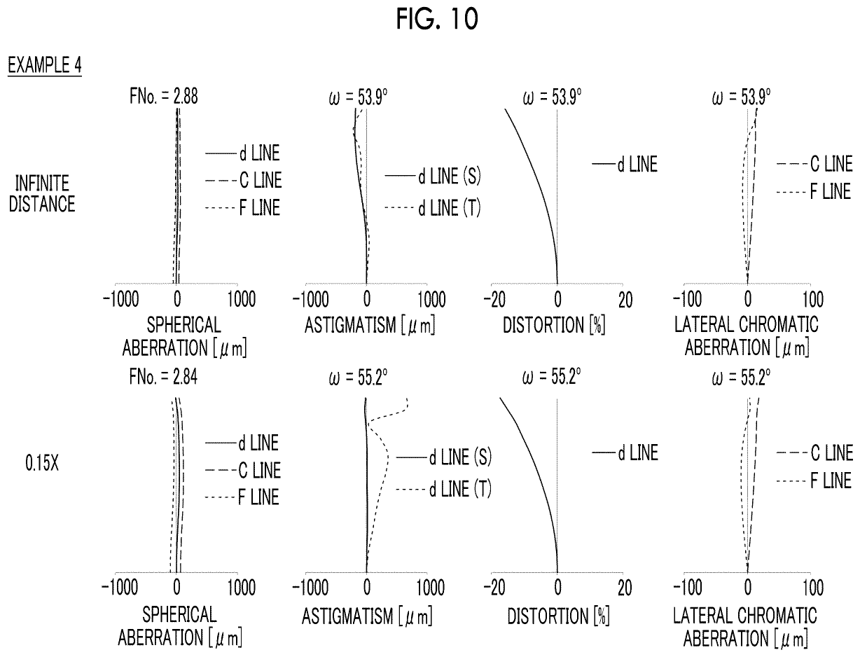

For the imaging lens of Example 4, Table 13 shows basic lens data, Table 14 shows specifications, Table 15 shows a variable surface spacing, Table 16 shows aspherical coefficients, and FIG. 10 illustrates each aberration diagram.

TABLE 13
Example 4

| | Sn | R | D | Nd | νd | θgF | ER | ρ |
|---|---|---|---|---|---|---|---|---|
| G1 | 1 | 39.0541 | 0.6998 | 1.58913 | 61.13 | 0.54067 | | 3.31 |
| (−) | 2 | 10.6431 | 5.5633 | | | | | |
| | *3 | 41.1384 | 0.8310 | 1.53409 | 55.87 | 0.55858 | 9.28 | 1.01 |
| | *4 | 15.6700 | 0.4465 | | | | 8.64 | |
| | 5 | 17.2056 | 3.5678 | 1.80440 | 39.59 | 0.57297 | | 4.34 |
| | 6 | 443.5438 | 3.7502 | | | | | |
| | 7 (St) | ∞ | 4.5208 | | | | | |
| Gf1 | 8 | 71.2216 | 2.4658 | 1.88300 | 39.22 | 0.57288 | | |
| (+) | 9 | −16.3536 | 0.6348 | 1.72151 | 29.23 | 0.60541 | | |
| | 10 | 291.9212 | 2.3061 | | | | 6.23 | |
| Gm | *11 | −11.4917 | 0.6748 | 1.66121 | 20.35 | 0.66162 | | |
| (+) | *12 | −23.7379 | 0.0573 | | | | | |
| | 13 | 388.7155 | 6.7972 | 1.77535 | 50.30 | 0.55004 | | |
| | 14 | −14.0219 | 0.7500 | | | | | |
| | *15 | −39.9966 | 1.9998 | 1.53409 | 55.87 | 0.55858 | | |
| | *16 | −53.2885 | 6.7319 | | | | | |
| Gf2 | *17 | 76.0146 | 3.5189 | 1.53409 | 55.87 | 0.55858 | | |
| (+) | *18 | −104.0099 | 2.7000 | | | | 14.33 | |
| Gi | 19 | −41.5356 | 0.8750 | 1.85025 | 30.05 | 0.59797 | | |
| (−) | 20 | −317.6766 | 11.0924 | | | | | |

TABLE 14
Example 4

| | |
|---|---|
| f | 18.76 |
| Bf | 11.09 |
| FNo | 2.88 |
| 2ωm [°] | 107.8 |

TABLE 15
Example 4

Variable Surface Spacing

| Sn | Infinite Distance | 0.15x |
|---|---|---|
| 7 | 4.5208 | 4.0050 |
| 10 | 2.3061 | 2.8220 |
| 16 | 6.7319 | 1.3238 |
| 18 | 2.7000 | 8.1081 |

TABLE 16
Example 4

| Sn | 3 | 4 |
|---|---|---|
| KA | 1.0000000E+00 | 1.0000000E+00 |
| A4 | −1.5949654E−05 | −4.4461293E−05 |
| A6 | 5.9645232E−07 | 2.4520211E−07 |
| A8 | −1.3909218E−08 | −1.3697024E−08 |
| A10 | 9.9308874E−11 | 2.0823999E−11 |
| A12 | −4.2017043E−13 | 4.8548573E−14 |

| Sn | 11 | 12 |
|---|---|---|
| KA | 1.0000000E+00 | 1.0000000E+00 |
| A4 | 1.0034557E−04 | 1.4642251E−04 |
| A6 | 4.7921431E−07 | −1.8088356E−07 |
| A8 | −9.5116681E−08 | −2.1991858E−09 |
| A10 | 2.0226282E−09 | −1.1434926E−10 |
| A12 | −1.1246484E−11 | −7.6109206E−13 |
| A14 | 2.3056604E−13 | 5.4714116E−14 |
| A16 | −2.3404355E−14 | −8.0336604E−16 |
| A18 | 3.1741308E−16 | 5.3110007E−18 |

| Sn | 15 | 16 | 17 | 18 |
|---|---|---|---|---|
| KA | 1.0000000E+00 | 1.0000000E+00 | 1.0000000E+00 | 1.0000000E+00 |
| A4 | −2.1121167E−05 | 6.3861779E−06 | −6.4943093E−05 | −5.0948623E−05 |
| A6 | 1.4481948E−06 | 1.4609112E−06 | 4.1628722E−07 | 1.6425357E−07 |
| A8 | −5.6566623E−09 | −6.1193166E−09 | −1.0723748E−09 | 6.3996080E−10 |
| A10 | −6.8847144E−11 | −4.9243535E−11 | −1.0303022E−12 | −3.6482814E−12 |
| A12 | 1.8549005E−13 | 2.2101110E−13 | 5.4507848E−15 | 3.1242150E−15 |
| A14 | 3.1532176E−15 | 1.0956343E−15 | −3.5070533E−18 | −2.7726234E−17 |
| A16 | −1.6361766E−17 | −5.6581568E−18 | −1.4397683E−19 | −4.3352019E−21 |

### Example 5

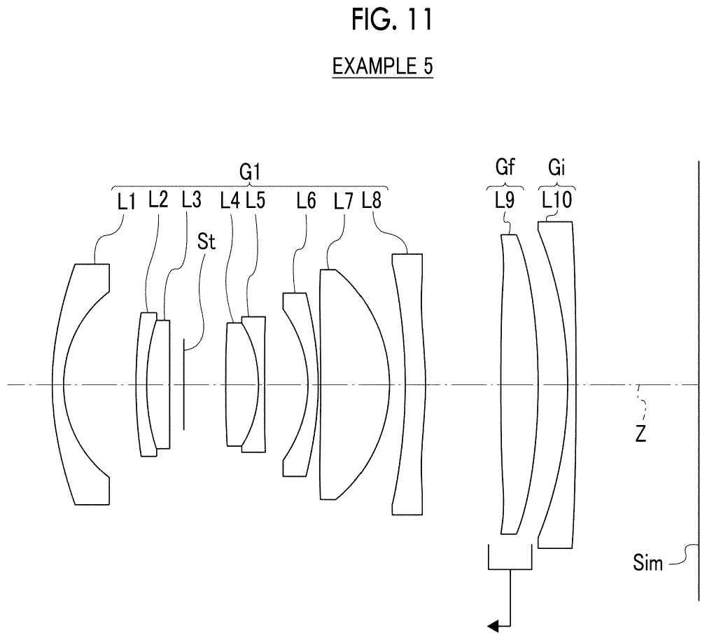

A cross-sectional view of a configuration of an imaging lens of Example 5 is illustrated in FIG. 11. The imaging lens of Example 5 comprises only one focus lens group. Hereinafter, the focus lens group in the imaging lens comprising only one focus lens group will be referred to as a single focus lens group Gf. The imaging lens of Example 5 consists of, in order from the object side to the image side, the first lens group G1 having a positive refractive power, the single focus lens group Gf having a positive refractive power, and the image-side lens group G1 having a negative refractive power. During focusing from the infinite distance object to the nearest object, the first lens group G1 and the image-side lens group G1 are fixed with respect to the image plane Sim, and the single focus lens group Gf moves to the object side.

The first lens group G1 consists of, in order from the object side to the image side, three lenses including the lenses L1 to L3, the aperture stop St, and five lenses including the lenses L4 to L8. The single focus lens group Gf consists of one lens that is the lens L9. The image-side lens group G1 consists of one lens that is the lens L10. The materials of the lens L6, the lens L8, and the lens L9 are plastic.

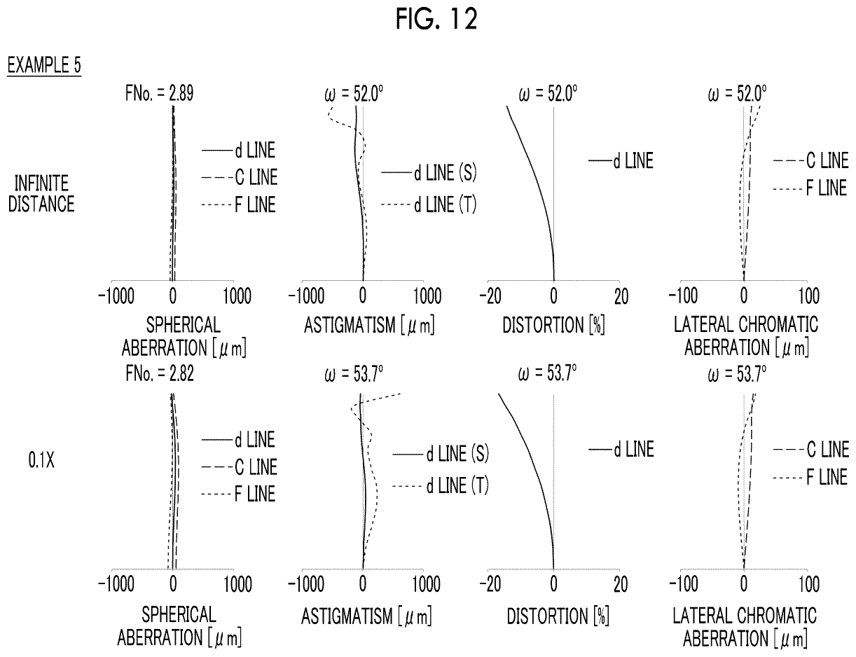

For the imaging lens of Example 5, Table 17 shows basic lens data, Table 18 shows specifications, Table 19 shows a variable surface spacing, Table 20 shows aspherical coefficients, and FIG. 12 illustrates each aberration diagram.

TABLE 17
Example 5

| | Sn | R | D | Nd | νd | θgF | ER | ρ |
|---|---|---|---|---|---|---|---|---|
| G1 | 1 | 32.6632 | 1.0000 | 1.58913 | 61.13 | 0.54067 | | 3.31 |
| (+) | 2 | 11.0170 | 6.4998 | | | | | |
| | 3 | 58.0991 | 0.9058 | 1.59562 | 38.44 | 0.57969 | | 2.52 |
| | 4 | 19.0861 | 2.0520 | 1.80704 | 30.42 | 0.59851 | | 4.00 |
| | 5 | 234.3534 | 1.3172 | | | | | |
| | 6 (St) | ∞ | 3.6042 | | | | | |
| | 7 | 73.9012 | 2.9611 | 1.88300 | 39.22 | 0.57288 | | 5.17 |
| | 8 | −11.6444 | 0.6349 | 1.72151 | 29.23 | 0.60541 | | 3.07 |
| | 9 | 231.4170 | 3.8399 | | | | | |
| | *10 | −11.7212 | 0.9148 | 1.66121 | 20.35 | 0.66162 | | 1.23 |
| | *11 | −23.3305 | 0.1522 | | | | | |
| | 12 | −730.9118 | 6.1509 | 1.77535 | 50.30 | 0.55004 | | 4.35 |
| | 13 | −14.1928 | 1.2709 | | | | | |
| | *14 | −42.5529 | 1.9984 | 1.53409 | 55.87 | 0.55858 | | 1.01 |
| | *15 | −47.8764 | 5.9317 | | | | | |
| Gf | *16 | 68.3015 | 3.7079 | 1.53409 | 55.87 | 0.55858 | | |
| (+) | *17 | −91.6534 | 3.0000 | | | | 14.17 | |
| Gi | 18 | −31.2396 | 0.8748 | 1.85025 | 30.05 | 0.59797 | | |
| (−) | 19 | −147.2883 | 10.7995 | | | | | |

TABLE 18
Example 5

| | |
|---|---|
| f | 19.76 |
| Bf | 10.80 |
| FNo | 2.89 |
| 2ωm [°] | 104.0 |

TABLE 19
Example 5

Variable Surface Spacing

| Sn | Infinite Distance | 0.1x |
|---|---|---|
| 15 | 5.9317 | 2.4690 |
| 17 | 3.0000 | 6.4627 |

TABLE 20
Example 5

| Sn | 10 | 11 |
|---|---|---|
| KA | 1.0000000E+00 | 1.0000000E+00 |
| A4 | 7.7576340E−05 | 1.3080559E−04 |
| A6 | 1.7342332E−07 | 2.4507112E−07 |
| A8 | −2.4848651E−08 | −9.0278958E−09 |
| A10 | −2.4797056E−10 | −1.9591584E−10 |
| A12 | −5.0746396E−12 | 1.4439991E−12 |
| A14 | 6.1774803E−13 | 5.8958753E−14 |
| A16 | −1.4916836E−14 | −8.3894791E−16 |
| A18 | 1.1584949E−16 | 3.2111931E−18 |

| Sn | 14 | 15 | 16 | 17 |
|---|---|---|---|---|
| KA | 1.0000000E+00 | 1.0000000E+00 | 1.0000000E+00 | 1.0000000E+00 |
| A4 | −2.3519776E−05 | −1.8459200E−05 | −7.4172662E−05 | −5.1705528E−05 |
| A6 | 1.6383515E−06 | 1.8133107E−06 | 7.5731845E−07 | 3.1947260E−07 |
| A8 | −6.9982179E−09 | −8.2896005E−09 | −4.1650235E−09 | −5.0040880E−10 |
| A10 | −5.5596198E−11 | −3.7956601E−11 | 6.2919202E−12 | −4.7188037E−12 |
| A12 | 7.1795502E−14 | 1.7447059E−13 | 2.3250112E−14 | 8.1899390E−15 |
| A14 | 3.7039565E−15 | 1.2959482E−15 | −1.0766902E−16 | 6.5017231E−17 |
| A16 | −1.5875283E−17 | −6.1396885E−18 | 2.3062726E−20 | −2.4620175E−19 |

### Example 6

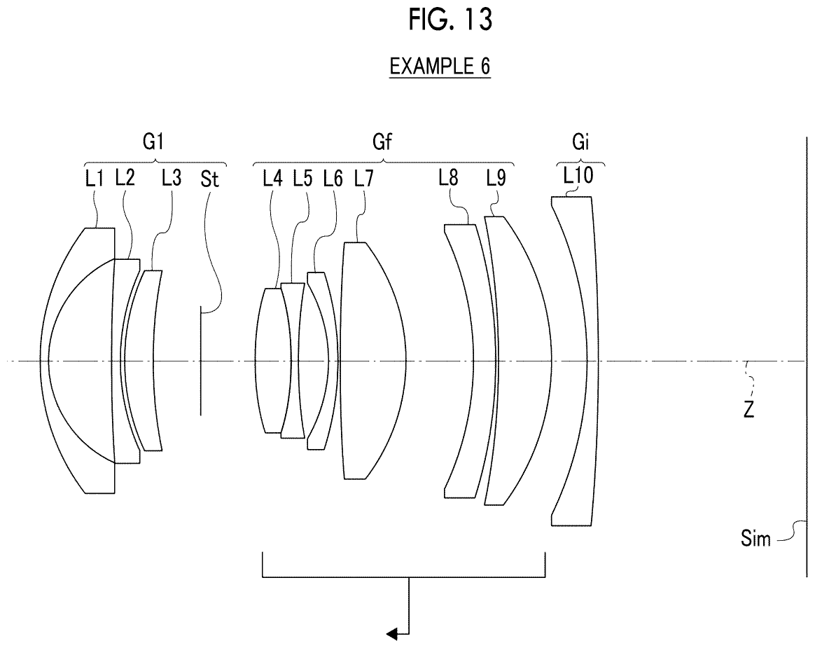

A cross-sectional view of a configuration of an imaging lens of Example 6 is illustrated in FIG. 13. The imaging lens of Example 6 consists of, in order from the object side to the image side, the first lens group G1 having a negative refractive power, the single focus lens group Gf having a positive refractive power, and the image-side lens group G1 having a negative refractive power. During focusing from the infinite distance object to the nearest object, the first lens group G1 and the image-side lens group G1 are fixed with respect to the image plane Sim, and the single focus lens group Gf moves to the object side.

The first lens group G1 consists of, in order from the object side to the image side, three lenses including the lenses L1 to L3 and the aperture stop St. The single focus lens group Gf consists of, in order from the object side to the image side, six lenses including the lenses L4 to L9. The image-side lens group G1 consists of one lens that is the lens L10. The materials of the lens L2, the lens L6, and the lens L8 are plastic.

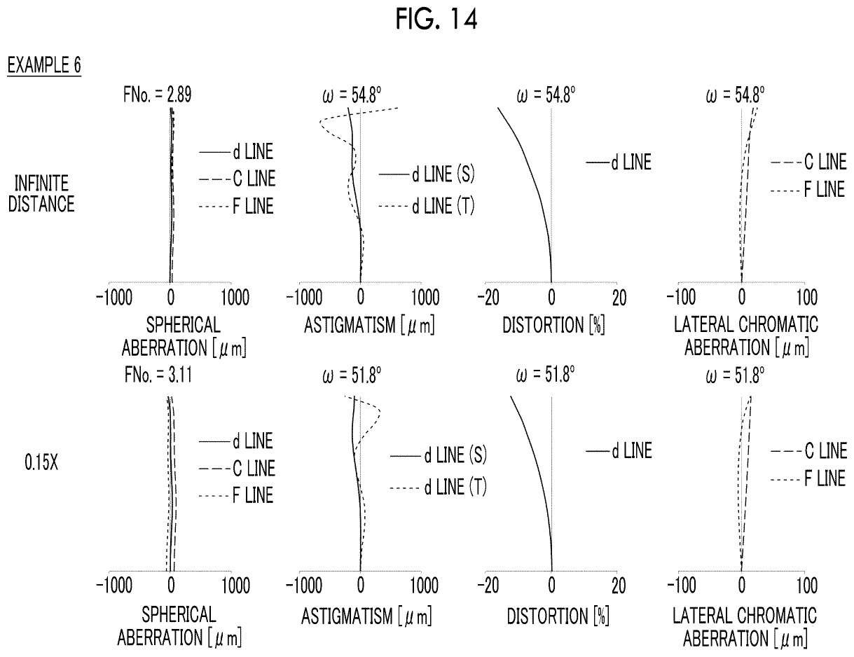

For the imaging lens of Example 6, Table 21 shows basic lens data, Table 22 shows specifications, Table 23 shows a variable surface spacing, Table 24 shows aspherical coefficients, and FIG. 14 illustrates each aberration diagram.

TABLE 21
Example 6

| | Sn | R | D | Nd | νd | θgF | ER | ρ |
|---|---|---|---|---|---|---|---|---|
| G1 | 1 | 17.6385 | 0.6998 | 1.75500 | 52.32 | 0.54758 | | 4.22 |
| (−) | 2 | 9.1223 | 4.8688 | | | | | |
| | *3 | 53.4624 | 0.7252 | 1.53409 | 55.87 | 0.55858 | 8.20 | 1.01 |
| | *4 | 14.4042 | 0.4746 | | | | 7.45 | |
| | 5 | 17.7211 | 2.1801 | 1.84667 | 23.79 | 0.62050 | | 3.52 |
| | 6 | 43.0923 | 3.7502 | | | | | |
| | 7 (St) | ∞ | 4.3502 | | | | | |
| Gf | 8 | 24.4047 | 2.6552 | 1.90069 | 37.05 | 0.57804 | | |
| (+) | 9 | −23.8862 | 0.6351 | 1.84667 | 23.79 | 0.62050 | | |
| | 10 | 39.8330 | 2.4111 | | | | | |
| | *11 | −12.7715 | 0.6751 | 1.66121 | 20.35 | 0.66162 | 6.41 | |
| | *12 | −21.2434 | 0.0500 | | | | 7.28 | |
| | 13 | 94.5255 | 5.2749 | 1.77535 | 50.30 | 0.55004 | | |
| | 14 | −15.1293 | 5.2775 | | | | | |
| | *15 | −29.9633 | 1.7498 | 1.53409 | 55.87 | 0.55858 | 10.09 | |
| | *16 | −26.0385 | 0.2398 | | | | 10.92 | |
| | 17 | −53.8237 | 4.1700 | 1.48749 | 70.32 | 0.52917 | | |
| | 18 | −19.0839 | 2.7000 | | | | 11.62 | |
| Gi | 19 | −29.4115 | 0.8752 | 1.83400 | 37.21 | 0.58082 | | |
| (−) | 20 | −223.2761 | 16.5021 | | | | | |

TABLE 22
Example 6

| | |
|---|---|
| f | 18.26 |
| Bf | 16.50 |
| FNo | 2.89 |
| 2ωm [°] | 109.6 |

TABLE 23
Example 6

Variable Surface Spacing

| Sn | Infinite Distance | 0.15x |
|---|---|---|
| 7 | 4.3502 | 2.4690 |
| 18 | 2.7000 | 4.5812 |

TABLE 24
Example 6

| Sn | 3 | 4 |
|---|---|---|
| KA | 1.0000000E+00 | 1.0000000E+00 |
| A4 | −2.3715789E−05 | −7.6652740E−05 |
| A6 | −2.3726693E−07 | −4.3025518E−07 |
| A8 | 8.4949492E−10 | −1.2268610E−08 |
| A10 | −8.2522960E−11 | −9.1061658E−11 |
| A12 | 6.1253281E−13 | 1.6784685E−12 |

| Sn | 11 | 12 |
|---|---|---|
| KA | 1.0000000E+00 | 1.0000000E+00 |
| A4 | 1.3277380E−05 | 8.2394663E−05 |
| A6 | 1.0296697E−06 | −2.0707838E−08 |
| A8 | −1.0164419E−07 | 5.2372537E−10 |
| A10 | 2.1757950E−09 | −7.4979893E−11 |
| A12 | −4.0050835E−12 | −1.1857044E−12 |
| A14 | 1.6481520E−13 | 1.3443771E−14 |
| A16 | −3.5793620E−14 | 1.8946070E−16 |
| A18 | 5.7343496E−16 | 2.1020549E−18 |
| Sn | 15 | 16 |
| KA | 1.0000000E+00 | 1.0000000E+00 |
| A4 | −6.9657763E−05 | 1.3970295E−05 |
| A6 | 1.0772876E−06 | 9.8848128E−07 |
| A8 | −5.2934158E−09 | −1.7105085E−09 |
| A10 | −6.2600001E−11 | −5.6219398E−11 |
| A12 | 2.8505106E−13 | 2.5506019E−13 |
| A14 | 1.2890497E−15 | 1.9071286E−16 |
| A16 | −1.5523204E−17 | −1.9326461E−18 |

### Example 7

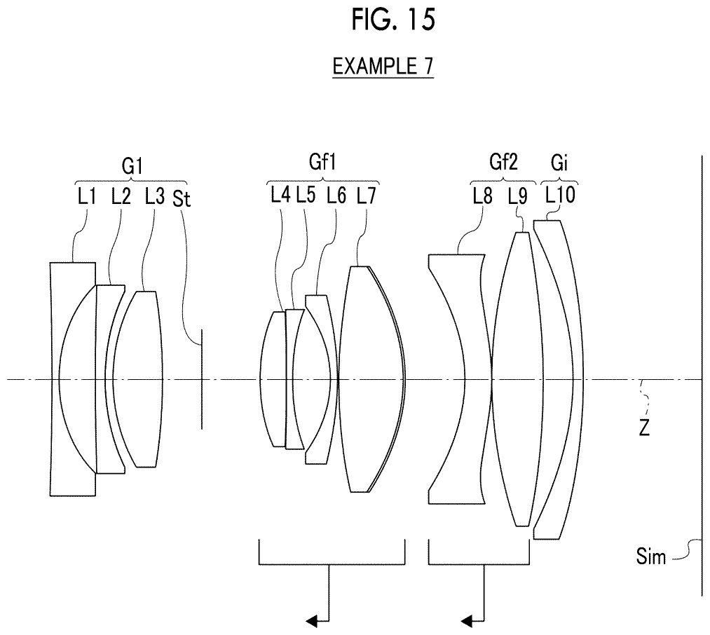

A cross-sectional view of a configuration of an imaging lens of Example 7 is illustrated in FIG. 15. The imaging lens of Example 7 consists of, in order from the object side to the image side, the first lens group G1 having a negative refractive power, the first focus lens group Gf1 having a positive refractive power, the second focus lens group Gf2 having a positive refractive power, and the image-side lens group G1 having a negative refractive power. During focusing from the infinite distance object to the nearest object, the first lens group G1 and the image-side lens group G1 are fixed with respect to the image plane Sim, and the first focus lens group Gf1 and the second focus lens group Gf2 move to the object side by different moving amounts.

The first lens group G1 consists of, in order from the object side to the image side, three lenses including the lenses L1 to L3 and the aperture stop St. The first focus lens group Gf1 consists of, in order from the object side to the image side, four lenses including the lenses L4 to L7. The second focus lens group Gf2 consists of, in order from the object side to the image side, two lenses including the lenses L8 and L9. The image-side lens group G1 consists of one lens that is the lens L10. The lens L7 is a compound aspherical lens. The materials of the lens L6 and the lens L8 are plastic.

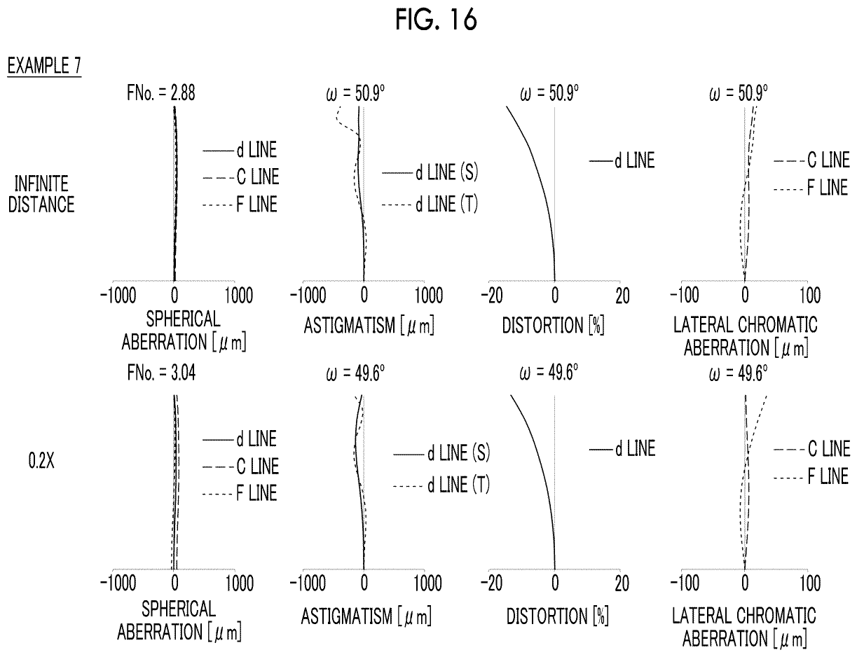

For the imaging lens of Example 7, Table 25 shows basic lens data, Table 26 shows specifications, Table 27 shows a variable surface spacing, Table 28 shows aspherical coefficients, and FIG. 16 illustrates each aberration diagram.

TABLE 25
Example 7

| | Sn | R | D | Nd | νd | θgF | ER | ρ |
|---|---|---|---|---|---|---|---|---|
| G1 | 1 | −457.7147 | 0.7000 | 1.69189 | 42.72 | 0.57182 | | 3.41 |
| (−) | 2 | 13.9684 | 3.2500 | | | | | |
| | 3 | 249.8111 | 1.0000 | 1.48749 | 70.32 | 0.52917 | | 2.45 |
| | 4 | 20.6388 | 0.6981 | | | | | |
| | 5 | 16.6190 | 4.5776 | 1.77535 | 50.30 | 0.55004 | | 4.35 |
| | 6 | −70.4904 | 3.7498 | | | | | |
| | 7 (St) | ∞ | 5.3602 | | | | | |
| Gf1 | 8 | 18.0520 | 2.4746 | 1.85150 | 40.78 | 0.56958 | | |
| (+) | 9 | −234.5753 | 0.6350 | 1.80000 | 29.84 | 0.60178 | | |
| | 10 | 21.4167 | 3.5440 | | | | | |
| | *11 | −11.9763 | 0.6751 | 1.66121 | 20.35 | 0.66162 | 6.87 | |
| | *12 | −21.2496 | 0.0500 | | | | 8.02 | |
| | 13 | 54.9017 | 5.9975 | 1.88300 | 39.22 | 0.57288 | | |
| | 14 | −18.6540 | 0.1400 | 1.56093 | 36.64 | 0.58853 | | |
| | *15 | −22.7367 | 5.6598 | | | | 10.88 | |
| Gf2 | *16 | −13.6488 | 2.5002 | 1.66121 | 20.35 | 0.66162 | 10.69 | |
| (+) | *17 | −18.9093 | 0.0500 | | | | 11.90 | |
| | 18 | 47.8914 | 4.8003 | 1.53775 | 74.70 | 0.53936 | | |
| | 19 | −69.6092 | 2.7000 | | | | 14.01 | |
| Gi | 20 | −29.4115 | 0.8750 | 1.96300 | 24.11 | 0.62126 | | |
| (−) | 21 | −55.4451 | 11.0991 | | | | | |

TABLE 26
Example 7

| | |
|---|---|
| f | 20.60 |
| Bf | 11.10 |
| FNo | 2.88 |
| 2ωm [°] | 101.8 |

TABLE 27
Example 7

Variable Surface Spacing

| Sn | Infinite Distance | 0.2x |
|---|---|---|
| 7 | 5.3602 | 2.4690 |
| 15 | 5.6598 | 4.8433 |
| 19 | 2.7000 | 6.4077 |

TABLE 28
Example 7

| Sn | 11 | 12 |
|---|---|---|
| KA | 1.0000000E+00 | 1.0000000E+00 |
| A4 | 4.3387854E−05 | 1.2726589E−04 |
| A6 | −3.5820325E−07 | −1.2582952E−07 |
| A8 | −3.1383506E−08 | −2.6849531E−09 |
| A10 | 2.1761736E−10 | −6.7544117E−11 |
| A12 | 7.0683606E−12 | −4.8567609E−13 |
| A14 | −2.5516827E−14 | 8.4288198E−15 |
| A16 | −9.3626514E−15 | −2.1394815E−17 |
| A18 | 1.3260678E−16 | 6.0289742E−19 |

| Sn | 15 | 16 | 17 |
|---|---|---|---|
| KA | 1.0000000E+00 | 1.0000000E+00 | 1.0000000E+00 |
| A4 | −7.2917386E−05 | 9.4066948E−05 | 1.3696448E−04 |
| A6 | −3.0190840E−07 | 1.1862057E−06 | 1.0302140E−06 |
| A8 | 7.6476515E−09 | −3.0932145E−09 | −2.4376575E−09 |
| A10 | −2.2990689E−11 | −7.4818217E−11 | −5.8019220E−11 |
| A12 | −2.8945075E−13 | 1.9816715E−13 | 2.4414410E−13 |
| A14 | 3.2387369E−15 | 2.0075299E−15 | 5.8352452E−16 |
| A16 | −9.6313015E−18 | −6.1922813E−18 | −3.2758804E−18 |

### Example 8

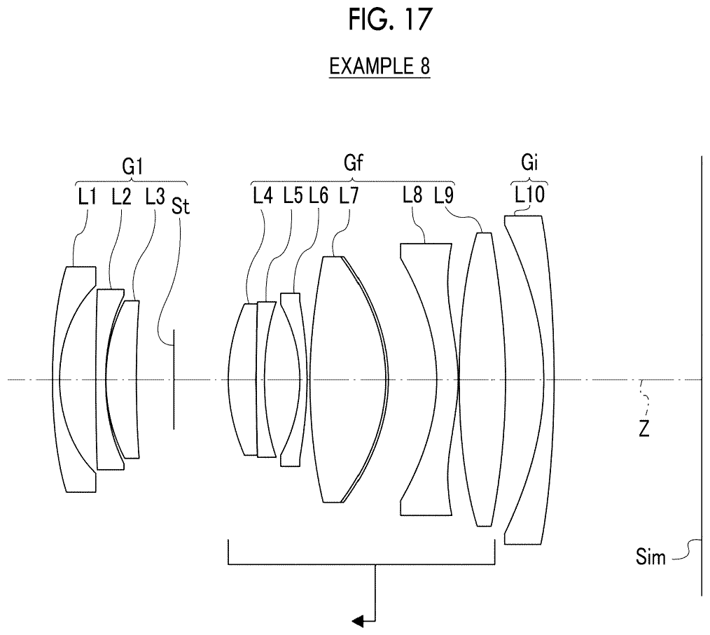

A cross-sectional view of a configuration of an imaging lens of Example 8 is illustrated in FIG. 17. The imaging lens of Example 8 consists of, in order from the object side to the image side, the first lens group G1 having a negative refractive power, the single focus lens group Gf having a positive refractive power, and the image-side lens group G1 having a negative refractive power. During focusing from the infinite distance object to the nearest object, the first lens group G1 and the image-side lens group G1 are fixed with respect to the image plane Sim, and the single focus lens group Gf moves to the object side.

The first lens group G1 consists of, in order from the object side to the image side, three lenses including the lenses L1 to L3 and the aperture stop St. The single focus lens group Gf consists of, in order from the object side to the image side, six lenses including the lenses L4 to L9. The image-side lens group G1 consists of one lens that is the lens L10. The lens L7 is a compound aspherical lens. The materials of the lens L6 and the lens L8 are plastic.

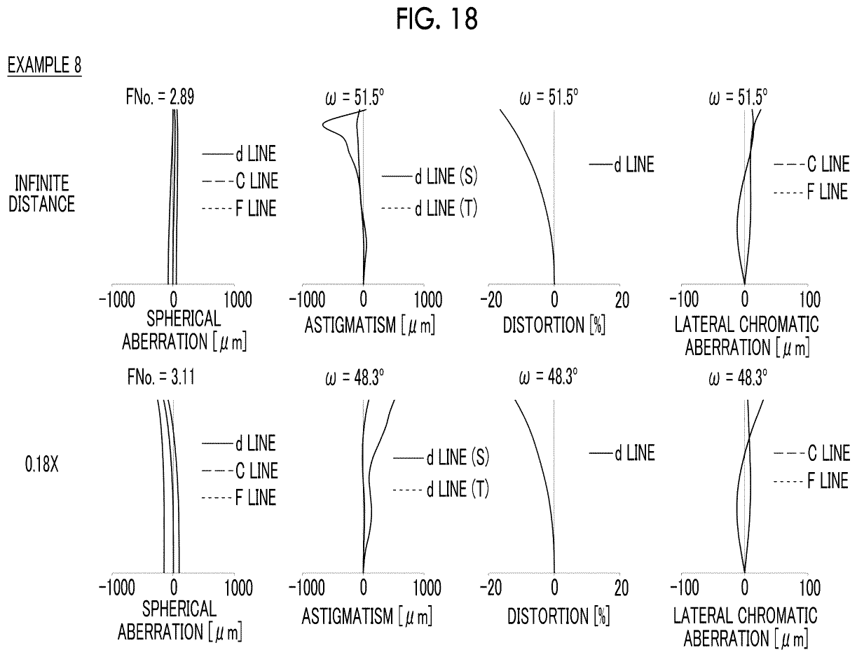

For the imaging lens of Example 8, Table 29 shows basic lens data, Table 30 shows specifications, Table 31 shows a variable surface spacing, Table 32 shows aspherical coefficients, and FIG. 18 illustrates each aberration diagram.

TABLE 29
Example 8

| | Sn | R | D | Nd | νd | θgF | ER | ρ |
|---|---|---|---|---|---|---|---|---|
| G1 | 1 | 44.0657 | 0.7002 | 1.62299 | 58.16 | 0.54589 | | 3.60 |
| (−) | 2 | 12.8988 | 3.2500 | | | | | |
| | 3 | 959.6023 | 0.7248 | 1.48749 | 70.32 | 0.52917 | | 2.45 |
| | 4 | 17.2338 | 0.0485 | | | | | |
| | 5 | 15.8366 | 2.8255 | 1.75500 | 52.32 | 0.54757 | | 4.17 |
| | 6 | 119.3342 | 3.1514 | | | | | |
| | 7 (St) | ∞ | 4.9008 | | | | | |
| Gf | 8 | 16.7493 | 2.4831 | 1.88300 | 39.22 | 0.57288 | | |
| (+) | 9 | 145.9102 | 0.6852 | 1.78472 | 25.68 | 0.61621 | | |
| | 10 | 20.8246 | 3.1947 | | | | | |
| | *11 | −13.0583 | 0.6752 | 1.66121 | 20.35 | 0.66162 | 7.17 | |
| | *12 | −21.8039 | 0.2171 | | | | 8.14 | |
| | 13 | 48.3257 | 6.7231 | 1.88300 | 39.22 | 0.57288 | | |
| | 14 | −18.7910 | 0.1400 | 1.56093 | 36.64 | 0.58853 | | |
| | *15 | −22.5759 | 4.2969 | | | | | |
| | *16 | −12.4979 | 1.9954 | 1.66121 | 20.35 | 0.66162 | 11.00 | |
| | *17 | −16.4964 | 0.0500 | | | | 12.14 | |
| | 18 | 63.7181 | 4.0634 | 1.77535 | 50.30 | 0.55004 | | |
| | 19 | −70.0894 | 3.3873 | | | | 13.57 | |
| Gi | 20 | −29.5855 | 0.8752 | 1.80518 | 25.42 | 0.61616 | | |
| (−) | 21 | −112.9288 | 13.1001 | | | | | |

TABLE 30
Example 8

| | |
|---|---|
| f | 20.60 |
| Bf | 13.10 |
| FNo | 2.89 |
| 2ωm [°] | 103.0 |

TABLE 31
Example 8

Variable Surface Spacing

| Sn | Infinite Distance | 0.18x |
|---|---|---|
| 7 | 4.9008 | 2.2690 |
| 19 | 3.3873 | 6.0191 |

TABLE 32
Example 8

| Sn | 11 | 12 |
|---|---|---|
| KA | 1.0000000E+00 | 1.0000000E+00 |
| A4 | 1.9459282E−04 | 2.5515275E−04 |
| A6 | −4.5692285E−07 | −1.8833413E−07 |
| A8 | −2.1265466E−08 | −3.7921122E−09 |
| A10 | 5.6350807E−11 | −2.4347159E−10 |
| A12 | 1.2057068E−11 | 1.1875946E−12 |
| A14 | −4.1383030E−13 | 3.5166028E−14 |
| A16 | 2.2754678E−15 | −2.7240100E−16 |
| A18 | 3.7591353E−17 | 1.1072572E−18 |

| Sn | 15 | 16 | 17 |
|---|---|---|---|
| KA | 1.0000000E+00 | 1.0000000E+00 | 1.0000000E+00 |
| A4 | −5.8238179E−05 | 2.3050704E−04 | 2.3972001E−04 |
| A6 | −5.0137067E−07 | 3.5047222E−07 | 5.6260287E−07 |
| A8 | 8.8332216E−09 | −6.9165070E−10 | −2.8449361E−09 |
| A10 | −1.5966118E−11 | −5.4704124E−11 | −5.2030039E−11 |
| A12 | −3.7339795E−13 | 2.5347069E−13 | 2.5349937E−13 |
| A14 | 2.7797480E−15 | −2.0435717E−16 | 5.3443391E−16 |
| A16 | −6.0318808E−18 | 2.3291592E−18 | −3.4602602E−18 |

### Example 9

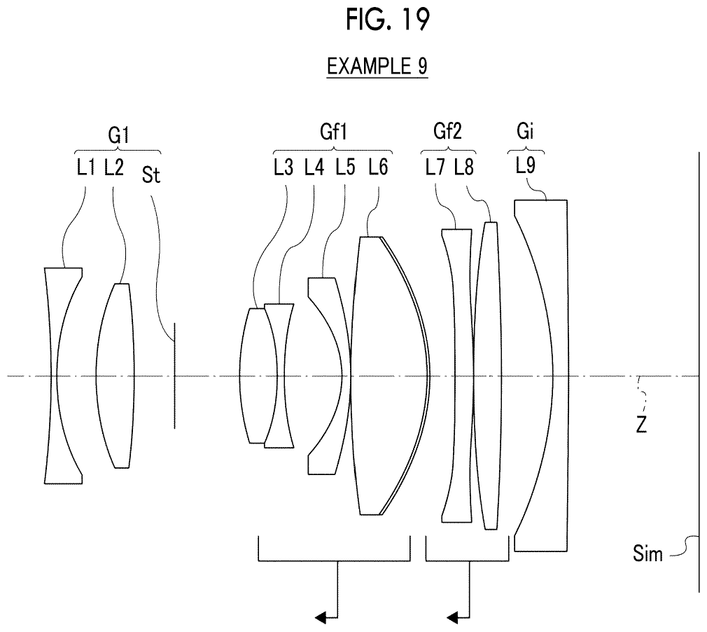

A cross-sectional view of a configuration of an imaging lens of Example 9 is illustrated in FIG. 19. The imaging lens of Example 9 consists of, in order from the object side to the image side, the first lens group G1 having a positive refractive power, the first focus lens group Gf1 having a positive refractive power, the second focus lens group Gf2 having a positive refractive power, and the image-side lens group G1 having a negative refractive power. During focusing from the infinite distance object to the nearest object, the first lens group G1 and the image-side lens group G1 are fixed with respect to the image plane Sim, and the first focus lens group Gf1 and the second focus lens group Gf2 move to the object side by different moving amounts.

The first lens group G1 consists of, in order from the object side to the image side, two lenses including the lenses L1 and L2 and the aperture stop St. The first focus lens group Gf1 consists of, in order from the object side to the image side, four lenses including the lenses L3 to L6. The second focus lens group Gf2 consists of, in order from the object side to the image side, two lenses including the lenses L7 and L8. The image-side lens group G1 consists of one lens that is the lens L9. The lens L6 is a compound aspherical lens. The material of the lens L7 is plastic.

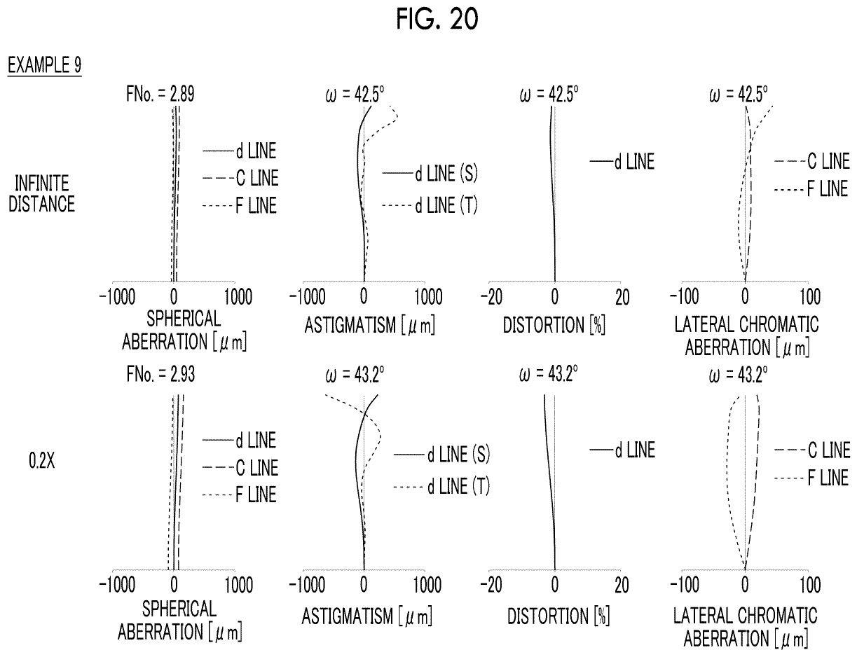

For the imaging lens of Example 9, Table 33 shows basic lens data, Table 34 shows specifications, Table 35 shows a variable surface spacing, Table 36 shows aspherical coefficients, and FIG. 20 illustrates each aberration diagram.

TABLE 33
Example 9

| | Sn | R | D | Nd | νd | θgF | ER | ρ |
|---|---|---|---|---|---|---|---|---|
| G1 | 1 | −87.8265 | 0.5184 | 1.83400 | 37.21 | 0.58082 | | 4.43 |
| (+) | 2 | 18.7760 | 3.4990 | | | | | |
| | 3 | 22.8448 | 3.2835 | 1.95375 | 32.32 | 0.59056 | | 4.94 |
| | 4 | −81.1208 | 3.6408 | | | | | |
| | 5 (St) | ∞ | 5.7945 | | | | | |
| Gf1 | 6 | 22.8463 | 3.3431 | 1.95375 | 32.32 | 0.59056 | | |
| (+) | 7 | −16.6747 | 0.5099 | 1.86074 | 23.08 | 0.62589 | | |
| | 8 | 25.8629 | 5.0355 | | | | | |
| | 9 | −10.5829 | 0.8603 | 1.95906 | 17.47 | 0.65993 | | |
| | 10 | −28.5316 | 0.0472 | | | | | |
| | 11 | 98.6997 | 6.5988 | 2.00100 | 29.13 | 0.59952 | | |
| | 12 | −21.1582 | 0.4031 | 1.56093 | 36.64 | 0.58853 | | |
| | *13 | −22.6786 | 2.1171 | | | | 12.55 | |
| Gf2 | *14 | −534.3587 | 1.6386 | 1.66121 | 20.35 | 0.66162 | 12.54 | |
| (+) | *15 | −48.4700 | 0.0674 | | | | 13.24 | |
| | 16 | 103.6770 | 2.4040 | 1.77535 | 50.30 | 0.55004 | | |
| | 17 | −249.9961 | 4.5140 | | | | 13.90 | |
| Gi | 18 | −33.1578 | 1.5001 | 1.48749 | 70.32 | 0.52917 | | |
| (−) | 19 | −606.5149 | 11.4111 | | | | | |

TABLE 34
Example 9

| | |
|---|---|
| f | 23.84 |
| Bf | 11.41 |
| FNo | 2.89 |
| 2ωm [°] | 85.0 |

TABLE 35
Example 9

Variable Surface Spacing

| Sn | Infinite Distance | 0.2x |
|---|---|---|
| 5 | 5.7945 | 2.8219 |
| 13 | 2.1171 | 1.3226 |
| 17 | 4.5140 | 8.2812 |

TABLE 36
Example 9

| Sn | 13 | 14 | 15 |
|---|---|---|---|
| KA | 1.0000000E+00 | 1.0000000E+00 | 1.0000000E+00 |
| A4 | −6.7024707E−05 | −4.8666599E−05 | 6.1787835E−05 |
| A6 | 2.3346921E−07 | 4.7851715E−07 | 2.4145260E−07 |
| A8 | 1.7413021E−09 | −2.6962410E−09 | −8.7762172E−10 |
| A10 | −9.8612684E−12 | 3.4857175E−12 | −2.7427732E−12 |
| A12 | −1.5879173E−14 | 1.9068625E−14 | −1.6500773E−14 |
| A14 | 1.4303721E−16 | −4.0244677E−16 | −1.3891545E−18 |
| A16 | −1.0836854E−19 | 8.4030125E−19 | 3.6129158E−19 |

### Example 10

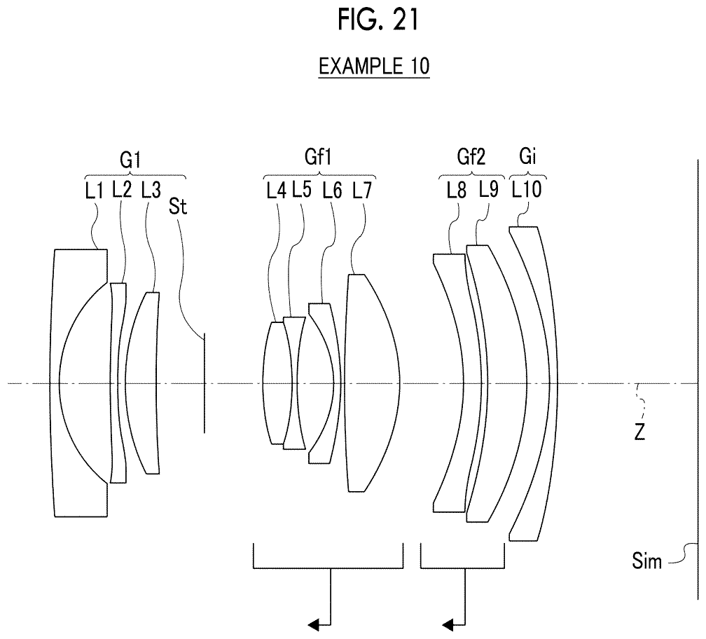

A cross-sectional view of a configuration of an imaging lens of Example 10 is illustrated in FIG. 21. The imaging lens of Example 10 consists of, in order from the object side to the image side, the first lens group G1 having a negative refractive power, the first focus lens group Gf1 having a positive refractive power, the second focus lens group Gf2 having a positive refractive power, and the image-side lens group G1 having a negative refractive power. During focusing from the infinite distance object to the nearest object, the first lens group G1 and the image-side lens group G1 are fixed with respect to the image plane Sim, and the first focus lens group Gf1 and the second focus lens group Gf2 move to the object side by different moving amounts.

The first lens group G1 consists of, in order from the object side to the image side, three lenses including the lenses L1 to L3 and the aperture stop St. The first focus lens group Gf1 consists of, in order from the object side to the image side, four lenses including the lenses L4 to L7. The second focus lens group Gf2 consists of, in order from the object side to the image side, two lenses including the lenses L8 and L9. The image-side lens group G1 consists of one lens that is the lens L10. The materials of the lens L2, the lens L6, and the lens L8 are plastic.

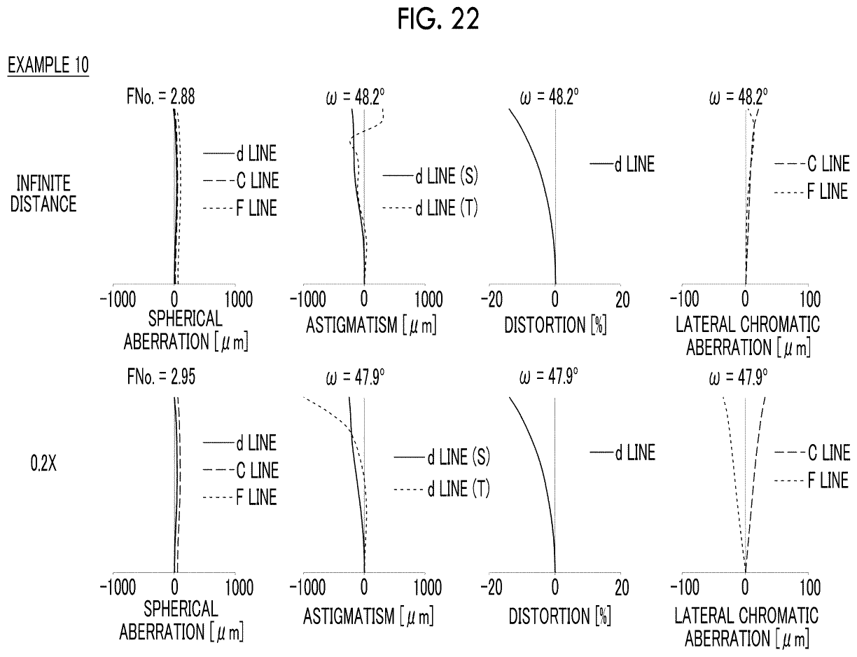

For the imaging lens of Example 10, Table 37 shows basic lens data, Table 38 shows specifications, Table 39 shows a variable surface spacing, Table 40 shows aspherical coefficients, and FIG. 22 illustrates each aberration diagram.

TABLE 37
Example 10

| | Sn | R | D | Nd | νd | θgF | ER | ρ |
|---|---|---|---|---|---|---|---|---|
| G1 | 1 | 225.5907 | 0.8880 | 1.48749 | 70.32 | 0.52917 | | 2.45 |
| (−) | 2 | 15.7099 | 6.1649 | | | | | |
| | *3 | 80.1134 | 0.9194 | 1.53409 | 55.87 | 0.55858 | 12.17 | 1.01 |
| | *4 | 35.6849 | 0.8149 | | | | 11.82 | |
| | 5 | 23.6424 | 3.6222 | 1.88300 | 39.22 | 0.57288 | | 5.17 |
| | 6 | 143.3783 | 5.9251 | | | | | |
| | 7 (St) | ∞ | 6.8765 | | | | | |
| Gf1 | 8 | 29.7567 | 3.3325 | 1.88300 | 39.22 | 0.57288 | | |
| (+) | 9 | −23.8902 | 0.8052 | 1.84666 | 23.80 | 0.62155 | | |
| | 10 | 41.8213 | 3.9637 | | | | | |
| | *11 | −13.3487 | 1.1508 | 1.66121 | 20.35 | 0.66162 | 8.25 | |
| | *12 | −25.9744 | 0.3960 | | | | 9.82 | |
| | 13 | 195.1476 | 6.3423 | 1.90265 | 35.72 | 0.58047 | | |
| | 14 | −23.1508 | 7.5247 | | | | 13.23 | |
| Gf2 | *15 | −35.5601 | 2.2201 | 1.53409 | 55.87 | 0.55858 | 14.41 | |
| (+) | *16 | −35.9571 | 0.8029 | | | | 15.56 | |
| | 17 | −50.5867 | 4.4395 | 1.77535 | 50.30 | 0.55004 | | |
| | 18 | −32.6762 | 2.7000 | | | | 16.63 | |
| Gi | 19 | −37.3095 | 1.1098 | 1.83400 | 37.21 | 0.58082 | | |
| (−) | 20 | −80.8419 | 16.5893 | | | | | |

TABLE 38
Example 10

| | |
|---|---|
| f | 28.50 |
| Bf | 16.59 |
| FNo | 2.88 |
| 2ωm [°] | 96.4 |

TABLE 39
Example 10

Variable Surface Spacing

| Sn | Infinite Distance | 0.2x |
|---|---|---|
| 7 | 6.8765 | 3.7975 |
| 14 | 7.5247 | 4.2429 |
| 18 | 2.7000 | 9.0609 |

TABLE 40
Example 10

| Sn | 3 | 4 |
|---|---|---|
| KA | 1.0000000E+00 | 1.0000000E+00 |
| A4 | −2.7376013E−05 | −3.5150324E−05 |
| A6 | −1.0087195E−07 | −1.2212587E−07 |
| A8 | 7.2517725E−11 | −3.7277128E−10 |
| A10 | −3.7349119E−13 | 3.6812598E−12 |
| A12 | 4.0955714E−15 | −4.5480461E−15 |

| Sn | 11 | 12 |
|---|---|---|
| KA | 1.0000000E+00 | 1.0000000E+00 |
| A4 | 2.2024327E−05 | 3.7608752E−05 |
| A6 | 4.3000349E−07 | 1.8377576E−07 |
| A8 | −9.8177725E−09 | −1.8148602E−09 |
| A10 | 8.2270223E−11 | 2.6264691E−12 |
| A12 | 5.5654854E−13 | −3.4731337E−14 |
| A14 | 3.4291021E−15 | 2.3406742E−15 |
| A16 | −4.8155365E−16 | −2.5725915E−17 |
| A18 | 4.5502008E−18 | 1.0338992E−19 |

| Sn | 15 | 16 |
|---|---|---|
| KA | 1.0000000E+00 | 1.0000000E+00 |
| A4 | −3.7728078E−05 | −5.8109086E−06 |
| A6 | 3.7232765E−07 | 3.2855530E−07 |
| A8 | −6.3038397E−10 | −4.7089525E−10 |
| A10 | −7.5670089E−12 | −5.4062248E−12 |
| A12 | 1.9510630E−14 | 1.7124208E−14 |
| A14 | 6.6007887E−17 | 1.4371140E−17 |
| A16 | −2.2081475E−19 | −7.6003179E−20 |

### Example 11

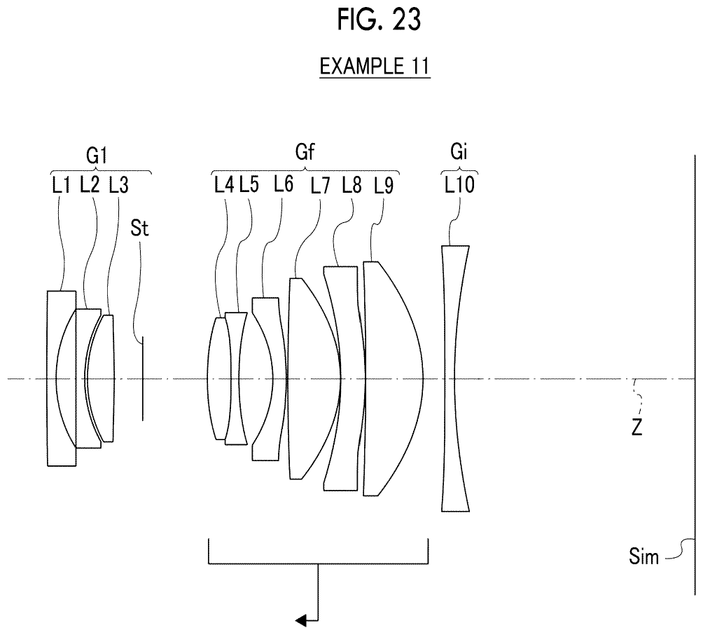

A cross-sectional view of a configuration of an imaging lens of Example 11 is illustrated in FIG. 23. The imaging lens of Example 11 consists of, in order from the object side to the image side, the first lens group G1 having a negative refractive power, the single focus lens group Gf having a positive refractive power, and the image-side lens group G1 having a negative refractive power. During focusing from the infinite distance object to the nearest object, the first lens group G1 and the image-side lens group G1 are fixed with respect to the image plane Sim, and the single focus lens group Gf moves to the object side.

The first lens group G1 consists of, in order from the object side to the image side, three lenses including the lenses L1 to L3 and the aperture stop St. The single focus lens group Gf consists of, in order from the object side to the image side, six lenses including the lenses L4 to L9. The image-side lens group G1 consists of one lens that is the lens L10.

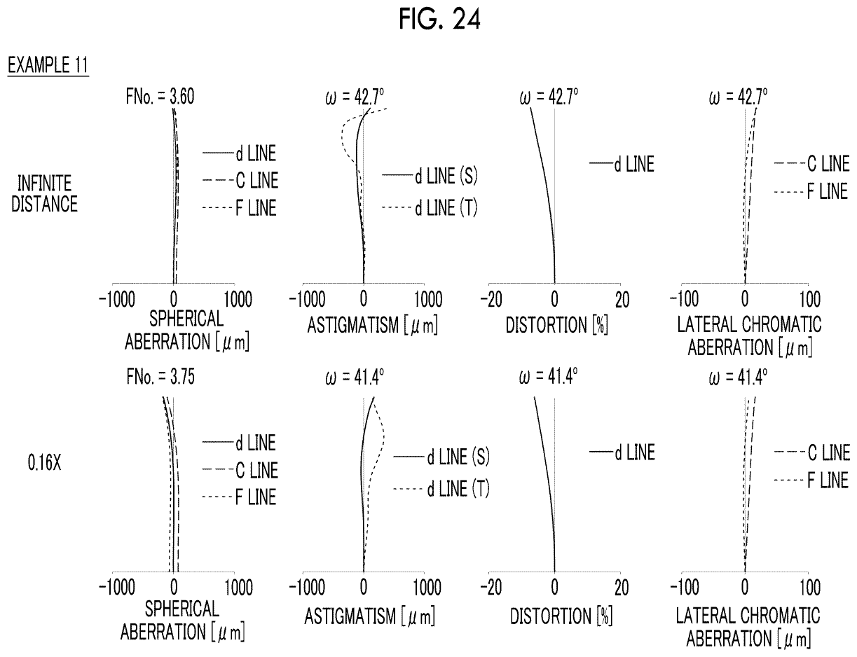

For the imaging lens of Example 11, Table 41 shows basic lens data, Table 42 shows specifications, Table 43 shows a variable surface spacing, Table 44 shows aspherical coefficients, and FIG. 24 illustrates each aberration diagram.

TABLE 41
Example 11

| | Sn | R | D | Nd | νd | θgF | ER | ρ |
|---|---|---|---|---|---|---|---|---|
| G1 | 1 | −563.4601 | 0.8879 | 1.48749 | 70.32 | 0.52917 | | 2.45 |
| (−) | 2 | 16.8861 | 2.2809 | | | | | |
| | 3 | 165.3513 | 1.2688 | 1.67270 | 32.18 | 0.59733 | | 2.90 |
| | 4 | 17.7482 | 0.1665 | | | | | |
| | 5 | 17.1072 | 3.3689 | 1.88300 | 39.22 | 0.57288 | | 5.17 |
| | 6 | −301.1811 | 3.4242 | | | | | |
| | 7 (St) | ∞ | 7.5887 | | | | | |
| Gf | 8 | 26.9078 | 3.0042 | 1.88300 | 39.22 | 0.57288 | | |
| (+) | 9 | −39.0672 | 0.8057 | 1.62588 | 35.72 | 0.58880 | | |
| | 10 | 28.0226 | 4.1329 | | | | | |
| | *11 | −12.1902 | 1.7280 | 1.80301 | 25.53 | 0.61531 | 8.19 | |
| | *12 | −24.3616 | 0.0501 | | | | 10.00 | |
| | 13 | 342.5569 | 6.3428 | 1.77535 | 50.30 | 0.55004 | | |
| | 14 | −18.4832 | 0.1108 | | | | | |
| | *15 | −31.2244 | 2.6896 | 1.76450 | 49.10 | 0.55289 | 12.74 | |
| | *16 | −47.6384 | 0.0500 | | | | 13.83 | |
| | 17 | −462.8172 | 6.9768 | 1.43875 | 94.66 | 0.53402 | | |
| | 18 | −21.8155 | 2.7000 | | | | 14.63 | |
| Gi | 19 | −325.5023 | 1.1102 | 1.83400 | 37.16 | 0.57759 | | |
| (−) | 20 | 78.1553 | 28.9082 | | | | | |

TABLE 42
Example 11

| | |
|---|---|
| f | 31.98 |
| Bf | 28.91 |
| FNo | 3.60 |
| 2ωm [°] | 85.4 |

TABLE 43
Example 11

Variable Surface Spacing

| Sn | Infinite Distance | 0.16x |
|---|---|---|
| 7 | 7.5887 | 4.8078 |
| 18 | 2.7000 | 5.4809 |

TABLE 44
Example 11

| Sn | 11 | 12 |
|---|---|---|
| KA | 1.0000000E+00 | 1.0000000E+00 |
| A4 | 1.8163098E−04 | 1.5184188E−04 |
| A6 | −2.1053522E−07 | −2.0469582E−07 |
| A8 | −8.8979489E−09 | −2.2232392E−09 |
| A10 | 1.0709233E−10 | −1.4891312E−11 |
| A12 | −1.3174131E−12 | −8.1779043E−14 |
| A14 | 1.2759185E−14 | 3.0259141E−15 |
| A16 | −2.3577889E−16 | −1.0404602E−17 |
| A18 | 2.2678483E−18 | −4.9053847E−21 |

| Sn | 15 | 16 |
|---|---|---|
| KA | 1.0000000E+00 | 1.0000000E+00 |
| A4 | 6.1484845E−06 | 2.8512090E−05 |
| A6 | 3.9053939E−07 | 2.0646934E−07 |
| A8 | −1.0618546E−09 | −3.3710825E−10 |
| A10 | −7.8891175E−12 | −5.4786079E−12 |
| A12 | 1.7667270E−14 | 1.4720121E−14 |
| A14 | 6.3263569E−17 | 2.2091761E−17 |
| A16 | −2.0224493E−19 | −7.7873185E−20 |

### Example 12

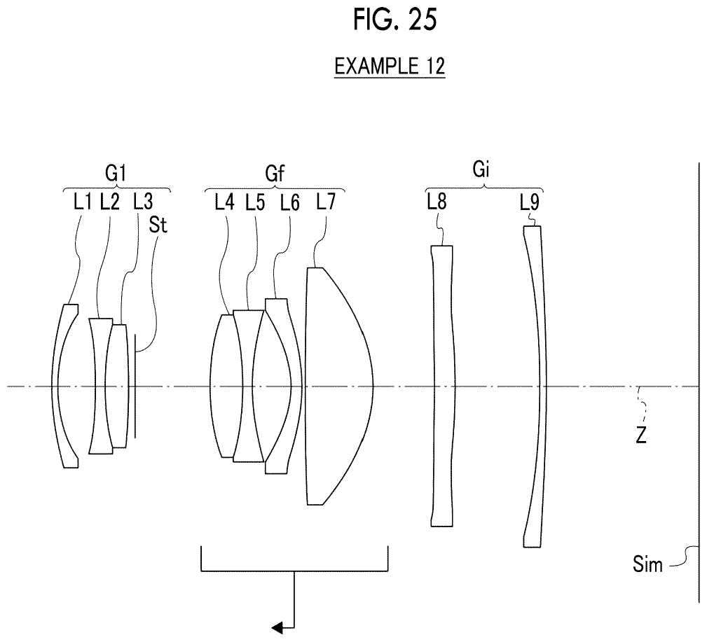

A cross-sectional view of a configuration of an imaging lens of Example 12 is illustrated in FIG. 25. The imaging lens of Example 12 consists of, in order from the object side to the image side, the first lens group G1 having a negative refractive power, the single focus lens group Gf having a positive refractive power, and the image-side lens group G1 having a negative refractive power. During focusing from the infinite distance object to the nearest object, the first lens group G1 and the image-side lens group G1 are fixed with respect to the image plane Sim, and the single focus lens group Gf moves to the object side.

The first lens group G1 consists of, in order from the object side to the image side, three lenses including the lenses L1 to L3 and the aperture stop St. The single focus lens group Gf consists of, in order from the object side to the image side, four lenses including the lenses L4 to L7. The image-side lens group G1 consists of, in order from the object side to the image side, two lenses including the lenses L8 and L9.

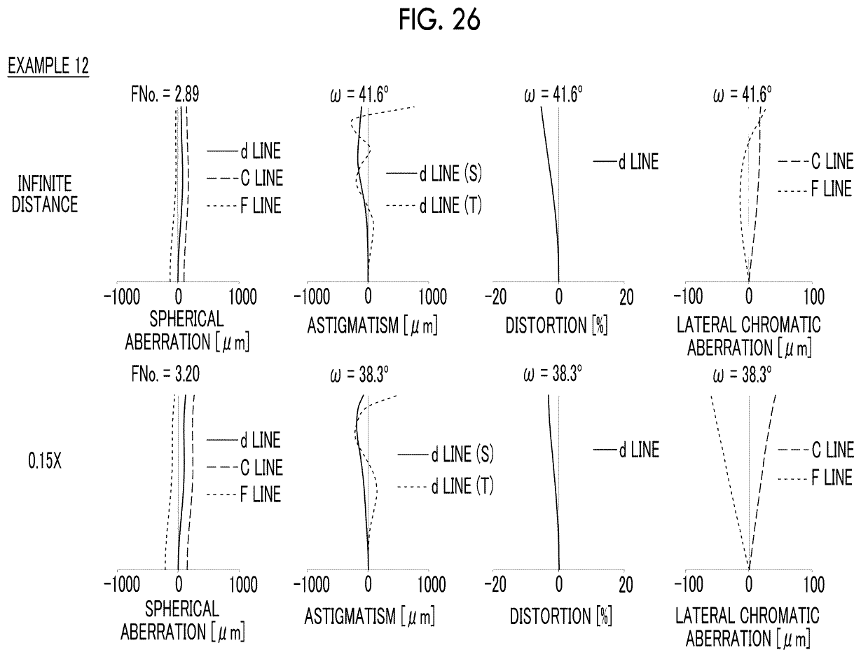

For the imaging lens of Example 12, Table 45 shows basic lens data, Table 46 shows specifications, Table 47 shows a variable surface spacing, Table 48 shows aspherical coefficients, and FIG. 26 illustrates each aberration diagram.

TABLE 45
Example 12

| | Sn | R | D | Nd | νd | θgF | ER | ρ |
|---|---|---|---|---|---|---|---|---|
| G1 | 1 | 33.4005 | 0.7000 | 1.60311 | 60.64 | 0.54148 | | 3.43 |
| (−) | 2 | 16.4620 | 4.7946 | | | | | |
| | 3 | −41.5046 | 1.0099 | 1.55200 | 70.70 | 0.54219 | | 3.74 |
| | 4 | 32.9266 | 2.9942 | 1.88300 | 39.22 | 0.57288 | | 5.17 |
| | 5 | −65.7378 | 0.7502 | | | | | |
| | 6 (St) | ∞ | 9.0470 | | | | | |
| Gf | 7 | 26.5480 | 3.9999 | 1.88300 | 39.22 | 0.57288 | | |
| (+) | 8 | −34.4460 | 1.1452 | 1.86074 | 23.08 | 0.62589 | | |
| | 9 | 31.2288 | 4.7381 | | | | | |
| | *10 | −11.9464 | 1.4539 | 1.85400 | 40.38 | 0.56890 | 8.80 | |
| | *11 | −16.7108 | 0.3756 | | | | 8.95 | |
| | 12 | 545.1604 | 7.9998 | 1.77535 | 50.30 | 0.55004 | | |
| | 13 | −21.1848 | 7.5247 | | | | 14.87 | |
| Gi | *14 | −278.8370 | 2.4998 | 1.58913 | 61.15 | 0.53824 | | |
| (−) | *15 | −96.6863 | 10.3643 | | | | | |
| | 16 | −101.8093 | 0.8749 | 2.00100 | 29.13 | 0.59952 | | |
| | 17 | −260.3187 | 18.5868 | | | | | |

TABLE 46
Example 12

| | |
|---|---|
| f | 32.56 |
| Bf | 18.59 |
| FNo | 2.89 |
| 2ωm [°] | 83.2 |

TABLE 47
Example 12

Variable Surface Spacing

| Sn | Infinite Distance | 0.15x |
|---|---|---|
| 6 | 9.0470 | 3.7348 |
| 13 | 7.5247 | 12.8369 |

TABLE 48
Example 12

| Sn | 10 | 11 |
|---|---|---|
| KA | 1.0000000E+00 | 1.0000000E+00 |
| A4 | 1.9400045E−04 | 1.6486460E−04 |
| A6 | 4.6645976E−07 | 1.0939602E−07 |
| A8 | −1.2465028E−08 | −6.1541736E−09 |
| A10 | 2.1353378E−10 | 3.7964305E−11 |
| A12 | −4.3862492E−12 | 1.7612604E−13 |
| A14 | 8.4213928E−14 | −2.2335915E−15 |
| A16 | −8.0460162E−16 | 2.8014041E−20 |
| A18 | 2.9103726E−18 | 3.5189105E−20 |
| Sn | 14 | 15 |
| KA | 1.0000000E+00 | 1.0000000E+00 |
| A4 | 6.5790149E−06 | 1.2898857E−05 |
| A6 | −4.1761627E−08 | 7.4002854E−10 |
| A8 | 9.3055176E−10 | 4.8315343E−10 |
| A10 | −5.2563417E−12 | −1.9758194E−12 |
| A12 | 1.0289874E−14 | −1.4136743E−15 |
| A14 | −3.7651257E−18 | 1.5124573E−17 |
| A16 | −1.0833109E−20 | −1.8811964E−20 |

### Example 13

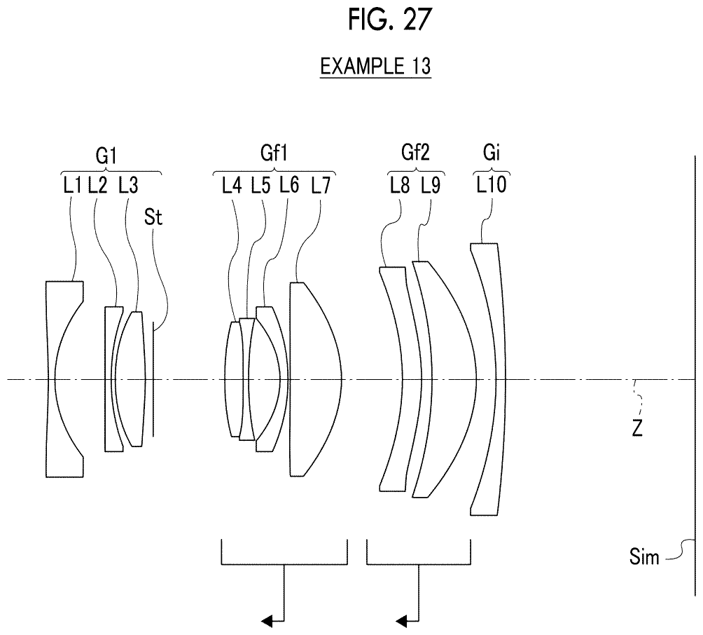

A cross-sectional view of a configuration of an imaging lens of Example 13 is illustrated in FIG. 27. The imaging lens of Example 13 consists of, in order from the object side to the image side, the first lens group G1 having a positive refractive power, the first focus lens group Gf1 having a positive refractive power, the second focus lens group Gf2 having a positive refractive power, and the image-side lens group G1 having a negative refractive power. During focusing from the infinite distance object to the nearest object, the first lens group G1 and the image-side lens group G1 are fixed with respect to the image plane Sim, and the first focus lens group Gf1 and the second focus lens group Gf2 move to the object side by different moving amounts.

The first lens group G1 consists of, in order from the object side to the image side, three lenses including the lenses L1 to L3 and the aperture stop St. The first focus lens group Gf1 consists of, in order from the object side to the image side, four lenses including the lenses L4 to L7. The second focus lens group Gf2 consists of, in order from the object side to the image side, two lenses including the lenses L8 and L9. The image-side lens group G1 consists of one lens that is the lens L01.

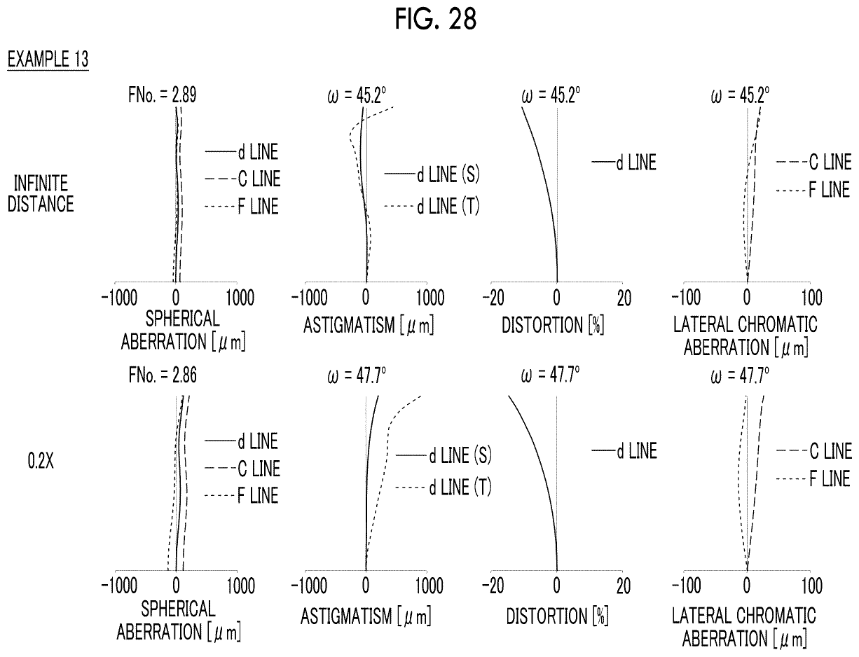

For the imaging lens of Example 13, Table 49 shows basic lens data, Table 50 shows specifications, Table 51 shows a variable surface spacing, Table 52 shows aspherical coefficients, and FIG. 28 illustrates each aberration diagram.

TABLE 49
Example 13

| | Sn | R | D | Nd | νd | θgF | ER | ρ |
|---|---|---|---|---|---|---|---|---|
| G1 | 1 | −338.6829 | 0.8877 | 1.60562 | 43.71 | 0.57214 | | 2.91 |
| (+) | 2 | 15.8385 | 6.0229 | | | | | |
| | 3 | 199.3958 | 0.9194 | 1.48749 | 70.32 | 0.52917 | | 2.45 |
| | 4 | 26.0379 | 0.5173 | | | | | |
| | 5 | 19.3366 | 3.6994 | 1.77535 | 50.30 | 0.55004 | | 4.35 |
| | 6 | −86.8954 | 0.9517 | | | | | |
| | 7 (St) | ∞ | 8.8930 | | | | | |
| Gf1 | 8 | 48.0685 | 2.2199 | 1.95375 | 32.33 | 0.59055 | | |
| (+) | 9 | −58.3236 | 0.8025 | 1.80100 | 34.97 | 0.58642 | | |
| | 10 | 54.9521 | 3.5524 | | | | | |
| | *11 | −11.3615 | 1.3025 | 2.00178 | 19.32 | 0.64480 | 7.81 | |
| | *12 | −17.1542 | 0.0500 | | | | 9.16 | |
| | 13 | −1880.9675 | 6.3423 | 1.77535 | 50.30 | 0.55004 | | |
| | 14 | −18.0639 | 7.5247 | | | | 12.15 | |
| Gf2 | *15 | −27.6165 | 2.2196 | 1.95150 | 29.83 | 0.59560 | 13.45 | |
| (+) | *16 | −30.0045 | 1.4198 | | | | 14.18 | |
| | 17 | −44.6450 | 5.2219 | 1.49700 | 81.54 | 0.53748 | | |
| | 18 | −21.5638 | 2.7000 | | | | 15.15 | |
| Gi | 19 | −43.5809 | 1.1100 | 2.00100 | 29.13 | 0.59952 | | |
| (−) | 20 | −129.2195 | 23.2950 | | | | | |

TABLE 50
Example 13

| | |
|---|---|
| f | 30.58 |
| Bf | 23.30 |
| FNo | 2.89 |
| 2ωm [°] | 90.4 |

TABLE 51
Example 13

Variable Surface Spacing

| Sn | Infinite Distance | 0.2x |
|---|---|---|
| 7 | 8.8930 | 7.2025 |
| 14 | 7.5247 | 2.9476 |
| 18 | 2.7000 | 8.9677 |

TABLE 52
Example 13

| Sn | 11 | 12 |
|---|---|---|
| KA | 1.0000000E+00 | 1.0000000E+00 |
| A4 | 8.6521496E−05 | 8.3875469E−05 |
| A6 | 2.3074934E−07 | 4.8016998E−08 |
| A8 | −7.3300966E−09 | −3.9113127E−09 |
| A10 | −6.6724111E−11 | −5.4527139E−12 |
| A12 | −1.3454511E−13 | 5.2221464E−13 |
| A14 | 9.4261055E−14 | 9.4298802E−16 |
| A16 | −1.7604675E−15 | −6.1373570E−17 |
| A18 | 1.0208810E−17 | 2.9724152E−19 |
| Sn | 15 | 16 |
| KA | 1.0000000E+00 | 1.0000000E+00 |
| A4 | −2.8048738E−06 | 1.4775516E−05 |
| A6 | 3.0565997E−07 | 2.4203947E−07 |
| A8 | −6.5191127E−10 | −2.2323800E−10 |
| A10 | −5.6581437E−12 | −5.1562217E−12 |
| A12 | 2.1518776E−14 | 1.8022879E−14 |
| A14 | 6.6926399E−17 | 1.7882926E−17 |
| A16 | −3.2562827E−19 | −1.2323221E−19 |

### Example 14

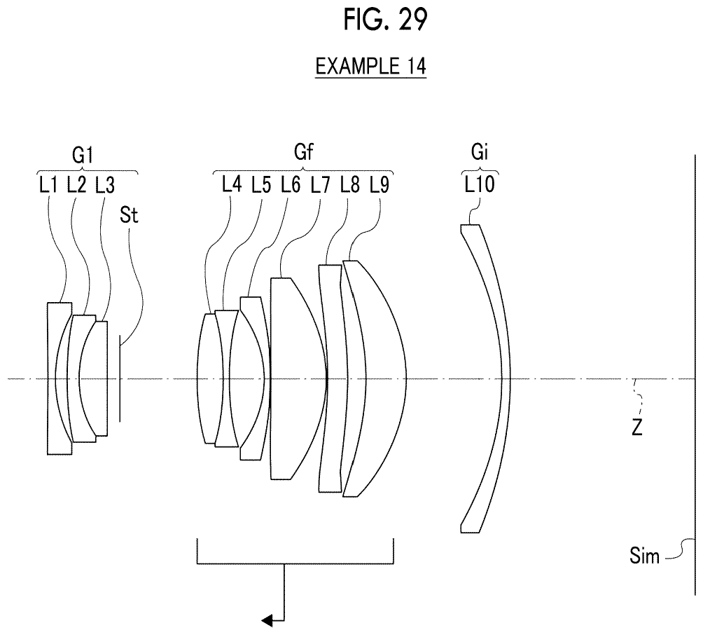

A cross-sectional view of a configuration of an imaging lens of Example 14 is illustrated in FIG. 29. The imaging lens of Example 14 consists of, in order from the object side to the image side, the first lens group G1 having a negative refractive power, the single focus lens group Gf having a positive refractive power, and the image-side lens group G1 having a negative refractive power. During focusing from the infinite distance object to the nearest object, the first lens group G1 and the image-side lens group G1 are fixed with respect to the image plane Sim, and the single focus lens group Gf moves to the object side.

The first lens group G1 consists of, in order from the object side to the image side, three lenses including the lenses L1 to L3 and the aperture stop St. The single focus lens group Gf consists of, in order from the object side to the image side, six lenses including the lenses L4 to L9. The image-side lens group G1 consists of one lens that is the lens L10.

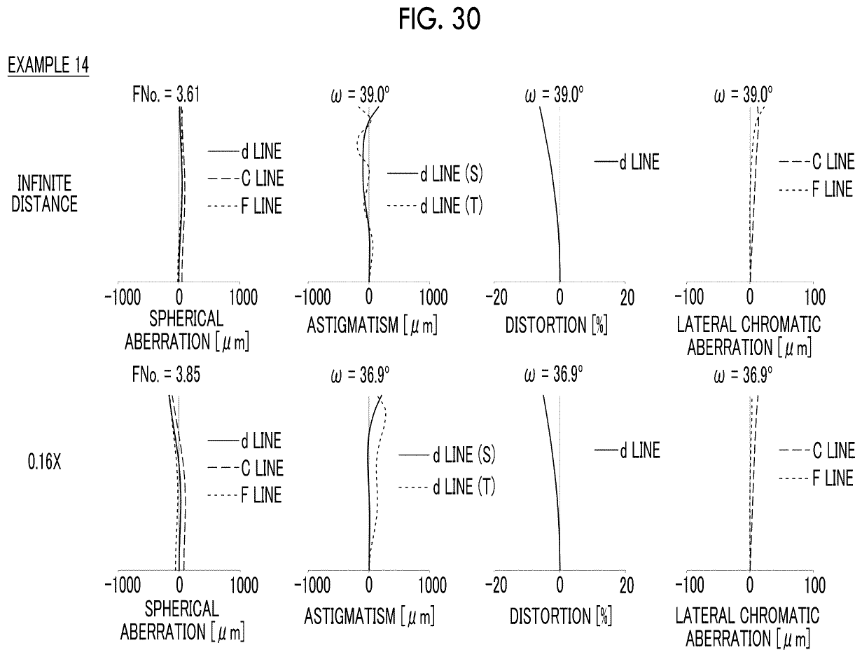

For the imaging lens of Example 14, Table 53 shows basic lens data, Table 54 shows specifications, Table 55 shows a variable surface spacing, Table 56 shows aspherical coefficients, and FIG. 30 illustrates each aberration diagram.

TABLE 53
Example 14

| | Sn | R | D | Nd | νd | θgF | ER | ρ |
|---|---|---|---|---|---|---|---|---|
| G1 | 1 | 3793.0037 | 0.8877 | 1.48749 | 70.32 | 0.52917 | | 2.45 |
| (−) | 2 | 17.1097 | 1.3955 | | | | | |
| | 3 | 52.9212 | 1.2784 | 1.67270 | 32.18 | 0.59733 | | 2.90 |
| | 4 | 13.0947 | 3.1000 | 1.88300 | 39.22 | 0.57288 | | 5.17 |
| | 5 | 200.4638 | 1.5608 | | | | | |
| | 6 (St) | ∞ | 8.7907 | | | | | |
| Gf | 7 | 30.9457 | 3.0077 | 1.88300 | 39.22 | 0.57288 | | |
| (+) | 8 | −35.1838 | 0.8025 | 1.62588 | 35.72 | 0.58880 | | |
| | 9 | 30.7308 | 3.8411 | | | | | |
| | *10 | −13.5356 | 0.8565 | 1.80301 | 25.53 | 0.61531 | 8.27 | |
| | *11 | −31.6123 | 0.0503 | | | | 9.66 | |
| | 12 | −486.2463 | 6.3423 | 1.77535 | 50.30 | 0.55004 | | |
| | 13 | −19.0057 | 0.1266 | | | | | |
| | *14 | −44.9128 | 2.2199 | 1.76450 | 49.10 | 0.55289 | 12.90 | |
| | *15 | −43.8455 | 2.2740 | | | | 13.43 | |
| | 16 | −34.0292 | 4.4399 | 1.43875 | 94.66 | 0.53402 | | |
| | 17 | −20.1770 | 10.9919 | | | | 14.12 | |
| Gi | 18 | −34.4301 | 1.1102 | 2.00100 | 29.13 | 0.59952 | | |
| (−) | 19 | −45.3048 | 21.0829 | | | | | |

TABLE 54
Example 14

| | |
|---|---|
| f | 36.01 |
| Bf | 21.08 |
| FNo | 3.61 |
| 2ωm [°] | 78.0 |

TABLE 55
Example 14

Variable Surface Spacing

| | Infinite | |
|---|---|---|
| Sn | Distance | 0.16x |
| 6 | 8.7907 | 4.3880 |
| 17 | 10.9919 | 15.3946 |

TABLE 56
Example 14

| Sn | 10 | 11 |
|---|---|---|
| KA | 1.0000000E+00 | 1.0000000E+00 |
| A4 | 7.2170464E−05 | 6.2577088E−05 |
| A6 | 1.9922112E−07 | −1.2761837E−08 |
| A8 | −1.2745705E−08 | −1.5511608E−09 |
| A10 | 1.2361389E−10 | 8.2398110E−13 |
| A12 | −2.0919104E−13 | 1.1375534E−13 |
| A14 | 3.1211409E−14 | 6.4410465E−16 |
| A16 | −8.2945491E−16 | −3.4247621E−17 |
| A18 | 5.1960922E−18 | 1.9161253E−19 |
| Sn | 14 | 15 |
| KA | 1.0000000E+00 | 1.0000000E+00 |
| A4 | −3.5207582E−06 | 2.1376025E−05 |
| A6 | 4.2997042E−07 | 2.7634796E−07 |
| A8 | −7.6877170E−10 | −2.4456791E−10 |
| A10 | −7.2667594E−12 | −5.4803233E−12 |
| A12 | 1.9819842E−14 | 1.5211888E−14 |
| A14 | 7.5441061E−17 | 8.4618696E−18 |
| A16 | −3.8293279E−19 | −9.3123203E−20 |

### Example 15

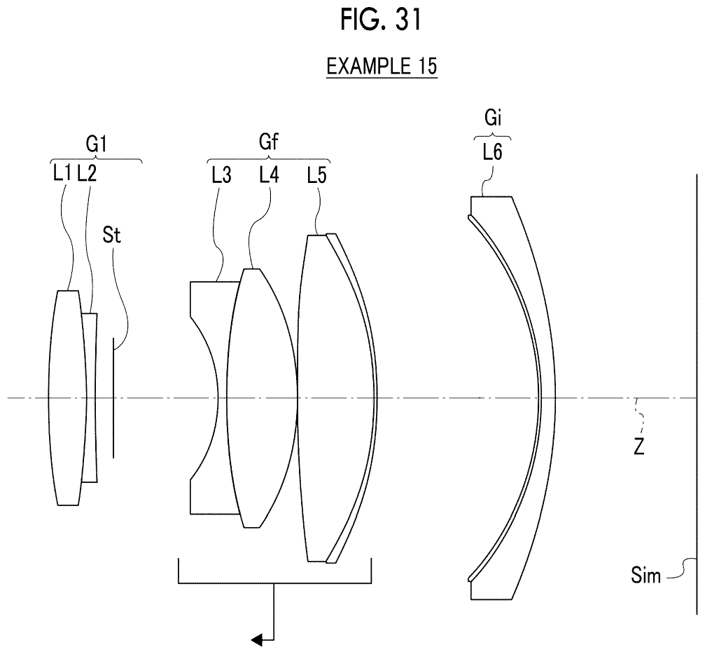

A cross-sectional view of a configuration of an imaging lens of Example 15 is illustrated in FIG. 31. The imaging lens of Example 15 consists of, in order from the object side to the image side, the first lens group G1 having a positive refractive power, the single focus lens group Gf having a positive refractive power, and the image-side lens group G1 having a negative refractive power. During focusing from the infinite distance object to the nearest object, the first lens group G1 and the image-side lens group G1 are fixed with respect to the image plane Sim, and the single focus lens group Gf moves to the object side.

The first lens group G1 consists of, in order from the object side to the image side, two lenses including the lenses L1 and L2 and the aperture stop St. The single focus lens group Gf consists of, in order from the object side to the image side, three lenses including the lenses L3 to L5. The image-side lens group G1 consists of one lens that is the lens L6. The lens L5 and the lens L6 are compound aspherical lenses.

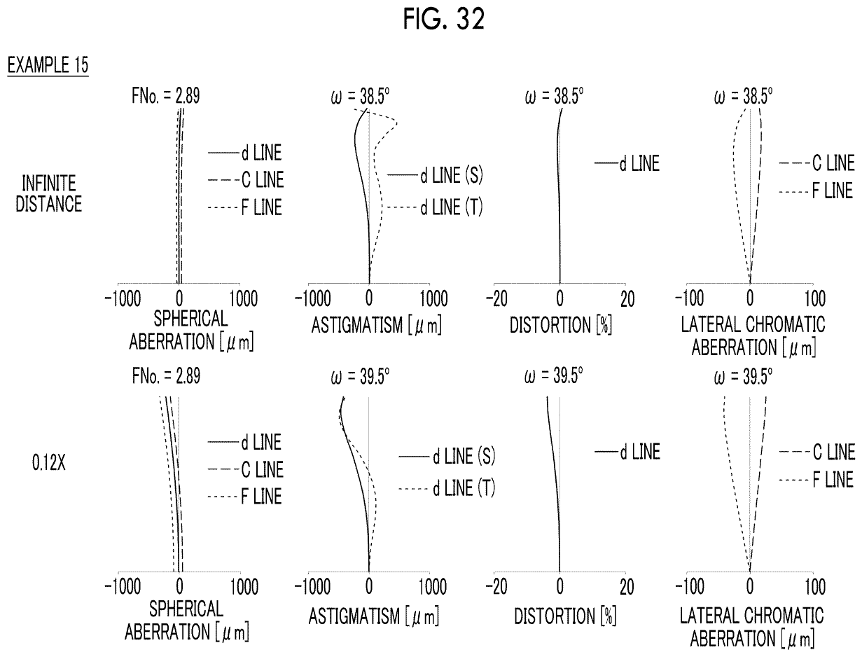

For the imaging lens of Example 15, Table 57 shows basic lens data, Table 58 shows specifications, Table 59 shows a variable surface spacing, Table 60 shows aspherical coefficients, and FIG. 32 illustrates each aberration diagram.

TABLE 57
Example 15

| | Sn | R | D | Nd | νd | θgF | ER | ρ |
|---|---|---|---|---|---|---|---|---|
| G1 | 1 | 46.4859 | 2.7500 | 1.88300 | 39.22 | 0.57288 | | 5.17 |
| (+) | 2 | −54.6135 | 0.6348 | 1.80518 | 25.42 | 0.61616 | | 3.37 |
| | 3 | 137.3917 | 1.2689 | | | | | |
| | 4 (St) | ∞ | 7.4998 | | | | | |
| Gf | 5 | −10.1919 | 0.7602 | 1.71736 | 29.52 | 0.60483 | | |
| (+) | 6 | 43.9244 | 4.9870 | 1.88300 | 39.22 | 0.57288 | | |
| | 7 | −18.0469 | 0.1000 | | | | | |
| | 8 | 111.4541 | 5.5197 | 1.77535 | 50.30 | 0.55004 | | |
| | 9 | −22.8144 | 0.2000 | 1.56093 | 36.64 | 0.58853 | | |
| | *10 | −22.1509 | 11.6078 | | | | 12.28 | |
| Gi | *11 | −22.2389 | 0.2000 | 1.56093 | 36.64 | 0.58853 | | |
| (−) | 12 | −20.4346 | 1.0002 | 1.95375 | 32.32 | 0.59015 | | |
| | 13 | −37.3723 | 10.2655 | | | | | |

TABLE 58
Example 15

| | |
|---|---|
| f | 27.02 |
| Bf | 10.27 |
| FNo | 2.89 |
| 2ωm [°] | 77.0 |

TABLE 59
Example 15

Variable Surface Spacing

| | Infinite | |
|---|---|---|
| Sn | Distance | 0.12x |
| 4 | 7.4998 | 5.1246 |
| 10 | 11.6078 | 13.9830 |

TABLE 60
Example 15

| Sn | 10 | 11 |
|---|---|---|
| KA | 1.0000000E+00 | 1.0000000E+00 |
| A4 | 2.8593546E−05 | −1.5712768E−05 |
| A6 | −2.3622367E−08 | 4.0547517E−08 |
| A8 | 2.0266085E−10 | −4.7771242E−10 |
| A10 | 3.8662475E−13 | 1.5009677E−12 |
| A12 | −3.3064000E−15 | −4.1254000E−15 |

Tables 61 to 68 show the corresponding values of Conditional Expressions (1) to (41) of the imaging lenses of Examples 1 to 15. In Tables 62, 64, 66, and 68, reference numerals of corresponding lenses are shown on the right of the corresponding values of Conditional Expressions (38) to (41).

For a compound aspherical lens, corresponding values of a spherical lens constituting the compound aspherical lens are shown. Preferable ranges of the conditional expressions may be set using the corresponding values of the examples shown in Tables 61 to 68 as the upper limits and the lower limits of the conditional expressions.

TABLE 61

| Expression | | | | | |
|---|---|---|---|---|---|
| Number | | Example 1 | Example 2 | Example 3 | Example 4 |
| (1) | ωm | 58.10 | 57.70 | 54.50 | 53.90 |
| (2) | Bf/(f × tan ωm) | 0.42 | 0.42 | 0.48 | 0.43 |
| (3) | TL/(f × tan ωm) | 2.39 | 2.43 | 2.40 | 2.33 |
| (4) | FNo/tan ωm | 1.79 | 1.82 | 2.05 | 2.10 |
| (5) | FNo | 2.88 | 2.88 | 2.88 | 2.88 |
| (6) | STI/TL | 0.29 | 0.31 | 0.25 | 0.25 |
| (7) | \|β\| | 0.2 | 0.2 | 0.2 | 0.15 |
| (8) | f/f1 | −0.1015 | −0.0412 | 0.0834 | −0.1780 |
| (9) | Denp/f | 0.6177 | 0.6642 | 0.4504 | 0.4901 |
| (10) | (R1f + R1r)/(R1f − R1r) | 1.6363 | 1.7488 | 1.5906 | 1.7492 |
| (11) | f/R1f | 0.3489 | 0.3816 | 0.3495 | 0.4804 |
| (12) | f/(−fL1) | 0.5313 | 0.4933 | 0.9108 | 0.7485 |
| (13) | (R2f + R2r)/(R2f − R2r) | 2.2085 | 6.1906 | 3.1039 | 2.2305 |
| (14) | (R1rf + R1rr)/(R1rf − R1rr) | −0.7745 | −0.9614 | −0.5878 | −1.0807 |
| (15) | ν1r | 70.32 | 39.22 | 70.32 | 39.59 |
| (16) | ρ1ave | 3.157 | 3.775 | 3.083 | 2.887 |
| (17) | (1/Rc1f − 1/Rc1r)/(1/Ry1f − 1/Ry1r) | — | — | — | 1.4778 |
| (18) | ff1/ff2 | 0.4025 | 0.4075 | 0.6428 | 0.6130 |
| (19) | βf1/βf2 | −0.1156 | −0.0472 | 0.1007 | −0.6601 |
| (20) | {βf1 + (1/βf1)}⁻² | 0.0098 | 0.0016 | 0.0062 | 0.1789 |
| (21) | {βf2 + (1/βf2)}⁻² | 0.2449 | 0.2444 | 0.2366 | 0.2421 |
| (22) | f/ff1 | 0.6791 | 0.6953 | 0.6577 | 0.3696 |
| (23) | νf1p − νf1n | −6.29 | −7.26 | −2.64 | 9.99 |
| (24) | Nf1p − Nf1n | 0.33486 | 0.30033 | 0.15275 | 0.16149 |
| (25) | Effave/(f × tan ωm) | 0.4661 | 0.4554 | 0.4686 | 0.3998 |
| (26) | f/(−fi) | 0.2403 | 0.2478 | 0.4641 | 0.3333 |
| (27) | Nir | 2.00069 | 2.00069 | 2.00069 | 1.85025 |

TABLE 62

| Expression | | | | | |
|---|---|---|---|---|---|
| Number | | Example 1 | Example 2 | Example 3 | Example 4 |
| (28) | (1/Rcff1f − 1/Rcff1r)/(1/Ryff1f − 1/Ryff1r) | 0.7542 | 0.6753 | 0.6392 | — |
| (29) | (1/Rcff2f − 1/Rcff2r)/(1/Ryff2f − 1/Ryff2r) | 0.2483 | 0.2051 | 0.2849 | — |
| (30) | fm/ff1 | — | — | — | 0.6262 |
| (31) | f/ff | — | — | — | — |
| (32) | TL/ff | — | — | — | — |
| (33) | νfp − νfn | — | — | — | — |
| (34) | Nfp − Nfn | — | — | — | — |
| (35) | Eff/(f × tan ωm) | — | — | — | — |
| (26) | f/(−fi) | — | — | — | — |
| (27) | Nir | — | — | — | — |
| (36) | (1/Rcffof − 1/Rcffor)/(1/Ryffof − 1/Ryffor) | — | — | — | — |
| (37) | (1/Rcffif − 1/Rcffir)/(1/Ryffif − 1/Ryffir) | — | — | — | — |
| (38) | Np − (2.015 − 0.0068 × νp) | 0.0959(L7) | 0.1024(L8) | 0.1024(L7) | 0.1024(L7) |
| | | 0.1024(L9) | | 0.1024(L9) | |
| (39) | νp | 52.34(L7) | 50.30(L8) | 50.30(L7) | 50.30(L7) |
| | | 50.30(L9) | | 50.30(L9) | |
| (40) | θgFp | 0.54761(L7) | 0.55004(L8) | 0.55004(L7) | 0.55004(L7) |
| | | 0.55004(L9) | | 0.55004(L9) | |
| (41) | θgFp − (0.6418 − 0.00168 × νp) | −0.0063(L7) | −0.0073(L8) | −0.0073(L7) | −0.0073(L7) |
| | | −0.0073(L9) | | −0.0073(L9) | |

TABLE 63

| Expression | | | | | |
|---|---|---|---|---|---|
| Number | | Example 5 | Example 6 | Example 7 | Example 8 |
| (1) | ωm | 52.00 | 54.80 | 50.90 | 51.50 |
| (2) | Bf/(f × tan ωm) | 0.43 | 0.64 | 0.44 | 0.51 |
| (3) | TL/(f × tan ωm) | 2.28 | 2.33 | 2.39 | 2.22 |
| (4) | FNo/tan ωm | 2.26 | 2.04 | 2.34 | 2.30 |
| (5) | FNo | 2.89 | 2.89 | 2.88 | 2.89 |
| (6) | STI/TL | 0.20 | 0.21 | 0.23 | 0.19 |
| (7) | \|β\| | 0.1 | 0.15 | 0.2 | 0.18 |
| (8) | f/f1 | 1.0174 | −0.6718 | −0.0895 | −0.3844 |
| (9) | Denp/f | 0.4060 | 0.4556 | 0.3840 | 0.3584 |
| (10) | (R1f + R1r)/(R1f − R1r) | 2.0179 | 3.1423 | 0.9408 | 1.8277 |
| (11) | f/R1f | 0.6050 | 1.0352 | −0.0450 | 0.4675 |
| (12) | f/(−fL1) | 0.6883 | 0.7039 | 1.0521 | 0.6976 |
| (13) | (R2f + R2r)/(R2f − R2r) | 1.9784 | 1.7376 | 1.1801 | 1.0366 |
| (14) | (R1rf + R1rr)/(R1rf − R1rr) | — | −2.3969 | −0.6184 | −1.3060 |
| (15) | ν1r | — | 23.79 | 50.30 | 52.32 |
| (16) | ρ1ave | 3.082 | 2.917 | 3.402 | 3.407 |
| (17) | (1/Rc1f − 1/Rc1r)/(1/Ry1f − 1/Ry1r) | — | 1.3306 | — | — |
| (18) | ff1/ff2 | — | — | 0.2183 | — |
| (19) | βf1/βf2 | — | — | −0.0832 | — |
| (20) | {βf1 + (1/βf1)}⁻² | — | — | 0.0062 | — |
| (21) | {βf2 + (1/βf2)}⁻² | — | — | 0.2494 | — |
| (22) | f/ff1 | — | — | 0.8861 | — |
| (23) | νf1p − νf1n | — | — | 10.94 | — |
| (24) | Nf1p − Nf1n | — | — | 0.0515 | — |
| (25) | Effave/(f × tan ωm) | — | — | 0.4910 | — |
| (26) | f/(−fi) | — | — | 0.3115 | — |
| (27) | Nir | — | — | 1.96300 | — |

TABLE 64

| Expression | | | | | |
|---|---|---|---|---|---|
| Number | | Example 5 | Example 6 | Example 7 | Example 8 |
| (28) | (1/Rcff1f − 1/Rcff1r)/(1/Ryff1f − 1/Ryff1r) | — | — | 0.6298 | — |
| (29) | (1/Rcff2f − 1/Rcff2r)/(1/Ryff2f − 1/Ryff2r) | — | — | 0.2939 | — |
| (30) | fm/ff1 | — | — | — | — |
| (31) | f/ff | 0.2675 | 0.3129 | — | 0.4722 |
| (32) | TL/ff | 0.7799 | 1.0327 | — | 1.3178 |
| (33) | νfp − νfn | 9.99 | 13.26 | — | 13.54 |
| (34) | Nfp − Nfn | 0.16149 | 0.05402 | — | 0.09828 |
| (35) | Eff/(f × tan ωm) | 0.5603 | 0.4487 | — | 0.5241 |
| (26) | f/(−fi) | 0.4223 | 0.4487 | — | 0.4118 |
| (27) | Nir | 1.85025 | 1.83400 | — | 1.80518 |
| (36) | (1/Rcffof − 1/Rcffor)/(1/Ryffof − 1/Ryffor) | — | 0.6404 | — | 0.5168 |
| (37) | (1/Rcffif − 1/Rcffir)/(1/Ryffif − 1/Ryffir) | — | −0.1117 | — | 0.2924 |
| (38) | Np − (2.015 − 0.0068 × νp) | 0.1024(L7) | 0.1024(L7) | 0.1024(L3) | 0.0958(L3) |
| | | | | | 0.1024(L9) |
| (39) | νp | 50.30(L7) | 50.30(L7) | 50.30(L3) | 52.32(L3) |
| | | | | | 50.30(L9) |
| (40) | θgFp | 0.55004(L7) | 0.55004(L7) | 0.55004(L3) | 0.54757(L3) |
| | | | | | 0.55004(L9) |
| (41) | θgFp − (0.6418− 0.00168 × νp) | −0.0073(L7) | −0.0073(L7) | −0.0073(L3) | −0.0063(L3) |
| | | | | | −0.0073(L9) |

TABLE 65

| Expression | | | | | |
|---|---|---|---|---|---|
| Number | | Example 9 | Example 10 | Example 11 | Example 12 |
| (1) | ωm | 42.50 | 48.20 | 42.70 | 41.60 |
| (2) | Bf/(f × tan ωm) | 0.52 | 0.52 | 0.98 | 0.64 |
| (3) | TL/(f × tan ωm) | 2.62 | 2.40 | 2.63 | 2.73 |
| (4) | FNo/tan ωm | 3.15 | 2.58 | 3.90 | 3.26 |
| (5) | FNo | 2.89 | 2.88 | 3.60 | 2.89 |
| (6) | STI/TL | 0.19 | 0.24 | 0.15 | 0.13 |
| (7) | \|β\| | 0.2 | 0.2 | 0.16 | 0.15 |
| (8) | f/f1 | 0.2340 | −0.0180 | −0.2124 | −0.2062 |
| (9) | Denp/f | 0.2935 | 0.4277 | 0.2399 | 0.2246 |
| (10) | (R1f + R1r)/(R1f − R1r) | 0.6477 | 1.1497 | 0.9418 | 2.9437 |
| (11) | f/R1f | −0.2714 | 0.1263 | −0.0568 | 0.9748 |
| (12) | f/(−fL1) | 1.2882 | 0.8216 | 0.9514 | 0.5955 |
| (13) | (R2f + R2r)/(R2f − R2r) | −0.5605 | 2.6064 | 1.2405 | 0.1152 |
| (14) | (R1rf + R1rr)/(R1rf − R1rr) | −0.5605 | −1.3949 | −0.8925 | −0.3326 |
| (15) | ν1r | 32.32 | 39.22 | 39.22 | 39.22 |
| (16) | ρ1ave | 4.685 | 2.877 | 3.507 | 4.113 |
| (17) | (1/Rc1f − 1/Rc1r)/(1/Ry1f − 1/Ry1r) | — | 1.3143 | — | — |
| (18) | ff1/ff2 | 1.0929 | 0.3044 | — | — |
| (19) | βf1/βf2 | 0.5063 | −0.0184 | — | — |
| (20) | {βf1 + (1/βf1)}⁻² | 0.0833 | 0.0003 | — | — |
| (21) | {βf2 + (1/βf2)}⁻² | 0.2028 | 0.2471 | — | — |
| (22) | f/ff1 | 0.5000 | 0.9045 | — | — |
| (23) | νf1p − νf1n | 9.24 | 15.42 | — | — |
| (24) | Nf1p − Nf1n | 0.09301 | 0.03634 | — | — |
| (25) | Effave/(f × tan ωm) | 0.6055 | 0.4684 | — | — |
| (26) | f/(−fi) | 0.3311 | 0.3391 | — | — |
| (27) | Nir | 1.48749 | 1.83400 | — | — |

TABLE 66

| Expression | | | | | |
|---|---|---|---|---|---|
| Number | | Example 9 | Example 10 | Example 11 | Example 12 |
| (28) | (1/Rcff1f − 1/Rcff1r)/(1/Ryff1f − 1/Ryff1r) | — | 0.7734 | — | — |
| (29) | (1/Rcff2f − 1/Rcff2r)/(1/Ryff2f − 1/Ryff2r) | −0.4252 | 0.0102 | — | — |
| (30) | fm/ff1 | — | — | — | — |
| (31) | f/ff | — | — | 1.2385 | 0.9382 |
| (32) | TL/ff | — | — | 3.0051 | 2.2722 |
| (33) | νfp − νfn | — | — | 3.50 | 16.14 |
| (34) | Nfp − Nfn | — | — | 0.25712 | 0.02226 |
| (35) | Eff/(f × tan ωm) | — | — | 0.4957 | 0.5144 |
| (26) | f/(−fi) | — | — | 0.4237 | 0.0569 |
| (27) | Nir | — | — | 1.83400 | 2.00100 |
| (36) | (1/Rcffof − 1/Rcffor)/(1/Ryffof − 1/Ryffor) | — | — | 0.7842 | 0.6654 |
| (37) | (1/Rcffif − 1/Rcffir)/(1/Ryffif − 1/Ryffir) | — | — | 0.3717 | 0.6654 |
| (38) | Np − (2.015 − 0.0068 × νp) | 0.1024(L8) | 0.1024(L9) | 0.1024(L7) | 0.1024(L7) |
| (39) | νp | 50.30(L8) | 50.30(L9) | 50.30(L7) | 50.30(L7) |
| (40) | θgFp | 0.55004(L8) | 0.55004(L9) | 0.55004(L7) | 0.55004(L7) |
| (41) | θgFp − (0.6418 − 0.00168 × νp) | −0.0073(L8) | −0.0073(L9) | −0.0073(L7) | −0.0073(L7) |

TABLE 67

| Expression | | | | |
|---|---|---|---|---|
| Number | | Example 13 | Example 14 | Example 15 |
| (1) | ωm | 45.20 | 39.00 | 38.50 |
| (2) | Bf/(f × tan ωm) | 0.76 | 0.72 | 0.48 |
| (3) | TL/(f × tan ωm) | 2.59 | 2.54 | 2.18 |
| (4) | FNo/tan ωm | 2.87 | 4.46 | 3.63 |
| (5) | FNo | 2.89 | 3.61 | 2.89 |
| (6) | STI/TL | 0.16 | 0.11 | 0.10 |
| (7) | \|β\| | 0.2 | 0.16 | 0.12 |
| (8) | f/f1 | 0.0920 | −0.1038 | 0.3979 |
| (9) | Denp/f | 0.2576 | 0.1541 | 0.1209 |
| (10) | (R1f + R1r)/(R1f − R1r) | 0.9106 | 1.0091 | — |
| (11) | f/R1f | −0.0903 | 0.0095 | — |
| (12) | f/(−fL1) | 1.2251 | 1.0213 | — |
| (13) | (R2f + R2r)/(R2f − R2r) | 1.3004 | 1.6576 | — |
| (14) | (R1rf + R1rr)/(R1rf − R1rr) | −0.6360 | −1.1398 | — |
| (15) | ν1r | 50.30 | 39.22 | — |
| (16) | ρ1ave | 3.237 | 3.507 | 4.270 |
| (17) | (1/Rc1f − 1/Rc1r)/(1/Ry1f − 1/Ry1r) | — | — | — |
| (18) | ff1/ff2 | 0.4302 | — | — |
| (19) | βf1/βf2 | 0.0940 | — | — |
| (20) | {βf1 + (1/βf1)}⁻² | 0.0063 | — | — |
| (21) | {βf2 + (1/βf2)}⁻² | 0.2432 | — | — |
| (22) | f/ff1 | 0.8503 | — | — |
| (23) | νf1p − νf1n | −2.64 | — | — |
| (24) | Nf1p − Nf1n | 0.15275 | — | — |
| (25) | Effave/(f × tan ωm) | 0.4433 | — | — |
| (26) | f/(−fi) | 0.4625 | — | — |
| (27) | Nir | 2.00100 | — | — |

TABLE 68

| Expression | | | | |
|---|---|---|---|---|
| Number | | Example 13 | Example 14 | Example 15 |
| (28) | (1/Rcff1f − 1/Rcff1r)/(1/Ryff1f − 1/Ryff1r) | 0.7571 | — | — |
| (29) | (1/Rcff2f − 1/Rcff2r)/(1/Ryff2f − 1/Ryff2r) | 0.1501 | — | — |
| (30) | fm/ff1 | — | — | — |
| (31) | f/ff | — | 1.1262 | 1.1560 |
| (32) | TL/ff | — | 2.3192 | 2.0019 |
| (33) | νfp − νfn | — | 3.50 | −9.70 |
| (34) | Nfp − Nfn | — | 0.25712 | −0.16564 |
| (35) | Eff/(f × tan ωm) | — | 0.4844 | 0.5715 |
| (26) | f/(−fi) | — | 0.2385 | 0.4951 |
| (27) | Nir | — | 2.00100 | 1.95375 |
| (36) | (1/Rcffof − 1/Rcffor)/(1/Ryffof − 1/Ryffor) | — | 0.8603 | — |
| (37) | (1/Rcffif − 1/Rcffir)/(1/Ryffif − 1/Ryffir) | — | −0.0429 | — |
| (38) | Np − (2.015 − 0.0068 × νp) | 0.1024(L3) | 0.1024(L7) | 0.1024(L5) |
| | | 0.1024(L7) | | |
| (39) | νp | 50.30(L3) | 50.30(L7) | 50.30(L5) |
| | | 50.30(L7) | | |
| (40) | θgFp | 0.55004(L3) | 0.55004(L7) | 0.55004(L5) |
| | | 0.55004(L7) | | |
| (41) | θgFp − (0.6418 − 0.00168 × νp) | −0.0073(L3) | −0.0073(L7) | −0.0073(L5) |
| | | −0.0073(L7) | | |

The imaging lenses of Examples 1 to 15 have a full angle of view greater than 75 degrees, which is a wide angle of view. The imaging lenses of Examples 1 to 15 have an open F-number less than 3.7. Particularly, a part of the examples has an open F-number less than 3 and implements an optical system having a small F-number. The imaging lenses of Examples 1 to 15, while being configured to be reduced in size, maintain high optical performance by favorably correcting various aberrations in both of the state where the infinite distance object is in focus and the state where the nearest object is in focus.

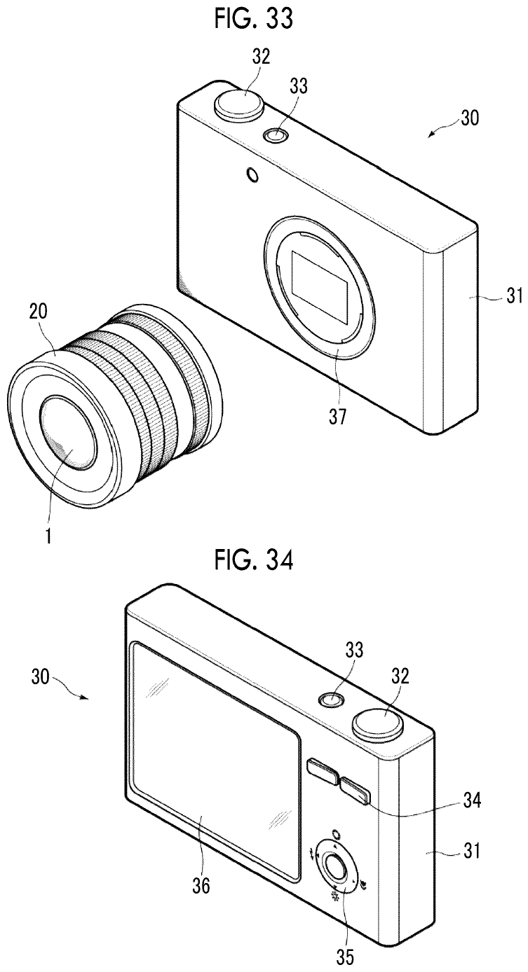

Next, an imaging apparatus according to the embodiment of the present disclosure will be described. FIGS. 33 and 34 illustrate external views of a camera 30 that is the imaging apparatus according to one embodiment of the present disclosure. FIG. 33 illustrates a perspective view of the camera 30 seen from a front surface side, and FIG. 34 illustrates a perspective view of the camera 30 seen from a rear surface side. The camera 30 is a so-called mirrorless type digital camera on which an interchangeable lens 20 can be attachably and detachably mounted. The interchangeable lens 20 is configured to include an imaging lens 1 according to one embodiment of the present disclosure accommodated in a lens barrel.

The camera 30 comprises a camera body 31, and a shutter button 32 and a power button 33 are provided on an upper surface of the camera body 31. An operator 34, an operator 35, and a display unit 36 are provided on a rear surface of the camera body 31. The display unit 36 can display a captured image and an image within an angle of view before capturing.

An imaging opening on which light from an imaging target is incident is provided in a center portion of a front surface of the camera body 31, and a mount 37 is provided at a position corresponding to the imaging opening. The interchangeable lens 20 is mounted on the camera body 31 through the mount 37.

The camera body 31 is provided with an imaging element such as a charge coupled device (CCD) or a complementary metal oxide semiconductor (CMOS) that outputs an imaging signal corresponding to a subject image formed by the interchangeable lens 20, a signal processing circuit that processes the imaging signal output from the imaging element to generate an image, a recording medium for recording the generated image, and the like. In the camera 30, a static image or a video can be captured by pressing the shutter button 32, and image data obtained by this capturing is recorded on the recording medium.

While the disclosed technology has been described above using the embodiment and the examples, the disclosed technology is not limited to the embodiment and the examples and can be subjected to various modifications. For example, the curvature radius, the surface spacing, the refractive index, the Abbe number, and the aspherical coefficient of each lens are not limited to the values shown in each example and may have other values.

The imaging apparatus according to the embodiment of the present disclosure is not limited to the example and may have various aspects of, for example, a camera of a type other than a mirrorless type, a film camera, and a video camera.

The following appendices are further disclosed with respect to the embodiment and the examples described above.

### Appendix 1

An imaging lens comprising a first lens group that is disposed closest to an object side and that is fixed with respect to an image plane during focusing, and two or fewer focus lens groups that move along an optical axis during focusing, in which one of the two or fewer focus lens groups is disposed adjacent to the first lens group on an image side, and in a case where a maximum half angle of view in a state where an infinite distance object is in focus is denoted by ωm, ωm is in degree units, a back focus of an entire system as an air conversion distance in the state where the infinite distance object is in focus is denoted by Bf, and a focal length of the entire system in the state where the infinite distance object is in focus is denoted by f, Conditional Expressions (1) and (2) are satisfied, which are represented by

$$35 < ω m < 76 \qquad ( 1 )$$

$$and$$

$$0.3 < Bf / ( f \times tan ω m ) < 1.2 . \qquad ( 2 )$$

### Appendix 2

The imaging lens according to Appendix 1, in which, in a case where a sum of a distance on the optical axis from a lens surface of the imaging lens closest to the object side to a lens surface of the imaging lens closest to the image side and the back focus of the entire system as the air conversion distance in the state where the infinite distance object is in focus is denoted by TL, Conditional Expression (3) is satisfied, which is represented by

$$1.4 < TL / ( f \times tan ω m ) < 3.5 . \qquad ( 3 )$$

### Appendix 3

The imaging lens according to Appendix 1 or 2, in which, in a case where an open F-number in the state where the infinite distance object is in focus is denoted by FNo, Conditional Expression (4) is satisfied, which is represented by

$$1 < FNo / tan ω m < 4.5 . \qquad ( 4 )$$

### Appendix 4

The imaging lens according to any one of Appendices 1 to 3, in which, in a case where an open F-number in the state where the infinite distance object is in focus is denoted by FNo, Conditional Expression (5) is satisfied, which is represented by

$$2.2 < FNo < 4.2 . \qquad ( 5 )$$

### Appendix 5

The imaging lens according to any one of Appendices 1 to 4, further comprising an aperture stop, in which, in a case where a distance on the optical axis from a lens surface of the first lens group closest to the object side to the aperture stop in the state where the infinite distance object is in focus is denoted by STI, and a sum of a distance on the optical axis from a lens surface of the imaging lens closest to the object side to a lens surface of the imaging lens closest to the image side and the back focus of the entire system as the air conversion distance in the state where the infinite distance object is in focus is denoted by TL, Conditional Expression (6) is satisfied, which is represented by

$$0.06 < STI / TL < 0.45 . \qquad ( 6 )$$

### Appendix 6

The imaging lens according to any one of Appendices 1 to 5, in which, in a case where a maximum imaging magnification is denoted by β, Conditional Expression (7) is satisfied, which is represented by

$$0.05 < \vert β \vert < 0.3 . \qquad ( 7 )$$

### Appendix 7

The imaging lens according to any one of Appendices 1 to 6, in which, in a case where a focal length of the first lens group is denoted by f1, Conditional Expression (8) is satisfied, which is represented by

$$- 1.5 < f / f 1 < 1.5 . \qquad ( 8 )$$

### Appendix 8

The imaging lens according to any one of Appendices 1 to 7, in which, in a case where a distance on the optical axis from a lens surface of the imaging lens closest to the object side to a paraxial entrance pupil position in the state where the infinite distance object is in focus is denoted by Denp, Conditional Expression (9) is satisfied, which is represented by

$$0.05 < Denp / f < 1. \qquad ( 9 )$$

### Appendix 9

The imaging lens according to any one of Appendices 1 to 8, in which a lens closest to the object side in the first lens group is a negative lens.

### Appendix 10

The imaging lens according to any one of Appendices 1 to 8, in which a lens closest to the object side in the first lens group is a negative lens having a concave surface facing the image side.

### Appendix 11

The imaging lens according to any one of Appendices 1 to 8, in which the first lens group includes, in consecutive order from a position closest to the object side to the image side, a negative lens having a concave surface facing the image side and a negative meniscus lens having a concave surface facing the image side.

### Appendix 12

The imaging lens according to any one of Appendices 9 to 11, in which, in a case where a paraxial curvature radius of a surface, on the object side, of the negative lens closest to the object side in the first lens group is denoted by R1f, and a paraxial curvature radius of a surface, on the image side, of the negative lens closest to the object side in the first lens group is denoted by R1r, Conditional Expression (10) is satisfied, which is represented by

$$0.1 < ( R 1 f + R 1 r ) / ( R 1 f - R 1 r ) < 5. \qquad ( 10 )$$

### Appendix 13

The imaging lens according to any one of Appendices 9 to 12, in which, in a case where a paraxial curvature radius of a surface, on the object side, of the negative lens closest to the object side in the first lens group is denoted by R1f, Conditional Expression (11) is satisfied, which is represented by

$$- 3 < f / R 1 f < 4. \qquad ( 11 )$$

### Appendix 14

The imaging lens according to any one of Appendices 9 to 13, in which, in a case where a focal length of the negative lens closest to the object side in the first lens group is denoted by fL1, Conditional Expression (12) is satisfied, which is represented by

$$0.1 < f / ( - fL 1 ) < 3.5 . \qquad ( 12 )$$

### Appendix 15

The imaging lens according to any one of Appendices 9 to 14, in which, in a case where a paraxial curvature radius of a surface, on the object side, of a lens which is second from the object side in the first lens group is denoted by R2f, and a paraxial curvature radius of a surface, on the image side, of the lens which is second from the object side in the first lens group is denoted by R2r, Conditional Expression (13) is satisfied, which is represented by

$$- 3 < ( R 2 f + R 2 r ) / ( R 2 f - R 2 r ) < 8. \qquad ( 13 )$$

### Appendix 16

The imaging lens according to any one of Appendices 1 to 15, in which a lens closest to the image side in the first lens group is a positive lens.

### Appendix 17

The imaging lens according to Appendix 16, in which, in a case where a paraxial curvature radius of a surface, on the object side, of the positive lens closest to the image side in the first lens group is denoted by R1rf, and a paraxial curvature radius of a surface, on the image side, of the positive lens closest to the image side in the first lens group is denoted by R1rr, Conditional Expression (14) is satisfied, which is represented by

$$- 4 < ( R 1 rf + R 1 rr ) / ( R 1 rf - R 1 rr ) < 0. \qquad ( 14 )$$

### Appendix 18

The imaging lens according to Appendix 16 or 17, in which, in a case where an Abbe number based on a d line for the positive lens closest to the image side in the first lens group is denoted by v1r, Conditional Expression (15) is satisfied, which is represented by

$$22 < v 1 r < 85. \qquad ( 15 )$$

### Appendix 19

The imaging lens according to any one of Appendices 1 to 18, in which, in a case where an average value of relative densities of all lenses included in the first lens group is denoted by ρ1ave, Conditional Expression (16) is satisfied, which is represented by

$$2.3 < ρ1 ave < 4.7 . \qquad ( 16 )$$

### Appendix 20

The imaging lens according to any one of Appendices 1 to 19, in which the first lens group includes at least one negative lens and at least one positive lens, and the number of lenses included in the first lens group is four or less.

### Appendix 21

The imaging lens according to any one of Appendices 1 to 20, in which the first lens group includes, in order from the object side to the image side, only three lenses consisting of a negative lens having a concave surface facing the image side, a negative lens having a concave surface facing the image side, and a positive lens as lenses.

### Appendix 22

The imaging lens according to any one of Appendices 1 to 21, in which the first lens group includes an aspherical lens having a concave surface facing the image side, and in a case where a paraxial curvature radius of a surface of the aspherical lens on the object side is denoted by Rc1f, a paraxial curvature radius of a surface of the aspherical lens on the image side is denoted by Rc1r, a curvature radius of the surface of the aspherical lens on the object side at a position of a maximum effective diameter is denoted by Ry1f, and a curvature radius of the surface of the aspherical lens on the image side at a position of a maximum effective diameter is denoted by Ry1r, Conditional Expression (17) is satisfied, which is represented by

$$0.4 < ( 1 / Rc 1 f ) - 1 / Rc 1 r ) / ( 1 Ry 1 f - 1 / Ry 1 r ) < 2.4 . \qquad ( 17 )$$

### Appendix 23

The imaging lens according to any one of Appendices 1 to 22, in which the imaging lens includes two focus lens groups, and in a case where a focus lens group on the object side out of the two focus lens groups is referred to as a first focus lens group, and a focus lens group on the image side out of the two focus lens groups is referred to as a second focus lens group, during focusing, the first focus lens group and the second focus lens group move by different moving amounts, and a lens group different from the first focus lens group and the second focus lens group is fixed with respect to the image plane.

### Appendix 24

The imaging lens according to Appendix 23, in which, in a case where a focal length of the first focus lens group is denoted by ff1, and a focal length of the second focus lens group is denoted by ff2, Conditional Expression (18) is satisfied, which is represented by

$$0.04 < ff 1 / ff 2 < 2. \qquad ( 18 )$$

### Appendix 25

The imaging lens according to Appendix 24, in which Conditional Expression (18-1) is satisfied, which is represented by

$$0.1 < ff 1 / ff 2 < 0.9 . \qquad ( 18 - 1 )$$

### Appendix 26

The imaging lens according to any one of Appendices 23 to 25, in which the first lens group includes, in consecutive order from a position closest to the object side to the image side, a negative lens having a concave surface facing the image side and a negative lens having a concave surface facing the image side.

### Appendix 27

The imaging lens according to any one of Appendices 23 to 26, in which, in a case where a lateral magnification of the first focus lens group in the state where the infinite distance object is in focus is denoted by βf1, and a lateral magnification of the second focus lens group in the state where the infinite distance object is in focus is denoted by βf2, Conditional Expression (19) is satisfied, which is represented by

$$- 1 < β f 1 / β f 2 < 1.2 . \qquad ( 19 )$$

### Appendix 28

The imaging lens according to any one of Appendices 23 to 27, in which, in a case where a lateral magnification of the first focus lens group in the state where the infinite distance object is in focus is denoted by βf1, Conditional Expression (20) is satisfied, which is represented by

$$0 < {\{ β f 1 + ( 1 / βf1 ) \}}^{- 2} < 0.25 . \qquad ( 20 )$$

### Appendix 29

The imaging lens according to any one of Appendices 23 to 28, in which, in a case where a lateral magnification of the second focus lens group in the state where the infinite distance object is in focus is denoted by βf2, Conditional Expression (21) is satisfied, which is represented by

$$0.05 < {\{ β f 2 + ( 1 / βf2 ) \}}^{- 2} < 0.25 . \qquad ( 21 )$$

### Appendix 30

The imaging lens according to any one of Appendices 23 to 29, in which, in a case where a focal length of the first focus lens group is denoted by ff1, Conditional Expression (22) is satisfied, which is represented by

$$0.1 < f / ff 1 < 1.5 . \qquad ( 22 )$$

### Appendix 31

The imaging lens according to any one of Appendices 23 to 30, in which the first focus lens group includes a cemented lens in which a positive lens and a negative lens are cemented in order from the object side.

### Appendix 32

The imaging lens according to Appendix 31, in which, in a case where an Abbe number based on a d line for the positive lens of the cemented lens is denoted by vf1p, and an Abbe number based on a d line for the negative lens of the cemented lens is denoted by vf1n, Conditional Expression (23) is satisfied, which is represented by

$$- 15 < vf 1 p - vf 1 n < 25. \qquad ( 23 )$$

### Appendix 33

The imaging lens according to Appendix 31 or 32, in which, in a case where a refractive index with respect to a d line for the positive lens of the cemented lens is denoted by Nf1p, and a refractive index with respect to a d line for the negative lens of the cemented lens is denoted by Nf1n, Conditional Expression (24) is satisfied, which is represented by

$$0 < Nf 1 p - Nf 1 n < 0.45 . \qquad ( 24 )$$

### Appendix 34

The imaging lens according to any one of Appendices 23 to 33, in which, in a case where an average value of an effective radius of a surface of the first focus lens group closest to the image side and an effective radius of a surface of the second focus lens group closest to the image side is denoted by Effave, Conditional Expression (25) is satisfied, which is represented by

$$0.3 < Effave / ( f \times tan ω m ) < 0.7 . \qquad ( 25 )$$

### Appendix 35

The imaging lens according to any one of Appendices 23 to 34, in which an image-side lens group that has a refractive power and that is fixed with respect to the image plane during focusing is disposed adjacent to the second focus lens group on the image side.

### Appendix 36

The imaging lens according to Appendix 35, in which, in a case where a focal length of the image-side lens group is denoted by fi, Conditional Expression (26) is satisfied, which is represented by

$$0.05 < f / ( - fi ) < 0.7 . \qquad ( 26 )$$

### Appendix 37

The imaging lens according to Appendix 35 or 36, in which a lens closest to the image side in the image-side lens group is a negative lens having a concave surface facing the object side.

### Appendix 38

The imaging lens according to Appendix 37, in which, in a case where a refractive index with respect to a d line for the negative lens closest to the image side in the image-side lens group is denoted by Nir, Conditional Expression (27) is satisfied, which is represented by

$$1.45 < Nir < 2.2 . \qquad ( 27 )$$

### Appendix 39

The imaging lens according to any one of Appendices 23 to 38, in which the first focus lens group includes an aspherical lens having a concave surface facing the object side, and in a case where a paraxial curvature radius of a surface, on the object side, of the aspherical lens of the first focus lens group is denoted by Rcff1f, a paraxial curvature radius of a surface, on the image side, of the aspherical lens of the first focus lens group is denoted by Rcff1r, a curvature radius of the surface, on the object side, of the aspherical lens of the first focus lens group at a position of a maximum effective diameter is denoted by Ryff1f, and a curvature radius of the surface, on the image side, of the aspherical lens of the first focus lens group at a position of a maximum effective diameter is denoted by Ryff1r, Conditional Expression (28) is satisfied, which is represented by

$$0.1 < ( 1 / Rcff 1 f - 1 / Rcff 1 r ) / ( 1 / Ryff 1 f - 1 / Ryff 1 r ) < 1.6 . \qquad ( 28 )$$

### Appendix 40

The imaging lens according to any one of Appendices 23 to 39, in which the second focus lens group includes an aspherical lens having a concave surface facing the object side, and in a case where a paraxial curvature radius of a surface, on the object side, of the aspherical lens of the second focus lens group is denoted by Rcff2f, a paraxial curvature radius of a surface, on the image side, of the aspherical lens of the second focus lens group is denoted by Rcff2r, a curvature radius of the surface, on the object side, of the aspherical lens of the second focus lens group at a position of a maximum effective diameter is denoted by Ryff2f, and a curvature radius of the surface, on the image side, of the aspherical lens of the second focus lens group at a position of a maximum effective diameter is denoted by Ryff2r, Conditional Expression (29) is satisfied, which is represented by

$$0 < ( 1 / Rcff 2 f - 1 / Rcff 2 r ) / ( 1 / Ryff 2 f - 1 / Ryff 2 r ) < 0.6 . \qquad ( 29 )$$

### Appendix 41

The imaging lens according to any one of Appendices 23 to 40, in which the imaging lens consists of, in order from the object side to the image side, the first lens group, the first focus lens group, the second focus lens group, and an image-side lens group that has a refractive power and that is fixed with respect to the image plane during focusing.

### Appendix 42

The imaging lens according to any one of Appendices 23 to 41, in which a middle lens group that has a positive refractive power and that is fixed with respect to the image plane during focusing is provided between the first focus lens group and the second focus lens group, and in a case where a focal length of the middle lens group is denoted by fm, and a focal length of the first focus lens group is denoted by ff1, Conditional Expression (30) is satisfied, which is represented by

$$2 < fm / ff 1 < 1. \qquad ( 30 )$$

### Appendix 43

The imaging lens according to any one of Appendices 1 to 22, in which the imaging lens includes only one focus lens group.

### Appendix 44

The imaging lens according to Appendix 43, in which, in a case where a focal length of the focus lens group is denoted by ff, Conditional Expression (31) is satisfied, which is represented by

$$0.1 < f / ff < 2. \qquad ( 31 )$$

### Appendix 45

The imaging lens according to Appendix 43 or 44, in which, in a case where a sum of a distance on the optical axis from a lens surface of the imaging lens closest to the object side to a lens surface of the imaging lens closest to the image side and the back focus of the entire system as the air conversion distance in the state where the infinite distance object is in focus is TL, and a focal length of the focus lens group is denoted by ff, Conditional Expression (32) is satisfied, which is represented by

$$0.5 < TL / ff < 3.5 . \qquad ( 32 )$$

### Appendix 46

The imaging lens according to any one of Appendices 43 to 45, in which the focus lens group includes a cemented lens in which a positive lens and a negative lens are cemented in order from the object side.

### Appendix 47

The imaging lens according to Appendix 46, in which, in a case where an Abbe number based on a d line for the positive lens of the cemented lens is denoted by vfp, and an Abbe number based on a d line for the negative lens of the cemented lens is denoted by vfn, Conditional Expression (33) is satisfied, which is represented by

$$- 15 < vfp - vfn < 25. \qquad ( 33 )$$

### Appendix 48

The imaging lens according to Appendix 46 or 47, in which, in a case where a refractive index with respect to a d line for the positive lens of the cemented lens is denoted by Nfp, and a refractive index with respect to a d line for the negative lens of the cemented lens is denoted by Nfn, Conditional Expression (34) is satisfied, which is represented by

$$0 < Nfp - Nfn < 0.45 . \qquad ( 34 )$$

### Appendix 49

The imaging lens according to any one of Appendices 43 to 48, in which, in a case where an effective radius of a surface of the focus lens group closest to the image side is denoted by Eff, Conditional Expression (35) is satisfied, which is represented by

$$0.3 < Eff / ( f \times tan ω m ) < 0.7 . \qquad ( 35 )$$

### Appendix 50

The imaging lens according to any one of Appendices 43 to 49, in which an image-side lens group that has a refractive power and that is fixed with respect to the image plane during focusing is disposed adjacent to the focus lens group on the image side.

### Appendix 51

The imaging lens according to Appendix 50, in which, in a case where a focal length of the image-side lens group is denoted by fi, Conditional Expression (26) is satisfied, which is represented by

$$0.05 < f / ( - fi ) < 0.7 . \qquad ( 26 )$$

### Appendix 52

The imaging lens according to Appendix 51, in which a lens closest to the image side in the image-side lens group is a negative lens having a concave surface facing the object side.

### Appendix 53

The imaging lens according to Appendix 52, in which, in a case where a refractive index with respect to a d line for the negative lens closest to the image side in the image-side lens group is denoted by Nir, Conditional Expression (27) is satisfied, which is represented by

$$1.45 < Nir < 2.2 . \qquad ( 27 )$$

### Appendix 54

The imaging lens according to any one of Appendices 43 to 53, in which the focus lens group includes at least one aspherical lens, an aspherical lens closest to the object side among aspherical lenses included in the focus lens group has a concave surface facing the object side, and in a case where a paraxial curvature radius of a surface, on the object side, of the aspherical lens closest to the object side is denoted by Rcffof, a paraxial curvature radius of a surface, on the image side, of the aspherical lens closest to the object side is denoted by Rcffor, a curvature radius of the surface, on the object side, of the aspherical lens closest to the object side at a position of a maximum effective diameter is denoted by Ryffof, and a curvature radius of the surface, on the image side, of the aspherical lens closest to the object side at a position of a maximum effective diameter is denoted by Ryffor, Conditional Expression (36) is satisfied, which is represented by

$$0.1 < ( 1 / Rcffof - 1 / Rcffor ) / ( 1 / Ryffof - 1 / Ryffor ) < 1.6 . \qquad ( 36 )$$

### Appendix 55

The imaging lens according to any one of Appendices 43 to 54, in which the focus lens group includes at least one aspherical lens, an aspherical lens closest to the image side among aspherical lenses included in the focus lens group has a concave surface facing the object side, and in a case where a paraxial curvature radius of a surface, on the object side, of the aspherical lens closest to the image side is denoted by Rcffif, a paraxial curvature radius of a surface, on the image side, of the aspherical lens closest to the image side is denoted by Rcffir, a curvature radius of the surface, on the object side, of the aspherical lens closest to the image side at a position of a maximum effective diameter is denoted by Ryffif, and a curvature radius of the surface, on the image side, of the aspherical lens closest to the image side at a position of a maximum effective diameter is denoted by Ryffir, Conditional Expression (37) is satisfied, which is represented by

$$- 0.7 < ( 1 / Rcfif - 1 / Rcffir ) / ( 1 / Ryffif - 1 / Ryffir ) < 1.2 . \qquad ( 37 )$$

### Appendix 56

The imaging lens according to any one of Appendices 1 to 55, in which, the imaging lens includes an Lp lens that is a positive lens, and in a case where a refractive index with respect to a d line for the Lp lens is denoted by Np, an Abbe number based on the d line for the Lp lens is denoted by vp, and a partial dispersion ratio of the Lp lens between a g line and an F line is denoted by θgFp, Conditional Expressions (38), (39), (40), and (41) are satisfied, which are represented by

$$0.005 < Np - ( 2.0 \; 15 - 0.0068 \times vp ) < 0.15 , \qquad ( 38 )$$

$$50 < vp < 65 , \qquad ( 39 )$$

$$0.545 < θ gFp < 0.58 , and \qquad ( 40 )$$

$$- 0. 11 < θ gFp - ( 0.6 \; 418 - 0.00168 \times vp ) < 0.0 35. \qquad ( 41 )$$

### Appendix 57

The imaging lens according to Appendix 56, further comprising an aperture stop, in which the Lp lens is disposed on the image side with respect to the aperture stop, and in a case where an open F-number in the state where the infinite distance object is in focus is denoted by FNo, a distance on the optical axis from a lens surface of the first lens group closest to the object side to the aperture stop in the state where the infinite distance object is in focus is denoted by STI, and a sum of a distance on the optical axis from a lens surface of the imaging lens closest to the object side to a lens surface of the imaging lens closest to the image side and the back focus of the entire system as the air conversion distance in the state where the infinite distance object is in focus is denoted by TL, Conditional Expressions (4-2) and (6-1) are satisfied, which are represented by

$$1.5 < FNo / tan ω m < 2.5 and \qquad ( 4 - 2 )$$

$$0.09 < STI / TL < 0.35 . \qquad ( 6 - 1 )$$

### Appendix 58

The imaging lens according to any one of Appendices 1 to 57, in which Conditional Expression (1-1) is satisfied, which is represented by

$$39 < ω m < 72. \qquad ( 1 - 1 )$$

### Appendix 59

The imaging lens according to Appendix 58, in which Conditional Expression (1-2) is satisfied, which is represented by

$$41 < ω m < 70. \qquad ( 1 - 2 )$$

### Appendix 60

The imaging lens according to any one of Appendices 1 to 59, in which, in a case where a sum of a distance on the optical axis from a lens surface of the imaging lens closest to the object side to a lens surface of the imaging lens closest to the image side and the back focus of the entire system as the air conversion distance in the state where the infinite distance object is in focus is denoted by TL, Conditional Expression (3-1) is satisfied, which is represented by

$$1. 7 < TL / ( f \times tan ω m ) < 3.2 . \qquad ( 3 ‐ 1 )$$

### Appendix 61

The imaging lens according to any one of Appendices 1 to 60, in which, in a case where an open F-number in the state where the infinite distance object is in focus is denoted by FNo, Conditional Expression (4-1) is satisfied, which is represented by

$$1. 4 < FNo / tan ω m < 2 \text{.75} . \qquad ( 4 ‐ 1 )$$

### Appendix 62

The imaging lens according to any one of Appendices 1 to 61, in which, in a case where a focal length of the first lens group is denoted by f1, Conditional Expression (8-1) is satisfied, which is represented by

$$- 0.8 < f / f 1 < 0.25 . \qquad ( 8 ‐ 1 )$$

### Appendix 63

An imaging apparatus comprising the imaging lens according to any one of Appendices 1 to 62.

All documents, patent applications, and technical standards described in the present specification are incorporated in the present specification by reference to the same extent as in a case where individual documents, patent applications, and technical standards are specifically and individually indicated to be incorporated by reference.

What is claimed is:

1. An imaging lens comprising:
a first lens group that is disposed closest to an object side and that is fixed with respect to an image plane during focusing; and
two or fewer focus lens groups that move along an optical axis during focusing,
wherein one of the two or fewer focus lens groups is disposed adjacent to the first lens group on an image side, and
in a case where a maximum half angle of view in a state where an infinite distance object is in focus is denoted by ωm,
ωm is in degree units,
a back focus of the imaging lens as an air conversion distance in the state where the infinite distance object is in focus is denoted by Bf, and
a focal length of the imaging lens in the state where the infinite distance object is in focus is denoted by f,
Conditional Expressions (1) and (2) are satisfied, which are represented by
$$35 < ω m < 76 and \qquad ( 1 )$$
$$0.3 < Bf / ( f \times tan ω m ) < 1.2 . \qquad ( 2 )$$

2. The imaging lens according to claim 1,
wherein, in a case where a sum of a distance on the optical axis from a lens surface of the imaging lens closest to the object side to a lens surface of the imaging lens closest to the image side and the back focus of the imaging lens as the air conversion distance in the state where the infinite distance object is in focus is denoted by TL,
Conditional Expression (3) is satisfied, which is represented by
$$1. 4 < TL / ( f \times tan ω m ) < 3.5 . \qquad ( 3 )$$

3. The imaging lens according to claim 2,
wherein Conditional Expression (3-1) is satisfied, which is represented by
$$1. 7 < TL / ( f \times tan ω m ) < 3.2 . \qquad ( 3 ‐ 1 )$$

4. The imaging lens according to claim 1,
wherein, in a case where an open F-number in the state where the infinite distance object is in focus is denoted by FNo,
Conditional Expression (4) is satisfied, which is represented by
$$1 < FNo / tan ω m < 4.5 . \qquad ( 4 )$$

5. The imaging lens according to claim 4,
wherein Conditional Expression (4-1) is satisfied, which is represented by
$$1. 4 < FNo / tan ω m < 2 \text{.75} . \qquad ( 4 ‐ 1 )$$

6. The imaging lens according to claim 1,
wherein, in a case where an open F-number in the state where the infinite distance object is in focus is denoted by FNo,
Conditional Expression (5) is satisfied, which is represented by
$$2. 2 < FNo < 4.2 . \qquad ( 5 )$$

7. The imaging lens according to claim 1,
wherein an aperture stop is disposed, and
in a case where a distance on the optical axis from a lens surface of the first lens group closest to the object side to the aperture stop in the state where the infinite distance object is in focus is denoted by STI, and
a sum of a distance on the optical axis from a lens surface of the imaging lens closest to the object side to a lens surface of the imaging lens closest to the image side and the back focus of the imaging lens as the air conversion distance in the state where the infinite distance object is in focus is denoted by TL,
Conditional Expression (6) is satisfied, which is represented by
$$0.06 < STI / TL < 0.45 . \qquad ( 6 )$$

8. The imaging lens according to claim 1,
wherein, in a case where a maximum imaging magnification is denoted by β,
Conditional Expression (7) is satisfied, which is represented by
$$0.05 < \vert β \vert < 0.3 . \qquad ( 7 )$$

9. The imaging lens according to claim 1,
wherein, in a case where a focal length of the first lens group is denoted by f1,
Conditional Expression (8) is satisfied, which is represented by
$$- 1.5 < f / f 1 < 1.5 . \qquad ( 8 )$$

10. The imaging lens according to claim 9,
wherein, in a case where a sum of a distance on the optical axis from a lens surface of the imaging lens closest to the object side to a lens surface of the imaging lens closest to the image side and the back focus of the imaging lens as the air conversion distance in the state where the infinite distance object is in focus is denoted by TL,
Conditional Expression (3-1) is satisfied, which is represented by
$$1.7 < TL / ( f \times tan ω m ) < 3.2 . \qquad ( 3 ‐ 1 )$$

11. The imaging lens according to claim 10,
wherein, in a case where an open F-number in the state where the infinite distance object is in focus is denoted by FNo,
Conditional Expression (4-1) is satisfied, which is represented by
$$1.4 < FNo / tan ω m < 2 \text{.75} . \qquad ( 4 ‐ 1 )$$

12. The imaging lens according to claim 11,
wherein Conditional Expression (1-1) is satisfied, which is represented by
$$39 < ω m < 72. \qquad ( 1 ‐ 1 )$$

13. The imaging lens according to claim 12,
wherein, in a case where the open F-number in the state where the infinite distance object is in focus is denoted by FNo,
Conditional Expression (5) is satisfied, which is represented by
$$2.2 < FNo < 4.2 . \qquad ( 5 )$$

14. The imaging lens according to claim 11,
wherein the first lens group includes, in consecutive order from a position closest to the object side to the image side, a negative lens having a concave surface facing the image side and a negative meniscus lens having a concave surface facing the image side.

15. The imaging lens according to claim 11,
wherein, in a case where a focal length of the first lens group is denoted by f1,
Conditional Expression (8-1) is satisfied, which is represented by
$$- 0.8 < f / f 1 < 0.25 . \qquad ( 8 - 1 )$$

16. The imaging lens according to claim 15,
wherein a lens closest to the object side in the first lens group is a negative lens having a concave surface facing the image side.

17. The imaging lens according to claim 1,
wherein, in a case where a distance on the optical axis from a lens surface of the imaging lens closest to the object side to a paraxial entrance pupil position in the state where the infinite distance object is in focus is denoted by Denp,
Conditional Expression (9) is satisfied, which is represented by
$$0.05 < D e n p / f < 1. \qquad ( 9 )$$

18. The imaging lens according to claim 1,
wherein a lens closest to the object side in the first lens group is a negative lens.

19. The imaging lens according to claim 18,
wherein, in a case where a paraxial curvature radius of a surface, on the object side, of the negative lens closest to the object side in the first lens group is denoted by R1f, and
a paraxial curvature radius of a surface, on the image side, of the negative lens closest to the object side in the first lens group is denoted by R1r,
Conditional Expression (10) is satisfied, which is represented by
$$0.1 < ( R 1 f + R 1 r ) / ( R 1 f - R 1 r ) < 5. \qquad ( 10 )$$

20. The imaging lens according to claim 18,
wherein, in a case where a paraxial curvature radius of a surface, on the object side, of the negative lens closest to the object side in the first lens group is denoted by R1f,
Conditional Expression (11) is satisfied, which is represented by
$$- 3 < f / R 1 f < 4. \qquad ( 11 )$$

21. The imaging lens according to claim 18,
wherein, in a case where a focal length of the negative lens closest to the object side in the first lens group is denoted by fL1,
Conditional Expression (12) is satisfied, which is represented by
$$0.1 < f / ( - fL 1 ) < 3.5 . \qquad ( 12 )$$

22. The imaging lens according to claim 18,
wherein, in a case where a paraxial curvature radius of a surface, on the object side, of a lens which is second from the object side in the first lens group is denoted by R2f, and
a paraxial curvature radius of a surface, on the image side, of the lens which is second from the object side in the first lens group is denoted by R2r,
Conditional Expression (13) is satisfied, which is represented by
$$- 3 < ( R 2 f + R 2 r ) / ( R 2 f - R 2 r ) < 8. \qquad ( 13 )$$

23. The imaging lens according to claim 1,
wherein a lens closest to the image side in the first lens group is a positive lens.

24. The imaging lens according to claim 23,
wherein, in a case where a paraxial curvature radius of a surface, on the object side, of the positive lens closest to the image side in the first lens group is denoted by R1rf, and
a paraxial curvature radius of a surface, on the image side, of the positive lens closest to the image side in the first lens group is denoted by R1rr,
Conditional Expression (14) is satisfied, which is represented by
$$- 4 < ( R 1 rf + R 1 rr ) / ( R 1 rf - R 1 rr ) < 0. \qquad ( 14 )$$

25. The imaging lens according to claim 23,
wherein, in a case where an Abbe number based on a d line for the positive lens closest to the image side in the first lens group is denoted by v1r,
Conditional Expression (15) is satisfied, which is represented by
$$22 < v 1 r < 85. \qquad ( 15 )$$

26. The imaging lens according to claim 1,
wherein, in a case where an average value of relative densities of all lenses included in the first lens group is denoted by ρ1ave,
Conditional Expression (16) is satisfied, which is represented by
$$2.3 < ρ 1 ave < 4.7 . \qquad ( 16 )$$

27. The imaging lens according to claim 1,
wherein the first lens group includes at least one negative lens and at least one positive lens, and the number of lenses included in the first lens group is four or less.

28. The imaging lens according to claim 27,
wherein the first lens group includes, in order from the object side to the image side, only three lenses consisting of a negative lens having a concave surface facing the image side, a negative lens having a concave surface facing the image side, and a positive lens as lenses.

29. The imaging lens according to claim 1,
wherein the first lens group includes an aspherical lens having a concave surface facing the image side, and
in a case where a paraxial curvature radius of a surface of the aspherical lens on the object side is denoted by Rc1f,
a paraxial curvature radius of a surface of the aspherical lens on the image side is denoted by Rc1r,
a curvature radius of the surface of the aspherical lens on the object side at a position of a maximum effective diameter is denoted by Ry1f, and
a curvature radius of the surface of the aspherical lens on the image side at a position of a maximum effective diameter is denoted by Ry1r,
Conditional Expression (17) is satisfied, which is represented by
$$0.4 < ( 1 / Rc 1 f - 1 / Rc 1 r ) / ( 1 / Ry 1 f - 1 / Ry 1 r ) < 2.4 . \qquad ( 17 )$$

30. The imaging lens according to claim 1,
wherein the imaging lens includes two focus lens groups, and
in a case where a focus lens group on the object side out of the two focus lens groups is referred to as a first focus lens group, and a focus lens group on the image side out of the two focus lens groups is referred to as a second focus lens group,
during focusing, the first focus lens group and the second focus lens group move by different moving amounts, and a lens group different from the first focus lens group and the second focus lens group is fixed with respect to the image plane.

31. The imaging lens according to claim 30,
wherein, in a case where a sum of a distance on the optical axis from a lens surface of the imaging lens closest to the object side to a lens surface of the imaging lens closest to the image side and the back focus of the imaging lens as the air conversion distance in the state where the infinite distance object is in focus is denoted by TL,
Conditional Expression (3-1) is satisfied, which is represented by
$$1. 7 < T L / ( f \times tan ω m ) < 3.2 . \qquad ( 3 - 1 )$$

32. The imaging lens according to claim 30,
wherein, in a case where a focal length of the first focus lens group is denoted by ff1, and
a focal length of the second focus lens group is denoted by ff2,
Conditional Expression (18) is satisfied, which is represented by
$$0.04 < ff 1 / ff 2 < 2. \qquad ( 18 )$$

33. The imaging lens according to claim 31,
wherein Conditional Expression (1-2) is satisfied, which is represented by
$$41 < ω m < 70. \qquad ( 1 - 2 )$$

34. The imaging lens according to claim 31,
wherein, in a case where a focal length of the first focus lens group is denoted by ff1, and
a focal length of the second focus lens group is denoted by ff2,
Conditional Expression (18-1) is satisfied, which is represented by
$$0.1 < ff 1 / ff 2 < 0.9 . \qquad ( 18 - 1 )$$

35. The imaging lens according to claim 34,
wherein the first lens group includes, in consecutive order from a position closest to the object side to the image side, a negative lens having a concave surface facing the image side and a negative lens having a concave surface facing the image side.

36. An imaging apparatus comprising:
the imaging lens according to claim 1.
